(19) United States
(12) Patent Application Publication
(10) Pub. No.: US 2020/0302945 A1
(43) Pub. Date: Sep. 24, 2020

(54) AUDIO DECODING DEVICE, AUDIO CODING DEVICE, AUDIO DECODING METHOD, AUDIO CODING METHOD, AUDIO DECODING PROGRAM, AND AUDIO CODING PROGRAM

(71) Applicant: NTT DOCOMO, INC., Tokyo (JP)

(72) Inventors: Kei Kikuiri, Tokyo (JP); Atsushi Yamaguchi, Tokyo (JP)

(73) Assignee: NTT DOCOMO, INC., Tokyo (JP)

(21) Appl. No.: 16/894,748

(22) Filed: Jun. 5, 2020

Related U.S. Application Data
(63) Continuation of application No. 16/047,904, filed on Jul. 27, 2018, now Pat. No. 10,714,113.
Application No. 16/047,904 is a continuation of application No. 15/635,191, filed on Jun. 27, 2017, now Pat. No. 10,068,584.
Application No. 15/635,191 is a continuation of application No. 14/523,260, filed on Oct. 24, 2014, now Pat. No. 9,761,240.
Application No. 14/523,260 is a continuation of application No. PCT/JP2013/061105, filed on Apr. 12, 2013.

(30) Foreign Application Priority Data
Apr. 27, 2012 (JP) 2012-103519
Nov. 20, 2015 (JP) 2012-254496

(51) Int. Cl. G10L 19/26; G10L 19/24

(52) U.S. Cl. CPC G10L 19/265; G10L 21/038; G10L 19/24

(57) ABSTRACT

An objective of the present invention is to correct a temporal envelope shape of a decoded signal with a small information volume and to reduce perceptible distortions. An audio decoding device which decodes a coded audio signal and outputs an audio signal comprises: a coded series analysis unit that analyzes a coded series which contains the coded audio signal; an audio decoding unit that receives from the coded series analysis unit the coded series which contains the coded audio signal and decodes same, obtaining an audio signal; a temporal envelope shape establishment unit that receives information from the coded series analysis unit and/or the audio decoding unit, and, on the basis of the information, establishes a temporal envelope shape of the decoded audio signal; and a temporal envelope correction unit that, on the basis of the temporal envelope shape which is established with the temporal envelope shape establishment unit, corrects the temporal envelope shape of the decoded audio signal and outputs same.

### RELATED APPLICATIONS

This application is a continuation application of U.S. patent application Ser. No. 16/047,904, filed on Jul. 27, 2018, which is a continuation application of U.S. patent application Ser. No. 15/635,191, filed on Jun. 27, 2017, which is a continuation application of U.S. patent application Ser. No. 14/523,260, filed Oct. 24, 2014, which is a continuation of International Patent Application of PCT/JP2013/061105, having an international filing date of Apr. 12, 2013, which claims priority to JP2012-103519 filed Apr. 27, 2012, and JP2012-254496 filed Nov. 20, 2012. This application incorporates U.S. patent application Ser. Nos. 16/047,904, 15/635,191, 14/523,260, PCT/JP2013/061105, JP2012-103519, and JP2012-254496 herein by reference.

### BACKGROUND OF THE INVENTION

### 1. Field of the Invention

The present invention relates to a speech decoding device, a speech encoding device, a speech decoding method, a speech encoding method, a speech decoding program, and a speech encoding program.

### 2. Description of the Related Art

Speech encoding for compressing the amount of data of speech signals and audio signals to a few tenths of the original size is an extremely important technique in terms of transmission and accumulation of signals. Examples of speech encoding techniques widely used include code excited linear prediction (CELP) that encodes a signal in a time domain, transform coded excitation (TCX) that encodes a signal in a frequency domain, and “MPEG4 AAC” standardized by “ISO/IEC MPEG”.

As a method for improving the performance of speech codec and enabling high speech quality at a low bit rate, bandwidth extension techniques have become widely used in these days in which a high frequency component is generated using a low frequency component of speech. An exemplary bandwidth extension technique is called a spectral band replication (SBR) used in “MPEG4 AAC”.

In speech encoding, the temporal envelope shape of a decoded signal obtained by decoding a code sequence obtained by encoding an input signal may greatly differ from the temporal envelope shape of the input signal, and such a difference may be perceived as distortions. Also, when the bandwidth extension techniques are used, since a high frequency component is generated by using a signal obtained by encoding and decoding a low frequency component of a speech signal with the speech encoding techniques as described above, the temporal envelope shape of the high frequency component may likewise differ and such a difference may be perceived as distortions.

The method below is a known method for solving this problem (see Patent Literature 1 below). Specifically, in order to generate high frequency component, a high frequency component in an arbitrary time segment is divided into frequency bands. When energy information for each frequency band is calculated and encoded, the energy information for each frequency band is calculated and encoded for respective time segments shorter than the aforementioned time segment. In doing so, with respect to the divided frequency band and the short time segment, the bandwidth of each frequency band and the length of the short time segment can be set flexibly. A decoding device therefore can control energy of a high frequency component for each short time segment in the time direction. That is, the decoding device can control the temporal envelope of a high frequency component for each short time segment.

### 3. Citation List—Patent Literature

Patent Literature 1: U.S. Pat. No. 7,191,121

### SUMMARY OF THE INVENTION

### Technical Problem

According to the method in Patent Literature 1 above, however, in order to exactly control the temporal envelope of a high frequency component, it is necessary to perform division into extremely short time segments and to calculate and encode the energy information for each frequency band at each short time segment. This significantly increases the amount of information and makes low bit rate encoding difficult.

In view of the aforementioned problem, the present invention aims to modify the temporal envelope shape of a decoded signal with a small amount of information in order to achieve less perception of distortions.

### Solution to Problem

The applicant invented a speech decoding device characterized in having the following first to fourth aspects in order to achieve the object above.

A speech decoding device according to the first aspect is a speech decoding device that decodes an encoded speech signal to output a speech signal. The speech decoding device comprises a code sequence analyzer that analyzes a code sequence including the encoded speech signal, a speech decoder that receives and decodes the code sequence including the encoded speech signal from the code sequence analyzer to obtain a speech signal, a temporal envelope shape determiner that receives information from at least one of the code sequence analyzer and the speech decoder and determines a temporal envelope shape of the decoded speech signal, based on the information, and a temporal envelope modifier that modifies the temporal envelope shape of the decoded speech signal, based on the temporal envelope shape determined by the temporal envelope shape determiner, and outputs the modified speech signal.

A speech decoding device according to the second aspect is a speech decoding device that decodes an encoded speech signal to output a speech signal. The speech decoding device comprises a code sequence demultiplexer that divides a code sequence including the encoded speech signal into at least a code sequence including encoded information of a low frequency signal of the speech signal and a code sequence including encoded information of a high frequency signal of the speech signal, a low frequency decoder that receives and decodes the code sequence including encoded information of the low frequency signal from the code sequence demultiplexer to obtain a low frequency signal, a high frequency decoder that receives first information from at least one of the code sequence demultiplexer and the low frequency decoder and generates a high frequency signal, based on the first information, a low frequency temporal envelope shape determiner that receives second information from at least one of the code sequence demultiplexer and the low frequency decoder and determines a temporal envelope shape of the decoded low frequency signal, based on the second information, a low frequency temporal envelope modifier that modifies the temporal envelope shape of the decoded low frequency signal, based on the temporal envelope shape determined by the low frequency temporal envelope shape determiner, and outputs the modified low frequency signal, and a low frequency/high frequency signal combiner that receives the low frequency signal whose temporal envelope shape is modified from the low frequency temporal envelope modifier, receives the high frequency signal from the high frequency decoder and combines the low frequency signal whose temporal envelope shape is modified and the high frequency signal to obtain a speech signal to be output.

A speech decoding device according to the third aspect is a speech decoding device that decodes an encoded speech signal to output a speech signal. The speech decoding device comprises a code sequence demultiplexer that divides a code sequence including the encoded speech signal into at least a code sequence including encoded information of a low frequency signal of the speech signal and a code sequence including encoded information of a high frequency signal of the speech signal, a low frequency decoder that receives and decodes the code sequence including encoded information of the low frequency signal from the code sequence demultiplexer to obtain a low frequency signal, a high frequency decoder that receives first information from at least one of the code sequence demultiplexer and the low frequency decoder and generates a high frequency signal, based on the first information, a high frequency temporal envelope shape determiner that receives second information from at least one of the code sequence demultiplexer, the low frequency decoder and the high frequency decoder and determines a temporal envelope shape of the generated high frequency signal, based on the second information, a high frequency temporal envelope modifier that modifies the temporal envelope shape of the generated high frequency signal, based on the temporal envelope shape determined by the high frequency temporal envelope shape determiner, and outputs the modified high frequency signal, and a low frequency/high frequency signal combiner that receives the low frequency signal from the low frequency decoder, receives the high frequency signal whose temporal envelope shape is modified from the high frequency temporal envelope modifier and combines the low frequency signal and the high frequency signal whose temporal envelope shape is modified to obtain a speech signal to be output.

A speech decoding device according to the fourth aspect is a speech decoding device that decodes an encoded speech signal to output a speech signal. The speech decoding device comprises a code sequence demultiplexer that divides a code sequence including the encoded speech signal into at least a code sequence including encoded information of a low frequency signal of the speech signal and a code sequence including encoded information of a high frequency signal of the speech signal, a low frequency decoder that receives and decodes the code sequence including encoded information of the low frequency signal from the code sequence demultiplexer to obtain a low frequency signal, a high frequency decoder that receives first information from at least one of the code sequence demultiplexer and the low frequency decoder and generates a high frequency signal, based on the first information, a low frequency temporal envelope shape determiner that receives second information from at least one of the code sequence demultiplexer and the low frequency decoder and determines a temporal envelope shape of the decoded low frequency signal, based on the second information, a low frequency temporal envelope modifier that modifies the temporal envelope shape of the decoded low frequency signal, based on the temporal envelope shape determined by the low frequency temporal envelope shape determiner, and outputs the modified low frequency signal, a high frequency temporal envelope shape determiner that receives third information from at least one of the code sequence demultiplexer, the low frequency decoder and the high frequency decoder and determines a temporal envelope shape of the generated high frequency signal, based on the third information, a high frequency temporal envelope modifier that modifies the temporal envelope shape of the generated high frequency signal, based on the temporal envelope shape determined by the high frequency temporal envelope shape determiner, and outputs the modified high frequency signal, and a low frequency/high frequency signal combiner that receives the low frequency signal whose temporal envelope shape is modified from the low frequency temporal envelope modifier, receives the high frequency signal whose temporal envelope shape is modified from the high frequency temporal envelope modifier and combines the low frequency signal whose temporal envelope shape is modified and the high frequency signal whose temporal envelope shape is modified to obtain a speech signal to be output.

In the speech decoding device according to the second or fourth aspect, the high frequency decoder may receive information from at least one of the code sequence demultiplexer, the low frequency decoder and the low frequency temporal envelope modifier and may generate a high frequency signal based on the information.

Also, in the speech decoding device according to the first to fourth aspects, the high frequency temporal envelope modifier may modify the temporal envelope shape of an intermediate signal appearing when generating the high frequency signal in the high frequency decoder, based on the temporal envelope shape determined by the high frequency temporal envelope shape determiner, and the high frequency decoder may carry out a process of generating a residual high frequency signal based on the intermediate signal whose temporal envelope shape is modified.

The invention of the speech decoding device according to the foregoing first to fourth aspects may be understood as an invention of a speech decoding method and can be described as follows.

A speech decoding method according to the first aspect is a speech decoding method executed by a speech decoding device that decodes an encoded speech signal to output a speech signal. The speech decoding method comprises a code sequence analyzing step of analyzing a code sequence including the encoded speech signal, a speech decoding step of receiving and decoding the code sequence including the encoded speech signal after the analysis to obtain a speech signal, a temporal envelope shape determining step of receiving information obtained in at least one of the code sequence analyzing step and the speech decoding step and determining a temporal envelope shape of the decoded speech signal based on the information, and a temporal envelope modifying step of modifying the temporal envelope shape of the decoded speech signal, based on the temporal envelope shape determined by the temporal envelope shape determining step, and outputting the modified speech signal.

A speech decoding method according to the second aspect is a speech decoding method executed by a speech decoding device that decodes an encoded speech signal to output a speech signal. The speech decoding method comprises a code sequence inverse multiplexing step of dividing a code sequence including the encoded speech signal into at least a code sequence including encoded information of a low frequency signal of the speech signal and a code sequence including encoded information of a high frequency signal of the speech signal, a low frequency decoding step of receiving and decoding the code sequence including encoded information of the low frequency signal obtained by division to obtain a low frequency signal, a high frequency decoding step of receiving first information obtained in at least one of the code sequence inverse multiplexing step and the low frequency decoding step and generating a high frequency signal based on the first information, a low frequency temporal envelope shape determining step of receiving second information obtained in at least one of the code sequence inverse multiplexing step and the low frequency decoding step and determining a temporal envelope shape of the decoded low frequency signal based on the second information, a low frequency temporal envelope modifying step of modifying the temporal envelope shape of the decoded low frequency signal, based on the temporal envelope shape determined by the low frequency temporal envelope shape determining step, and outputting the modified low frequency signal, and a low frequency/high frequency signal combining step of receiving the low frequency signal whose temporal envelope shape is modified obtained in the low frequency temporal envelope modifying step, receiving the high frequency signal obtained in the high frequency decoding step and combining the low frequency signal whose temporal envelope shape is modified and the high frequency signal to obtain a speech signal to be output.

A speech decoding method according to the third aspect is a speech decoding method executed by a speech decoding device that decodes an encoded speech signal to output a speech signal. The speech decoding method comprises a code sequence inverse multiplexing step of dividing a code sequence including the encoded speech signal into at least a code sequence including encoded information of a low frequency signal of the speech signal and a code sequence including encoded information of a high frequency signal of the speech signal, a low frequency decoding step of receiving and decoding the code sequence including encoded information of the low frequency signal obtained by division to obtain a low frequency signal, a high frequency decoding step of receiving first information obtained in at least one of the code sequence inverse multiplexing step and the low frequency decoding step and generating a high frequency signal based on the first information, a high frequency temporal envelope shape determining step of receiving second information obtained in at least one of the code sequence inverse multiplexing step, the low frequency decoding step and the high frequency decoding step and determining a temporal envelope shape of the generated high frequency signal based on the second information, a high frequency temporal envelope modifying step of modifying the temporal envelope shape of the generated high frequency signal, based on the temporal envelope shape determined by the high frequency temporal envelope shape determining step, and outputting the modified high frequency signal, and a low frequency/high frequency signal combining step of receiving the low frequency signal obtained in the low frequency decoding step, receiving the high frequency signal whose temporal envelope shape is modified obtained in the high frequency temporal envelope modifying step and combining the low frequency signal and the high frequency signal whose temporal envelope shape is modified to obtain a speech signal to be output.

A speech decoding method according to the fourth aspect is a speech decoding method executed by a speech decoding device that decodes an encoded speech signal to output a speech signal. The speech decoding method comprises a code sequence inverse multiplexing step of dividing a code sequence including the encoded speech signal into at least a code sequence including encoded information of a low frequency signal of the speech signal and a code sequence including encoded information of a high frequency signal of the speech signal, a low frequency decoding step of receiving and decoding the code sequence including encoded information of the low frequency signal obtained in the code sequence inverse multiplexing step to obtain a low frequency signal, a high frequency decoding step of receiving first information obtained in at least one of the code sequence inverse multiplexing step and the low frequency decoding step and generating a high frequency signal based on the first information, a low frequency temporal envelope shape determining step of receiving second information obtained in at least one of the code sequence inverse multiplexing step and the low frequency decoding step and determining a temporal envelope shape of the decoded low frequency signal based on the second information, a low frequency temporal envelope modifying step of modifying the temporal envelope shape of the decoded low frequency signal, based on the temporal envelope shape determined by the low frequency temporal envelope shape determining step, and outputting the modified low frequency signal, a high frequency temporal envelope shape determining step of receiving third information from at least one of the code sequence inverse multiplexing step, the low frequency decoding step and the high frequency decoding step and determining a temporal envelope shape of the generated high frequency signal based on the third information, a high frequency temporal envelope modifying step of modifying the temporal envelope shape of the generated high frequency signal, based on the temporal envelope shape determined by the high frequency temporal envelope shape determining step, and outputting the modified high frequency signal, and a low frequency/high frequency signal combining step of receiving the low frequency signal whose temporal envelope shape is modified obtained in the low frequency temporal envelope modifying step, receiving the high frequency signal whose temporal envelope shape is modified obtained in the high frequency temporal envelope modifying step and combining the low frequency signal whose temporal envelope shape is modified and the high frequency signal whose temporal envelope shape is modified to obtain a speech signal to be output.

Furthermore, the invention of the speech decoding device according to the foregoing first to fourth aspects can be understood as an invention of a speech decoding program and can be described as follows.

A speech decoding program according to the first aspect is a speech decoding program for causing a computer provided in a speech decoding device, which decodes an encoded speech signal to output a speech signal, to function as a code sequence analyzer that analyzes a code sequence including the encoded speech signal, a speech decoder that receives and decodes the code sequence including the encoded speech signal from the code sequence analyzer to obtain a speech signal, a temporal envelope shape determiner that receives information from at least one of the code sequence analyzer and the speech decoder and determines a temporal envelope shape of the decoded speech signal based on the information, and a temporal envelope modifier that modifies the temporal envelope shape of the decoded speech signal, based on the temporal envelope shape determined by the temporal envelope shape determiner, and outputs the modified speech signal.

A speech decoding program according to the second aspect is a speech decoding program for causing a computer provided in a speech decoding device, which decodes an encoded speech signal to output a speech signal, to function as a code sequence demultiplexer that divides a code sequence including the encoded speech signal into at least a code sequence including encoded information of a low frequency signal of the speech signal and a code sequence including encoded information of a high frequency signal of the speech signal, a low frequency decoder that receives and decodes the code sequence including encoded information of the low frequency signal from the code sequence demultiplexer to obtain a low frequency signal, a high frequency decoder that receives first information from at least one of the code sequence demultiplexer and the low frequency decoder and generates a high frequency signal based on the first information, a low frequency temporal envelope shape determiner that receives second information from at least one of the code sequence demultiplexer and the low frequency decoder and determines a temporal envelope shape of the decoded low frequency signal based on the second information, a low frequency temporal envelope modifier that modifies the temporal envelope shape of the decoded low frequency signal, based on the temporal envelope shape determined by the low frequency temporal envelope shape determiner, and outputs the modified low frequency signal, and a low frequency/high frequency signal combiner that receives the low frequency signal whose temporal envelope shape is modified from the low frequency temporal envelope modifier, receives the high frequency signal from the high frequency decoder and combines the low frequency signal whose temporal envelope shape is modified and the high frequency signal to obtain a speech signal to be output.

A speech decoding program according to the third aspect is a speech decoding program for causing a computer provided in a speech decoding device, which decodes an encoded speech signal to output a speech signal, to function as a code sequence demultiplexer that divides a code sequence including the encoded speech signal into at least a code sequence including encoded information of a low frequency signal of the speech signal and a code sequence including encoded information of a high frequency signal of the speech signal, a low frequency decoder that receives and decodes the code sequence including encoded information of the low frequency signal from the code sequence demultiplexer to obtain a low frequency signal, a high frequency decoder that receives first information from at least one of the code sequence demultiplexer and the low frequency decoder and generates a high frequency signal based on the first information, a high frequency temporal envelope shape determiner that receives second information from at least one of the code sequence demultiplexer, the low frequency decoder and the high frequency decoder and determines a temporal envelope shape of the generated high frequency signal based on the second information, a high frequency temporal envelope modifier that modifies the temporal envelope shape of the generated high frequency signal, based on the temporal envelope shape determined by the high frequency temporal envelope shape determiner, and outputs the modified high frequency signal, and a low frequency/high frequency signal combiner that receives the low frequency signal from the low frequency decoder, receives the high frequency signal whose temporal envelope shape is modified from the high frequency temporal envelope modifier and combines the low frequency signal and the high frequency signal whose temporal envelope shape is modified to obtain a speech signal to be output.

A speech decoding program according to the fourth aspect is a speech decoding program for causing a computer provided in a speech decoding device, which decodes an encoded speech signal to output a speech signal, to function as a code sequence demultiplexer that divides a code sequence including the encoded speech signal into at least a code sequence including encoded information of a low frequency signal of the speech signal and a code sequence including encoded information of a high frequency signal of the speech signal, a low frequency decoder that receives and decodes the code sequence including encoded information of the low frequency signal from the code sequence demultiplexer to obtain a low frequency signal, a high frequency decoder that receives first information from at least one of the code sequence demultiplexer and the low frequency decoder and generates a high frequency signal based on the first information, a low frequency temporal envelope shape determiner that receives second information from at least one of the code sequence demultiplexer and the low frequency decoder, and determines a temporal envelope shape of the decoded low frequency signal based on the second information, a low frequency temporal envelope modifier that modifies the temporal envelope shape of the decoded low frequency signal, based on the temporal envelope shape determined by the low frequency temporal envelope shape determiner, and outputs the modified low frequency signal, a high frequency temporal envelope shape determiner that receives third information from at least one of the code sequence demultiplexer, the low frequency decoder and the high frequency decoder and determines a temporal envelope shape of the generated high frequency signal based on the third information, a high frequency temporal envelope modifier that modifies the temporal envelope shape of the generated high frequency signal, based on the temporal envelope shape determined by the high frequency temporal envelope shape determiner, and outputs the modified high frequency signal, and a low frequency/high frequency signal combiner that receives the low frequency signal whose temporal envelope shape is modified from the low frequency temporal envelope modifier, receives the high frequency signal whose temporal envelope shape is modified from the high frequency temporal envelope modifier and combines the low frequency signal whose temporal envelope shape is modified and the high frequency signal whose temporal envelope shape is modified to obtain a speech signal to be output.

The applicant invented a speech encoding device characterized in having the following first to fourth aspects in order to achieve the object above.

A speech encoding device according to the first aspect is a speech encoding device that encodes an input speech signal to output a code sequence. The speech encoding device comprises a speech encoder that encodes the speech signal, a temporal envelope information encoder that calculates and encodes temporal envelope information of the speech signal, and a code sequence multiplexer that multiplexes a code sequence including the speech signal obtained by the speech encoder and a code sequence of the temporal envelope information obtained by the temporal envelope information encoder.

A speech encoding device according to the second aspect is a speech encoding device that encodes an input speech signal to output a code sequence. The speech encoding device comprises a low frequency encoder that encodes a low frequency component of the speech signal, a high frequency encoder that encodes a high frequency component of the speech signal, a low frequency temporal envelope information encoder that calculates and encodes temporal envelope information of the low frequency component, based on at least one of the speech signal, an encoding result in the low frequency encoder and information obtained in a process of the low frequency encoding, and a code sequence multiplexer that multiplexes a code sequence including the low frequency component obtained by the low frequency encoder, a code sequence including the high frequency component obtained by the high frequency encoder and a code sequence of the temporal envelope information of the low frequency component obtained by the low frequency temporal envelope information encoder.

A speech encoding device according to the third aspect is a speech encoding device that encodes an input speech signal to output a code sequence. The speech encoding device comprises a low frequency encoder that encodes a low frequency component of the speech signal, a high frequency encoder that encodes a high frequency component of the speech signal, a high frequency temporal envelope information encoder that calculates and encodes temporal envelope information of the high frequency component, based on at least one of the speech signal, an encoding result in the low frequency encoder, information obtained in a process of the low frequency encoding, an encoding result in the high frequency encoder and information obtained in a process of the high frequency encoding, and a code sequence multiplexer that multiplexes a code sequence including the low frequency component obtained by the low frequency encoder, a code sequence including the high frequency component obtained by the high frequency encoder and a code sequence of the temporal envelope information of the high frequency component obtained by the high frequency temporal envelope information encoder.

A speech encoding device according to the fourth aspect is a speech encoding device that encodes an input speech signal to output a code sequence. The speech encoding device comprises a low frequency encoder that encodes a low frequency component of the speech signal, a high frequency encoder that encodes a high frequency component of the speech signal, a low frequency temporal envelope information encoder that calculates and encodes temporal envelope information of the low frequency component, based on at least one of the speech signal, an encoding result in the low frequency encoder and information obtained in a process of the low frequency encoding, a high frequency temporal envelope information encoder that calculates and encodes temporal envelope information of the high frequency component, based on at least one of the speech signal, an encoding result in the low frequency encoder, information obtained in a process of the low frequency encoding, an encoding result in the high frequency encoder and information obtained in a process of the high frequency encoding, and a code sequence multiplexer that multiplexes a code sequence including the low frequency component obtained by the low frequency encoder, a code sequence including the high frequency component obtained by the high frequency encoder, a code sequence of the temporal envelope information of the low frequency component obtained by the low frequency temporal envelope information encoder and a code sequence of the temporal envelope information of the high frequency component obtained by the high frequency temporal envelope information encoder.

The invention of the speech encoding device according to the foregoing first to fourth aspects can be understood as an invention of a speech encoding method and can be described as follows.

A speech encoding method according to the first aspect is a speech encoding method executed by a speech encoding device that encodes an input speech signal to output a code sequence. The speech encoding method comprises a speech encoding step of encoding the speech signal, a temporal envelope information encoding step of calculating and encoding temporal envelope information of the speech signal, and a code sequence multiplexing step of multiplexing a code sequence including the speech signal obtained in the speech encoding step and a code sequence of the temporal envelope information obtained in the temporal envelope information encoding step.

A speech encoding method according to the second aspect is a speech encoding method executed by a speech encoding device that encodes an input speech signal to output a code sequence. The speech encoding method comprises a low frequency encoding step of encoding a low frequency component of the speech signal, a high frequency encoding step of encoding a high frequency component of the speech signal, a low frequency temporal envelope information encoding step of calculating and encoding temporal envelope information of the low frequency component, based on at least one of the speech signal, an encoding result in the low frequency encoding step and information obtained in a process of the low frequency encoding, and a code sequence multiplexing step of multiplexing a code sequence including the low frequency component obtained in the low frequency encoding step, a code sequence including the high frequency component obtained in the high frequency encoding step and a code sequence of the temporal envelope information of the low frequency component obtained in the low frequency temporal envelope information encoding step.

A speech encoding method according to the second aspect is a speech encoding method executed by a speech encoding device that encodes an input speech signal to output a code sequence. The speech encoding method comprises a low frequency encoding step of encoding a low frequency component of the speech signal, a high frequency encoding step of encoding a high frequency component of the speech signal, a high frequency temporal envelope information encoding step of calculating and encoding temporal envelope information of the high frequency component, based on at least one of the speech signal, an encoding result in the low frequency encoding step, information obtained in a process of the low frequency encoding, an encoding result in the high frequency encoding step and information obtained in a process of the high frequency encoding, and a code sequence multiplexing step of multiplexing a code sequence including the low frequency component obtained in the low frequency encoding step, a code sequence including the high frequency component obtained in the high frequency encoding step and a code sequence of the temporal envelope information of the high frequency component obtained in the high frequency temporal envelope information encoding step.

A speech encoding method according to the fourth aspect is a speech encoding method executed by a speech encoding device that encodes an input speech signal to output a code sequence. The speech encoding method comprises a low frequency encoding step of encoding a low frequency component of the speech signal, a high frequency encoding step of encoding a high frequency component of the speech signal, a low frequency temporal envelope information encoding step of calculating and encoding temporal envelope information of the low frequency component, based on at least one of the speech signal, an encoding result in the low frequency encoding step and information obtained in a process of the low frequency encoding, a high frequency temporal envelope information encoding step of calculating and encoding temporal envelope information of the high frequency component, based on at least one of the speech signal, an encoding result in the low frequency encoding step, information obtained in a process of the low frequency encoding, an encoding result in the high frequency encoding step and information obtained in a process of the high frequency encoding, and a code sequence multiplexing step of multiplexing a code sequence including the low frequency component obtained in the low frequency encoding step, a code sequence including the high frequency component obtained in the high frequency encoding step, a code sequence of the temporal envelope information of the low frequency component obtained in the low frequency temporal envelope information encoding step and a code sequence of the temporal envelope information of the high frequency component obtained in the high frequency temporal envelope information encoding step.

The invention of the speech encoding device according to the foregoing first to fourth aspects can be understood as an invention of a speech encoding program and can be described as follows.

A speech encoding program according to the first aspect is a speech encoding program for causing a computer provided in a speech encoding device, which encodes an input speech signal to output a code sequence, to function as a speech encoder that encodes the speech signal, a temporal envelope information encoder that calculates and encodes temporal envelope information of the speech signal, and a code sequence multiplexer that multiplexes a code sequence including the speech signal obtained by the speech encoder and a code sequence of the temporal envelope information obtained by the temporal envelope information encoder.

A speech encoding program according to the second aspect is a speech encoding program for causing a computer provided in a speech encoding device, which encodes an input speech signal to output a code sequence, to function as a low frequency encoder that encodes a low frequency component of the speech signal, a high frequency encoder that encodes a high frequency component of the speech signal, a low frequency temporal envelope information encoder that calculates and encodes temporal envelope information of the low frequency component, based on at least one of the speech signal, an encoding result in the low frequency encoder and information obtained in a process of the low frequency encoding, and a code sequence multiplexer that multiplexes a code sequence including the low frequency component obtained by the low frequency encoder, a code sequence including the high frequency component obtained by the high frequency encoder and a code sequence of the temporal envelope information of the low frequency component obtained by the low frequency temporal envelope information encoder.

A speech encoding program according to the third aspect is a speech encoding program for causing a computer provided in a speech encoding device, which encodes an input speech signal to output a code sequence, to function as a low frequency encoder that encodes a low frequency component of the speech signal, a high frequency encoder that encodes a high frequency component of the speech signal, a high frequency temporal envelope information encoder that calculates and encodes temporal envelope information of the high frequency component, based on at least one of the speech signal, an encoding result in the low frequency encoder, information obtained in a process of the low frequency encoding, an encoding result in the high frequency encoder and information obtained in a process of the high frequency encoding, and a code sequence multiplexer that multiplexes a code sequence including the low frequency component obtained by the low frequency encoder, a code sequence including the high frequency component obtained by the high frequency encoder and a code sequence of the temporal envelope information of the high frequency component obtained by the high frequency temporal envelope information encoder.

A speech encoding program according to the fourth aspect is a speech encoding program for causing a computer provided in a speech encoding device, which encodes an input speech signal to output a code sequence, to function as a low frequency encoder that encodes a low frequency component of the speech signal, a high frequency encoder that encodes a high frequency component of the speech signal, a low frequency temporal envelope information encoder that calculates and encodes temporal envelope information of the low frequency component, based on at least one of the speech signal, an encoding result in the low frequency encoder and information obtained in a process of the low frequency encoding, a high frequency temporal envelope information encoder that calculates and encodes temporal envelope information of the high frequency component, based on at least one of the speech signal, an encoding result in the low frequency encoder, information obtained in a process of the low frequency encoding, an encoding result in the high frequency encoder and information obtained in a process of the high frequency encoding, and a code sequence multiplexer that multiplexes a code sequence including the low frequency component obtained by the low frequency encoder, a code sequence including the high frequency component obtained by the high frequency encoder, a code sequence of the temporal envelope information of the low frequency component obtained by the low frequency temporal envelope information encoder and a code sequence of the temporal envelope information of the high frequency component obtained by the high frequency temporal envelope information encoder.

The applicant invented a speech decoding device characterized in having the following fifth to sixth aspects in order to achieve the object above.

A speech decoding device according to the fifth aspect is a speech decoding device that decodes an encoded speech signal to output a speech signal. The speech decoding device comprises a code sequence demultiplexer that divides a code sequence including the encoded speech signal into at least a code sequence including encoded information of a low frequency signal of the speech signal and a code sequence including encoded information of a high frequency signal of the speech signal, a low frequency decoder that receives and decodes the code sequence including encoded information of the low frequency signal from the code sequence demultiplexer to obtain a low frequency signal, a high frequency decoder that receives information from at least one of the code sequence demultiplexer and the low frequency decoder and generates a high frequency signal based on the information, a temporal envelope shape determiner that receives information from at least one of the code sequence demultiplexer, the low frequency decoder and the high frequency decoder and determines temporal envelope shapes of the decoded low frequency signal and the generated high frequency signal, a low frequency temporal envelope modifier that modifies the temporal envelope shape of the decoded low frequency signal, based on the temporal envelope shape determined by the temporal envelope shape determiner, and outputs the modified low frequency signal, a high frequency temporal envelope modifier that modifies the temporal envelope shape of the generated high frequency signal, based on the temporal envelope shape determined by the temporal envelope shape determiner, and outputs the modified high frequency signal, and a low frequency/high frequency signal combiner that receives the low frequency signal modified in temporal envelope from the low frequency temporal envelope modifier, receives the high frequency signal modified in temporal envelope from the high frequency temporal envelope modifier and synthesizes a speech signal to be output.

A speech decoding device according to the sixth aspect is a speech decoding device that decodes an encoded speech signal to output a speech signal. The speech decoding device comprises a code sequence demultiplexer that divides a code sequence including the encoded speech signal into at least a code sequence including encoded information of a low frequency signal of the speech signal and a code sequence including encoded information of a high frequency signal of the speech signal, a low frequency decoder that receives and decodes the code sequence including encoded information of the low frequency signal from the code sequence demultiplexer to obtain a low frequency signal, a high frequency decoder that receives information from at least one of the code sequence demultiplexer and the low frequency decoder and generates a high frequency signal based on the information, a temporal envelope shape determiner that receives information from at least one of the code sequence demultiplexer, the low frequency decoder and the high frequency decoder and determines temporal envelope shapes of the decoded low frequency signal and the generated high frequency signal, a temporal envelope modifier that receives the decoded low frequency signal from the low frequency decoder, receives the generated high frequency signal from the high frequency decoder, modifies the temporal envelope shapes of the decoded low frequency signal and the generated high frequency signal, based on the temporal envelope shapes determined by the temporal envelope shape determiner, and outputs the modified low frequency signal and high frequency signal, and a low frequency/high frequency signal combiner that receives the low frequency signal and high frequency signal modified in temporal envelope from the temporal envelope modifier and synthesizes a speech signal to be output.

In the speech decoding device according to the fifth aspect, the high frequency decoder may receive information from at least one of the code sequence demultiplexer, the low frequency decoder and the low frequency temporal envelope modifier, and may generate a high frequency signal based on the information.

Furthermore, in the speech decoding device according to the fifth aspect, the high frequency temporal envelope modifier may modify a temporal envelope shape of an intermediate signal appearing when generating a high frequency signal in the high frequency decoder, based on the temporal envelope shape determined by the temporal envelope shape determiner, and the high frequency decoder may carry out a process of generating a residual high frequency signal based on the intermediate signal whose temporal envelope shape is modified.

Furthermore, in the speech decoding device according to the sixth aspect, the high frequency decoder may receive information from at least one of the code sequence demultiplexer and the low frequency decoder and may generate a high frequency signal based on the information.

Furthermore, in the speech decoding device according to the sixth aspect, the temporal envelope modifier may modify a temporal envelope shape of an intermediate signal appearing when generating a high frequency signal in the high frequency decoder, based on the temporal envelope shape determined by the temporal envelope shape determiner, and the high frequency decoder may carry out a process of generating a residual high frequency signal based on the intermediate signal whose temporal envelope shape is modified.

The invention of the speech decoding device according to the foregoing fifth and sixth aspects may be understood as an invention of a speech decoding method and can be described as follows.

A speech decoding method according to the fifth aspect is a speech decoding method executed by a speech decoding device that decodes an encoded speech signal to output a speech signal. The speech decoding method comprises a code sequence inverse multiplexing step of dividing a code sequence including the encoded speech signal into at least a code sequence including encoded information of a low frequency signal of the speech signal and a code sequence including encoded information of a high frequency signal of the speech signal, a low frequency decoding step of receiving and decoding the code sequence including encoded information of the low frequency signal obtained by division to obtain a low frequency signal, a high frequency decoding step of receiving information obtained in at least one of the code sequence inverse multiplexing step and the low frequency decoding step and generating a high frequency signal based on the information, a temporal envelope shape determining step of receiving information obtained in at least one of the code sequence inverse multiplexing step, the low frequency decoding step and the high frequency decoding step and determining temporal envelope shapes of the decoded low frequency signal and the generated high frequency signal, a low frequency temporal envelope modifying step of modifying the temporal envelope shape of the decoded low frequency signal, based on the temporal envelope shape determined by the temporal envelope shape determining step, and outputting the modified low frequency signal, a high frequency temporal envelope modifying step of modifying the temporal envelope shape of the generated high frequency signal, based on the temporal envelope shape determined by the temporal envelope shape determining step, and outputting the modified high frequency signal, and a low frequency/high frequency signal combining step of receiving the low frequency signal modified in temporal envelope obtained in the low frequency temporal envelope modifying step, receiving the high frequency signal modified in temporal envelope obtained in the high frequency temporal envelope modifying step and synthesizing a speech signal to be output.

A speech decoding method according to the sixth aspect is a speech decoding method executed by a speech decoding device that decodes an encoded speech signal to output a speech signal. The speech decoding method comprises a code sequence inverse multiplexing step of dividing a code sequence including the encoded speech signal into at least a code sequence including encoded information of a low frequency signal of the speech signal and a code sequence including encoded information of a high frequency signal of the speech signal, a low frequency decoding step of receiving and decoding the code sequence including encoded information of the low frequency signal obtained by division to obtain a low frequency signal, a high frequency decoding step of receiving information obtained in at least one of the code sequence inverse multiplexing step and the low frequency decoding step and generating a high frequency signal based on the information, a temporal envelope shape determining step of receiving information obtained in at least one of the code sequence inverse multiplexing step, the low frequency decoding step and the high frequency decoding step and determining temporal envelope shapes of the decoded low frequency signal and the generated high frequency signal, a temporal envelope modifying step of receiving the decoded low frequency signal obtained in the low frequency decoding step, receiving the generated high frequency signal obtained in the high frequency decoding step, modifying the temporal envelope shapes of the decoded low frequency signal and the generated high frequency signal, based on the temporal envelope shapes determined by the temporal envelope shape determining step, and outputting the modified low frequency signal and high frequency signal, and a low frequency/high frequency signal combining step of receiving the low frequency signal and high frequency signal modified in temporal envelope obtained in the temporal envelope modifying step and synthesizing a speech signal to be output.

The invention of the speech decoding device according to the foregoing fifth to sixth aspects may be understood as an invention of a speech decoding program and can be described as follows.

A speech decoding program according to the fifth aspect is a speech decoding program for causing a computer provided in a speech decoding device, which decodes an encoded speech signal to output a speech signal, to function as a code sequence demultiplexer that divides a code sequence including the encoded speech signal into at least a code sequence including encoded information of a low frequency signal of the speech signal and a code sequence including encoded information of a high frequency signal of the speech signal, a low frequency decoder that receives and decodes the code sequence including encoded information of the low frequency signal from the code sequence demultiplexer to obtain a low frequency signal, a high frequency decoder that receives information from at least one of the code sequence demultiplexer and the low frequency decoder and generates a high frequency signal, based on the information, a temporal envelope shape determiner that receives information from at least one of the code sequence demultiplexer, the low frequency decoder and the high frequency decoder and determines temporal envelope shapes of the decoded low frequency signal and the generated high frequency signal, a low frequency temporal envelope modifier that modifies the temporal envelope shape of the decoded low frequency signal, based on the temporal envelope shape determined by the temporal envelope shape determiner, and outputs the modified low frequency signal, a high frequency temporal envelope modifier that modifies the temporal envelope shape of the generated high frequency signal, based on the temporal envelope shape determined by the temporal envelope shape determiner, and outputs the modified high frequency signal, and a low frequency/high frequency signal combiner that receives the low frequency signal modified in temporal envelope from the low frequency temporal envelope modifier, receives the high frequency signal modified in temporal envelope from the high frequency temporal envelope modifier and synthesizes a speech signal to be output.

A speech decoding program according to the sixth aspect is a speech decoding program for causing a computer provided in a speech decoding device, which decodes an encoded speech signal to output a speech signal, to function as a code sequence demultiplexer that divides a code sequence including the encoded speech signal into at least a code sequence including encoded information of a low frequency signal of the speech signal and a code sequence including encoded information of a high frequency signal of the speech signal, a low frequency decoder that receives and decodes the code sequence including encoded information of the low frequency signal from the code sequence demultiplexer to obtain a low frequency signal, a high frequency decoder that receives information from at least one of the code sequence demultiplexer and the low frequency decoder and generates a high frequency signal based on the information, a temporal envelope shape determiner that receives information from at least one of the code sequence demultiplexer, the low frequency decoder and the high frequency decoder and determines temporal envelope shapes of the decoded low frequency signal and the generated high frequency signal, a temporal envelope modifier that receives the decoded low frequency signal from the low frequency decoder, receives the generated high frequency signal from the high frequency decoder, modifies the temporal envelope shapes of the decoded low frequency signal and the generated high frequency signal, based on the temporal envelope shapes determined by the temporal envelope shape determiner, and outputs the modified low frequency signal and high frequency signal, and a low frequency/high frequency signal combiner that receives the low frequency signal and high frequency signal modified in temporal envelope from the temporal envelope modifier and synthesizes a speech signal to be output.

The present invention is also directed to a speech decoding device that decodes an encoded speech signal to output a speech signal, the speech decoding device comprising:
a code sequence analyzer that analyzes a code sequence including the encoded speech signal;
a speech decoder that receives and decodes the code sequence including the encoded speech signal from the code sequence analyzer to obtain a speech signal;
a temporal envelope shape determiner that receives information from at least one of the code sequence analyzer and the speech decoder and determines a temporal envelope shape of the decoded speech signal based on the information; and a temporal envelope modifier that modifies the temporal envelope shape of the decoded speech signal based on the temporal envelope shape determined by the temporal envelope shape determiner and outputs the modified speech signal.

The present invention is also directed to a speech decoding device that decodes an encoded speech signal to output a speech signal, the speech decoding device comprising:
a code sequence demultiplexer that divides a code sequence including the encoded speech signal into at least a code sequence including encoded information of a low frequency signal of the speech signal and a code sequence including encoded information of a high frequency signal of the speech signal;
a low frequency decoder that receives from the code sequence demultiplexer and decodes the code sequence including encoded information of the low frequency signal to obtain a low frequency signal;
a high frequency decoder that receives first information from at least one of the code sequence demultiplexer and the low frequency decoder and generates a high frequency signal based on the first information;
a low frequency temporal envelope shape determiner that receives second information from at least one of the code sequence demultiplexer and the low frequency decoder and determines a temporal envelope shape of the decoded low frequency signal based on the second information;
a low frequency temporal envelope modifier that modifies the temporal envelope shape of the decoded low frequency signal based on the temporal envelope shape determined by the low frequency temporal envelope shape determiner and outputs the modified low frequency signal; and
a low frequency/high frequency signal combiner that receives the low frequency signal, whose temporal envelope shape is modified, from the low frequency temporal envelope modifier, receives the high frequency signal from the high frequency decoder and combines the low frequency signal, whose temporal envelope shape is modified, and the high frequency signal to obtain a speech signal to be output.

The present invention is also directed to a speech decoding device that decodes an encoded speech signal to output a speech signal, the speech decoding device comprising:
a code sequence demultiplexer that divides a code sequence including the encoded speech signal into at least a code sequence including encoded information of a low frequency signal of the speech signal and a code sequence including encoded information of a high frequency signal of the speech signal;
a low frequency decoder that receives from the code sequence demultiplexer and decodes the code sequence including encoded information of the low frequency signal to obtain a low frequency signal;
a high frequency decoder that receives first information from at least one of the code sequence demultiplexer and the low frequency decoder and generates a high frequency signal based on the first information;
a low frequency temporal envelope shape determiner that receives second information from at least one of the code sequence demultiplexer and the low frequency decoder and determines a temporal envelope shape of the decoded low frequency signal based on the second information;
a low frequency temporal envelope modifier that modifies the temporal envelope shape of the decoded low frequency signal based on the temporal envelope shape determined by the low frequency temporal envelope shape determiner and outputs the modified low frequency signal;
a high frequency temporal envelope shape determiner that receives third information from at least one of the code sequence demultiplexer, the low frequency decoder and the high frequency decoder and determines a temporal envelope shape of the generated high frequency signal based on the third information;
a high frequency temporal envelope modifier that modifies the temporal envelope shape of the generated high frequency signal based on the temporal envelope shape determined by the high frequency temporal envelope shape determiner and outputs the modified high frequency signal; and
a low frequency/high frequency signal combiner that receives the low frequency signal, whose temporal envelope shape is modified, from the low frequency temporal envelope modifier, receives the high frequency signal, whose temporal envelope shape is modified, from the high frequency temporal envelope modifier and combines the low frequency signal, whose temporal envelope shape is modified, and the high frequency signal, whose temporal envelope shape is modified, to obtain a speech signal to be output.

In the speech decoding device discussed above, the high frequency decoder receives information from at least one of the code sequence demultiplexer, the low frequency decoder and the low frequency temporal envelope modifier and generates a high frequency signal based on the information.

In the speech decoding device discussed above, the high frequency temporal envelope modifier modifies, based on the temporal envelope shape determined by the high frequency temporal envelope shape determiner, a temporal envelope shape of an intermediate signal appearing when the high frequency decoder generates a high frequency signal, and
the high frequency decoder generates a residual high frequency signal based on the intermediate signal whose temporal envelope shape is modified.

The present invention is also directed to a speech encoding device that encodes an input speech signal to output a code sequence, the speech encoding device comprising:
a speech encoder that encodes the speech signal;
a temporal envelope information encoder that calculates and encodes temporal envelope information of the speech signal; and
a code sequence multiplexer that multiplexes a code sequence including the speech signal obtained by the speech encoder and a code sequence of the temporal envelope information obtained by the temporal envelope information encoder.

The present invention is also directed to a speech encoding device that encodes an input speech signal to output a code sequence, the speech encoding device comprising:
a low frequency encoder that encodes a low frequency component of the speech signal;
a high frequency encoder that encodes a high frequency component of the speech signal;
a low frequency temporal envelope information encoder that calculates and encodes temporal envelope information of the low frequency component, based on at least one of the speech signal, an encoding result in the low frequency encoder and information obtained in a process of the low frequency encoding; and
a code sequence multiplexer that multiplexes a code sequence including the low frequency component obtained by the low frequency encoder, a code sequence including the high frequency component obtained by the high frequency encoder and a code sequence of the temporal envelope information of the low frequency component obtained by the low frequency temporal envelope information encoder.

The present invention is also directed to a speech encoding device that encodes an input speech signal to output a code sequence, the speech encoding device comprising:
a low frequency encoder that encodes a low frequency component of the speech signal;
a high frequency encoder that encodes a high frequency component of the speech signal;
a low frequency temporal envelope information encoder that calculates and encodes temporal envelope information of the low frequency component, based on at least one of the speech signal, an encoding result in the low frequency encoder and information obtained in a process of the low frequency encoding;
a high frequency temporal envelope information encoder that calculates and encodes temporal envelope information of the high frequency component, based on at least one of the speech signal, an encoding result in the low frequency encoder, information obtained in a process of the low frequency encoding, an encoding result in the high frequency encoder and information obtained in a process of the high frequency encoding; and
a code sequence multiplexer that multiplexes a code sequence including the low frequency component obtained by the low frequency encoder, a code sequence including the high frequency component obtained by the high frequency encoder, a code sequence of the temporal envelope information of the low frequency component obtained by the low frequency temporal envelope information encoder and a code sequence of the temporal envelope information of the high frequency component obtained by the high frequency temporal envelope information encoder.

The present invention is also directed to a speech decoding method executed by a speech decoding device that decodes an encoded speech signal to output a speech signal, the speech decoding method comprising:
a code sequence analyzing step of analyzing a code sequence including the encoded speech signal;
a speech decoding step of receiving and decoding the analyzed code sequence including the encoded speech signal to obtain a speech signal;
a temporal envelope shape determining step of receiving information obtained in at least one of the code sequence analyzing step and the speech decoding step, and determining a temporal envelope shape of the decoded speech signal based on the information; and
a temporal envelope modifying step of modifying the temporal envelope shape of the decoded speech signal based on the temporal envelope shape determined in the temporal envelope shape determining step and outputting the modified speech signal.

The present invention is also directed to a speech decoding method executed by a speech decoding device that decodes an encoded speech signal to output a speech signal, the speech decoding method comprising:
a code sequence inverse multiplexing step of dividing a code sequence including the encoded speech signal into at least a code sequence including encoded information of a low frequency signal of the speech signal and a code sequence including encoded information of a high frequency signal of the speech signal;
a low frequency decoding step of receiving and decoding the code sequence including encoded information of the low frequency signal obtained by division to obtain a low frequency signal;
a high frequency decoding step of receiving first information obtained in at least one of the code sequence inverse multiplexing step and the low frequency decoding step and generating a high frequency signal based on the first information;
a low frequency temporal envelope shape determining step of receiving second information obtained in at least one of the code sequence inverse multiplexing step and the low frequency decoding step and determining a temporal envelope shape of the decoded low frequency signal based on the second information;
a low frequency temporal envelope modifying step of modifying the temporal envelope shape of the decoded low frequency signal based on the temporal envelope shape determined by the low frequency temporal envelope shape determining step, and outputting the modified low frequency signal; and
a low frequency/high frequency signal combining step of receiving the low frequency signal, whose temporal envelope shape is modified, obtained in the low frequency temporal envelope modifying step, receiving the high frequency signal obtained in the high frequency decoding step, and combining the low frequency signal, whose temporal envelope shape is modified, and the high frequency signal to obtain a speech signal to be output.

The present invention is also directed to a speech decoding method executed by a speech decoding device that decodes an encoded speech signal to output a speech signal, the speech decoding method comprising:
a code sequence inverse multiplexing step of dividing a code sequence including the encoded speech signal into at least a code sequence including encoded information of a low frequency signal of the speech signal and a code sequence including encoded information of a high frequency signal of the speech signal;
a low frequency decoding step of receiving and decoding the code sequence including encoded information of the low frequency signal obtained in the code sequence inverse multiplexing step to obtain a low frequency signal;
a high frequency decoding step of receiving first information obtained in at least one of the code sequence inverse multiplexing step and the low frequency decoding step and generating a high frequency signal based on the first information;
a low frequency temporal envelope shape determining step of receiving second information obtained in at least one of the code sequence inverse multiplexing step and the low frequency decoding step and determining a temporal envelope shape of the decoded low frequency signal based on the second information;
a low frequency temporal envelope modifying step of modifying the temporal envelope shape of the decoded low frequency signal based on the temporal envelope shape determined in the low frequency temporal envelope shape determining step, and outputting the modified low frequency signal;
a high frequency temporal envelope shape determining step of receiving third information from at least one of the code sequence inverse multiplexing step, the low frequency decoding step and the high frequency decoding step and determining a temporal envelope shape of the generated high frequency signal based on the third information;
a high frequency temporal envelope modifying step of modifying the temporal envelope shape of the generated high frequency signal based on the temporal envelope shape determined in the high frequency temporal envelope shape determining step and outputting the modified high frequency signal; and
a low frequency/high frequency signal combining step of receiving the low frequency signal, whose temporal envelope shape is modified, obtained in the low frequency temporal envelope modifying step, receiving the high frequency signal, whose temporal envelope shape is modified, obtained in the high frequency temporal envelope modifying step and combining the low frequency signal, whose temporal envelope shape is modified, and the high frequency signal, whose temporal envelope shape is modified, to obtain a speech signal to be output.

The present invention is also directed to a speech encoding method executed by a speech encoding device that encodes an input speech signal to output a code sequence, the speech encoding method comprising:
a speech encoding step of encoding the speech signal;
a temporal envelope information encoding step of calculating and encoding temporal envelope information of the speech signal; and
a code sequence multiplexing step of multiplexing a code sequence including the speech signal obtained in the speech encoding step and a code sequence of the temporal envelope information obtained in the temporal envelope information encoding step.

The present invention is also directed to a speech encoding method executed by a speech encoding device that encodes an input speech signal to output a code sequence, the speech encoding method comprising:
a low frequency encoding step of encoding a low frequency component of the speech signal;
a high frequency encoding step of encoding a high frequency component of the speech signal;
a low frequency temporal envelope information encoding step of calculating and encoding temporal envelope information of the low frequency component, based on at least one of the speech signal, an encoding result in the low frequency encoding step and information obtained in a process of the low frequency encoding; and
a code sequence multiplexing step of multiplexing a code sequence including the low frequency component obtained in the low frequency encoding step, a code sequence including the high frequency component obtained in the high frequency encoding step and a code sequence of the temporal envelope information of the low frequency component obtained in the low frequency temporal envelope information encoding step.

The present invention is also directed to a speech encoding method executed by a speech encoding device that encodes an input speech signal to output a code sequence, the speech encoding method comprising:
a low frequency encoding step of encoding a low frequency component of the speech signal;
a high frequency encoding step of encoding a high frequency component of the speech signal;
a low frequency temporal envelope information encoding step of calculating and encoding temporal envelope information of the low frequency component, based on at least one of the speech signal, an encoding result in the low frequency encoding step, and information obtained in the low frequency encoding step;
a high frequency temporal envelope information encoding step of calculating and encoding temporal envelope information of the high frequency component, based on at least one of the speech signal, an encoding result in the low frequency encoding step, information obtained in the low frequency encoding step, an encoding result in the high frequency encoding step and information obtained in the high frequency encoding step; and
a code sequence multiplexing step of multiplexing a code sequence including the low frequency component obtained in the low frequency encoding step, a code sequence including the high frequency component obtained in the high frequency encoding step, a code sequence of the temporal envelope information of the low frequency component obtained in the low frequency temporal envelope information encoding step, and a code sequence of the temporal envelope information of the high frequency component obtained in the high frequency temporal envelope information encoding step.

The present invention is also directed to a speech decoding program for causing a computer provided in a speech decoding device, which decodes an encoded speech signal to output a speech signal, to function as:
a code sequence analyzer that analyzes a code sequence including the encoded speech signal;
a speech decoder that receives and decodes the code sequence including the encoded speech signal from the code sequence analyzer to obtain a speech signal;
a temporal envelope shape determiner that receives information from at least one of the code sequence analyzer and the speech decoder and determines a temporal envelope shape of the decoded speech signal based on the information; and
a temporal envelope modifier that modifies the temporal envelope shape of the decoded speech signal based on the temporal envelope shape determined by the temporal envelope shape determiner, and outputs the modified speech signal.

The present invention is also directed to a speech decoding program for causing a computer provided in a speech decoding device, which decodes an encoded speech signal to output a speech signal, to function as:
a code sequence demultiplexer that divides a code sequence including the encoded speech signal into at least a code sequence including encoded information of a low frequency signal of the speech signal and a code sequence including encoded information of a high frequency signal of the speech signal;
a low frequency decoder that receives and decodes the code sequence including encoded information of the low frequency signal from the code sequence demultiplexer to obtain a low frequency signal;
a high frequency decoder that receives first information from at least one of the code sequence demultiplexer and the low frequency decoder and generates a high frequency signal based on the first information;
a low frequency temporal envelope shape determiner that receives second information from at least one of the code sequence demultiplexer and the low frequency decoder and determines a temporal envelope shape of the decoded low frequency signal based on the second information;
a low frequency temporal envelope modifier that modifies the temporal envelope shape of the decoded low frequency signal based on the temporal envelope shape determined by the low frequency temporal envelope shape determiner and outputs the modified low frequency signal; and
a low frequency/high frequency signal combiner that receives the low frequency signal, whose temporal envelope shape is modified, from the low frequency temporal envelope modifier, receives the high frequency signal from the high frequency decoder and combines the low frequency signal, whose temporal envelope shape is modified, and the high frequency signal to obtain a speech signal to be output.

The present invention is also directed to a speech decoding program for causing a computer provided in a speech decoding device, which decodes an encoded speech signal to output a speech signal, to function as:
a code sequence demultiplexer that divides a code sequence including the encoded speech signal into at least a code sequence including encoded information of a low frequency signal of the speech signal and a code sequence including encoded information of a high frequency signal of the speech signal;
a low frequency decoder that receives from the code sequence demultiplexer and decodes the code sequence including encoded information of the low frequency signal to obtain a low frequency signal;
a high frequency decoder that receives first information from at least one of the code sequence demultiplexer and the low frequency decoder and generates a high frequency signal based on the first information;
a high frequency temporal envelope shape determiner that receives second information from at least one of the code sequence demultiplexer, the low frequency decoder and the high frequency decoder and determines a temporal envelope shape of the generated high frequency signal based on the second information;
a high frequency temporal envelope modifier that modifies the temporal envelope shape of the generated high frequency signal based on the temporal envelope shape determined by the high frequency temporal envelope shape determiner and outputs the modified high frequency signal; and
a low frequency/high frequency signal combiner that receives the low frequency signal from the low frequency decoder, receives the high frequency signal, whose temporal envelope shape is modified, from the high frequency temporal envelope modifier and combines the low frequency signal and the high frequency signal, whose temporal envelope shape is modified, to obtain a speech signal to be output.

The present invention is also directed to a speech decoding program for causing a computer provided in a speech decoding device, which decodes an encoded speech signal to output a speech signal, to function as:
a code sequence demultiplexer that divides a code sequence including the encoded speech signal into at least a code sequence including encoded information of a low frequency signal of the speech signal and a code sequence including encoded information of a high frequency signal of the speech signal;
a low frequency decoder that receives from the code sequence demultiplexer and decodes the code sequence including encoded information of the low frequency signal to obtain a low frequency signal;
a high frequency decoder that receives first information from at least one of the code sequence demultiplexer and the low frequency decoder and generates a high frequency signal based on the first information;
a low frequency temporal envelope shape determiner that receives second information from at least one of the code sequence demultiplexer and the low frequency decoder and determines a temporal envelope shape of the decoded low frequency signal based on the second information;
a low frequency temporal envelope modifier that modifies the temporal envelope shape of the decoded low frequency signal based on the temporal envelope shape determined by the low frequency temporal envelope shape determiner and outputs the modified low frequency signal;
a high frequency temporal envelope shape determiner that receives third information from at least one of the code sequence demultiplexer, the low frequency decoder and the high frequency decoder and determines a temporal envelope shape of the generated high frequency signal based on the third information;
a high frequency temporal envelope modifier that modifies the temporal envelope shape of the generated high frequency signal based on the temporal envelope shape determined by the high frequency temporal envelope shape determiner, and outputs the modified high frequency signal; and
a low frequency/high frequency signal combiner that receives the low frequency signal, whose temporal envelope shape is modified, from the low frequency temporal envelope modifier, receives the high frequency signal, whose temporal envelope shape is modified, from the high frequency temporal envelope modifier and combines the low frequency signal, whose temporal envelope shape is modified, and the high frequency signal, whose temporal envelope shape is modified, to obtain a speech signal to be output.

The present invention is also directed to a speech encoding program for causing a computer provided in a speech encoding device, which encodes an input speech signal to output a code sequence, to function as:
a speech encoder that encodes the speech signal;
a temporal envelope information encoder that calculates and encodes temporal envelope information of the speech signal; and
a code sequence multiplexer that multiplexes a code sequence including the speech signal obtained by the speech encoder and a code sequence of the temporal envelope information obtained by the temporal envelope information encoder.

The present invention is also directed to a speech encoding program for causing a computer provided in a speech encoding device, which encodes an input speech signal to output a code sequence, to function as:
a low frequency encoder that encodes a low frequency component of the speech signal;
a high frequency encoder that encodes a high frequency component of the speech signal;
a low frequency temporal envelope information encoder that calculates and encodes temporal envelope information of the low frequency component, based on at least one of the speech signal, an encoding result in the low frequency encoder and information obtained by the low frequency encoder; and
a code sequence multiplexer that multiplexes a code sequence including the low frequency component obtained by the low frequency encoder, a code sequence including the high frequency component obtained by the high frequency encoder and a code sequence of the temporal envelope information of the low frequency component obtained by the low frequency temporal envelope information encoder.

The present invention is also directed to a speech encoding program for causing a computer provided in a speech encoding device, which encodes an input speech signal to output a code sequence, to function as:
a low frequency encoder that encodes a low frequency component of the speech signal;
a high frequency encoder that encodes a high frequency component of the speech signal;
a high frequency temporal envelope information encoder that calculates and encodes temporal envelope information of the high frequency component, based on at least one of the speech signal, an encoding result from the low frequency encoder, information obtained by the low frequency encoder, an encoding result from the high frequency encoder, and information obtained by the high frequency encoder; and
a code sequence multiplexer that multiplexes a code sequence including the low frequency component obtained by the low frequency encoder, a code sequence including the high frequency component obtained by the high frequency encoder, and a code sequence of the temporal envelope information of the high frequency component obtained by the high frequency temporal envelope information encoder.

The present invention is also directed to a speech encoding program for causing a computer provided in a speech encoding device, which encodes an input speech signal to output a code sequence, to function as:
a low frequency encoder that encodes a low frequency component of the speech signal;
a high frequency encoder that encodes a high frequency component of the speech signal;
a low frequency temporal envelope information encoder that calculates and encodes temporal envelope information of the low frequency component, based on at least one of the speech signal, an encoding result from the low frequency encoder and information obtained by the low frequency encoder;
a high frequency temporal envelope information encoder that calculates and encodes temporal envelope information of the high frequency component, based on at least one of the speech signal, an encoding result from the low frequency encoder, information obtained by the low frequency encoder, an encoding result from the high frequency encoder, and information obtained by the high frequency encoder; and
a code sequence multiplexer that multiplexes a code sequence including the low frequency component obtained by the low frequency encoder, a code sequence including the high frequency component obtained by the high frequency encoder, a code sequence of the temporal envelope information of the low frequency component obtained by the low frequency temporal envelope information encoder and a code sequence of the temporal envelope information of the high frequency component obtained by the high frequency temporal envelope information encoder.

The present invention is also directed to a speech decoding device that decodes an encoded speech signal to output a speech signal, the speech decoding device comprising:
a code sequence demultiplexer that divides a code sequence including the encoded speech signal into at least a code sequence including encoded information of a low frequency signal of the speech signal and a code sequence including encoded information of a high frequency signal of the speech signal;
a low frequency decoder that receives from the code sequence demultiplexer and decodes the code sequence including encoded information of the low frequency signal to obtain a low frequency signal;
a high frequency decoder that receives information from at least one of the code sequence demultiplexer and the low frequency decoder and generates a high frequency signal based on the information;
a temporal envelope shape determiner that receives information from at least one of the code sequence demultiplexer, the low frequency decoder, and the high frequency decoder and determines temporal envelope shapes of the decoded low frequency signal and the generated high frequency signal;
a low frequency temporal envelope modifier that modifies the temporal envelope shape of the decoded low frequency signal based on the temporal envelope shape determined by the temporal envelope shape determiner and outputs the modified low frequency signal;
a high frequency temporal envelope modifier that modifies the temporal envelope shape of the generated high frequency signal based on the temporal envelope shape determined by the temporal envelope shape determiner and outputs the modified high frequency signal; and
a low frequency/high frequency signal combiner that receives the low frequency signal, whose temporal envelope is modified, from the low frequency temporal envelope modifier, receives the high frequency signal, whose temporal envelope is modified, from the high frequency temporal envelope modifier and synthesizes a speech signal to be output.

The present invention is also directed to a speech decoding device that decodes an encoded speech signal to output a speech signal, the speech decoding device comprising:
a code sequence demultiplexer that divides a code sequence including the encoded speech signal into at least a code sequence including encoded information of a low frequency signal of the speech signal and a code sequence including encoded information of a high frequency signal of the speech signal;
a low frequency decoder that receives from the code sequence demultiplexer and decodes the code sequence including encoded information of the low frequency signal to obtain a low frequency signal;
a high frequency decoder that receives information from at least one of the code sequence demultiplexer and the low frequency decoder and generates a high frequency signal based on the information;
a temporal envelope shape determiner that receives information from at least one of the code sequence demultiplexer, the low frequency decoder and the high frequency decoder and determines temporal envelope shapes of the decoded low frequency signal and the generated high frequency signal;
a temporal envelope modifier that receives the decoded low frequency signal from the low frequency decoder, receives the generated high frequency signal from the high frequency decoder, modifies the temporal envelope shapes of the decoded low frequency signal and the generated high frequency signal, based on the temporal envelope shapes determined by the temporal envelope shape determiner, and outputs the modified low frequency signal and high frequency signal; and
a low frequency/high frequency signal combiner that receives the low frequency signal and high frequency signal, whose temporal envelopes are modified, from the temporal envelope modifier and synthesizes a speech signal to be output.

In the speech decoding device discussed above, the high frequency decoder receives information from at least one of the code sequence demultiplexer, the low frequency decoder and the low frequency temporal envelope modifier and generates a high frequency signal based on the information.

In the speech decoding device discussed above, the high frequency temporal envelope modifier modifies, based on the temporal envelope shape determined by the temporal envelope shape determiner, a temporal envelope shape of an intermediate signal appearing when the high frequency decoder generates a high frequency signal, and
the high frequency decoder generates a residual high frequency signal based on the intermediate signal whose temporal envelope shape is modified.

In the speech decoding device discussed above, the high frequency decoder receives information from at least one of the code sequence demultiplexer and the low frequency decoder and generates a high frequency signal based on the information.

In the speech decoding device discussed above, the temporal envelope modifier modifies, based on the temporal envelope shape determined by the temporal envelope shape determiner, a temporal envelope shape of an intermediate signal appearing when the high frequency decoder generates a high frequency signal, and
the high frequency decoder generates a residual high frequency signal based on the intermediate signal whose temporal envelope shape is modified.

The present invention is also directed to a speech decoding method executed by a speech decoding device that decodes an encoded speech signal to output a speech signal, the speech decoding method comprising:
a code sequence inverse multiplexing step of dividing a code sequence including the encoded speech signal into at least a code sequence including encoded information of a low frequency signal of the speech signal and a code sequence including encoded information of a high frequency signal of the speech signal;
a low frequency decoding step of receiving and decoding the code sequence including encoded information of the low frequency signal obtained in the code sequence inverse multiplexing step to obtain a low frequency signal;
a high frequency decoding step of receiving information obtained in at least one of the code sequence inverse multiplexing step and the low frequency decoding step and generating a high frequency signal based on the information;
a temporal envelope shape determining step of receiving information obtained in at least one of the code sequence inverse multiplexing step, the low frequency decoding step and the high frequency decoding step and determining temporal envelope shapes of the decoded low frequency signal and the generated high frequency signal;
a low frequency temporal envelope modifying step of modifying the temporal envelope shape of the decoded low frequency signal based on the temporal envelope shape determined by the temporal envelope shape determining step and outputting the modified low frequency signal;
a high frequency temporal envelope modifying step of modifying the temporal envelope shape of the generated high frequency signal based on the temporal envelope shape determined by the temporal envelope shape determining step and outputting the modified high frequency signal; and
a low frequency/high frequency signal combining step of receiving the low frequency signal modified in temporal envelope obtained in the low frequency temporal envelope modifying step, receiving the high frequency signal modified in temporal envelope obtained in the high frequency temporal envelope modifying step and synthesizing a speech signal to be output.

The present invention is also directed to a speech decoding method executed by a speech decoding device that decodes an encoded speech signal to output a speech signal, the speech decoding method comprising:
a code sequence inverse multiplexing step of dividing a code sequence including the encoded speech signal into at least a code sequence including encoded information of a low frequency signal of the speech signal and a code sequence including encoded information of a high frequency signal of the speech signal;
a low frequency decoding step of receiving and decoding the code sequence including encoded information of the low frequency signal obtained in the code sequence inverse multiplexing step to obtain a low frequency signal;
a high frequency decoding step of receiving information obtained in at least one of the code sequence inverse multiplexing step and the low frequency decoding step and generating a high frequency signal based on the information;
a temporal envelope shape determining step of receiving information obtained in at least one of the code sequence inverse multiplexing step, the low frequency decoding step and the high frequency decoding step and determining temporal envelope shapes of the decoded low frequency signal and the generated high frequency signal;
a temporal envelope modifying step of receiving the decoded low frequency signal obtained in the low frequency decoding step, receiving the generated high frequency signal obtained in the high frequency decoding step, modifying the temporal envelope shapes of the decoded low frequency signal and the generated high frequency signal, based on the temporal envelope shapes determined by the temporal envelope shape determining step and outputting the modified low frequency signal and high frequency signal; and
a low frequency/high frequency signal combining step of receiving the low frequency signal and high frequency signal, whose temporal envelopes are modified, obtained in the temporal envelope modifying step and synthesizing a speech signal to be output.

The present invention is also directed to a speech decoding program for causing a computer provided in a speech decoding device, which decodes an encoded speech signal to output a speech signal, to function as:
a code sequence demultiplexer that divides a code sequence including the encoded speech signal into at least a code sequence including encoded information of a low frequency signal of the speech signal and a code sequence including encoded information of a high frequency signal of the speech signal;
a low frequency decoder that receives from the code sequence demultiplexer and decodes the code sequence including encoded information of the low frequency signal to obtain a low frequency signal;
a high frequency decoder that receives information from at least one of the code sequence demultiplexer and the low frequency decoder and generates a high frequency signal based on the information;
a temporal envelope shape determiner that receives information from at least one of the code sequence demultiplexer, the low frequency decoder and the high frequency decoder and determines temporal envelope shapes of the decoded low frequency signal and the generated high frequency signal;
a low frequency temporal envelope modifier that modifies the temporal envelope shape of the decoded low frequency signal based on the temporal envelope shape determined by the temporal envelope shape determiner and outputs the modified low frequency signal;
a high frequency temporal envelope modifier that modifies the temporal envelope shape of the generated high frequency signal based on the temporal envelope shape determined by the temporal envelope shape determiner and outputs the modified high frequency signal; and
a low frequency/high frequency signal combiner that receives the low frequency signal modified in temporal envelope from the low frequency temporal envelope modifier, receives the high frequency signal, whose temporal envelope is modified, from the high frequency temporal envelope modifier and synthesizes a speech signal to be output.

The present invention is also directed to a a speech decoding program for causing a computer provided in a speech decoding device, which decodes an encoded speech signal to output a speech signal, to function as:
a code sequence demultiplexer that divides a code sequence including the encoded speech signal into at least a code sequence including encoded information of a low frequency signal of the speech signal and a code sequence including encoded information of a high frequency signal of the speech signal;
a low frequency decoder that receives from the code sequence demultiplexer and decodes the code sequence including encoded information of the low frequency signal to obtain a low frequency signal;
a high frequency decoder that receives information from at least one of the code sequence demultiplexer and the low frequency decoder and generates a high frequency signal based on the information;
a temporal envelope shape determiner that receives information from at least one of the code sequence demultiplexer, the low frequency decoder and the high frequency decoder and determines temporal envelope shapes of the decoded low frequency signal and the generated high frequency signal;
a temporal envelope modifier that receives the decoded low frequency signal from the low frequency decoder, receives the generated high frequency signal from the high frequency decoder, modifies the temporal envelope shapes of the decoded low frequency signal and the generated high frequency signal, based on the temporal envelope shapes determined by the temporal envelope shape determiner, and outputs the modified low frequency signal and high frequency signal; and
a low frequency/high frequency signal combiner that receives the low frequency signal and high frequency signal, whose temporal envelopes are modified, from the temporal envelope modifier and synthesizes a speech signal to be output.

### BRIEF DESCRIPTION OF THE DRAWINGS

FIG. 1 is a figure showing the configuration of the speech decoding device 1 according to a first embodiment.

FIG. 2 is a flow chart showing the operation of the speech decoding device according to the first embodiment.

FIG. 3 is a figure showing the configuration of the speech to digital converter 2 according to the first embodiment.

FIG. 4 is a flow chart showing the operation of the speech to digital converter 2 according to the first embodiment.

FIG. 5 is a figure showing the configuration of the speech decoding device 100 according to a second embodiment.

FIG. 6 is a flow chart showing the operation of the speech decoding device according to the second embodiment.

FIG. 7 is a figure showing the configuration of the speech to digital converter 200 according to the second embodiment.

FIG. 8 is a flow chart showing the operation of the speech to digital converter 200 according to the second embodiment.

FIG. 9 is a figure showing the configuration of the first modification 100A of the speech decoding device according to the second embodiment.

FIG. 10 is a flow chart showing the operation of the first modification 100A of the speech decoding device according to the second embodiment.

FIG. 11 is a figure showing the configuration of the first modification 100A of the speech to digital converter according to the second embodiment.

FIG. 12 is a figure showing the configuration of the speech decoding device 110 according to a third embodiment.

FIG. 13 is a flow chart showing the operation of the speech decoding device according to the third embodiment.

FIG. 14 is a figure showing the configuration of the speech to digital converter 210 according to the third embodiment.

FIG. 15 is a flow chart showing the operation of the speech to digital converter 210 according to the third embodiment.

FIG. 16 is a figure showing the configuration of the speech decoding device 120 according to a fourth embodiment.

FIG. 17 is a flow chart showing the operation of the speech decoding device 120 according to the fourth embodiment.

FIG. 18 is a figure showing the configuration of the speech to digital converter 220 according to the fourth embodiment.

FIG. 19 is a flow chart showing the operation of the speech to digital converter 220 according to the fourth embodiment.

FIG. 20 is a figure showing the configuration of the first modification 120A of the speech decoding device according to the fourth embodiment.

FIG. 21 is a flow chart showing the operation of the first modification 120A of the speech decoding device according to the fourth embodiment.

FIG. 22 is a figure showing the configuration of the second modification 120B of the speech decoding device according to the fourth embodiment.

FIG. 23 is a flow chart showing the operation of the second modification 120B of the speech decoding device according to the fourth embodiment.

FIG. 24 is a figure showing the configuration of the 3rd modification 120C of the speech decoding device according to the fourth embodiment.

FIG. 25 is a flow chart showing the operation of the 3rd modification 120C of the speech decoding device according to the fourth embodiment.

FIG. 26 is a figure showing the configuration of the 4th modification 120D of the speech decoding device according to the fourth embodiment.

FIG. 27 is a flow chart showing the operation of the 4th modification 120D of the speech decoding device according to the fourth embodiment.

FIG. 28 is a figure showing the configuration of the fifth modification 120E of the speech decoding device according to the fourth embodiment.

FIG. 29 is a flow chart showing the operation of the fifth modification 120E of the speech decoding device according to the fourth embodiment.

FIG. 30 is a figure showing the configuration of the sixth modification 120F of the speech decoding device according to the fourth embodiment.

FIG. 31 is a flow chart showing the operation of the sixth modification 120F of the speech decoding device according to the fourth embodiment.

FIG. 32 is a figure showing the configuration of the seventh modification 120G of the speech decoding device according to the fourth embodiment.

FIG. 33 is a flow chart showing the operation of the seventh modification 120G of the speech decoding device according to the fourth embodiment.

FIG. 34 is a figure showing the configuration of the eighth modification 120H of the speech decoding device according to the fourth embodiment.

FIG. 35 is a flow chart showing the operation of the eighth modification 120H of the speech decoding device according to the fourth embodiment.

FIG. 36 is a figure showing the configuration of the ninth modification 120I of the speech decoding device according to the fourth embodiment.

FIG. 37 is a flow chart showing the operation of the ninth modification 120I of the speech decoding device according to the fourth embodiment.

FIG. 38 is a figure showing the configuration of the tenth modification 120J of the speech decoding device according to the fourth embodiment.

FIG. 39 is a flow chart showing the operation of the tenth modification 120J of the speech decoding device according to the fourth embodiment.

FIG. 40 is a figure showing the configuration of the 11th modification 120K of the speech decoding device according to the fourth embodiment.

FIG. 41 is a flow chart showing the operation of the 11th modification 120K of the speech decoding device according to the fourth embodiment.

FIG. 42 is a figure showing the configuration of the 12th modification 120L of the speech decoding device according to the fourth embodiment.

FIG. 43 is a flow chart showing the operation of the 12th modification 120L of the speech decoding device according to the fourth embodiment.

FIG. 44 is a figure showing the configuration of the 13th modification 120M of the speech decoding device according to the fourth embodiment.

FIG. 45 is a flow chart showing the operation of the 13th modification 120M of the speech decoding device according to the fourth embodiment.

FIG. 46 is a figure showing the configuration of the 14th modification 120N of the speech decoding device according to the fourth embodiment.

FIG. 47 is a flow chart showing the operation of the 14th modification 120N of the speech decoding device according to the fourth embodiment.

FIG. 48 is a figure showing the configuration of the speech decoding device 130 according to a fifth embodiment.

FIG. 49 is a flow chart showing the operation of the speech decoding device according to the fifth embodiment.

FIG. 50 is a figure showing the configuration of the speech to digital converter 230 according to the fifth embodiment.

FIG. 51 is a flow chart showing the operation of the speech to digital converter 230 according to the fifth embodiment.

FIG. 52 is a figure showing the configuration of the speech decoding device 140 according to the sixth embodiment.

FIG. 53 is a flow chart showing the operation of the speech decoding device according to the sixth embodiment.

FIG. 54 is a figure showing the configuration of the speech to digital converter 240 according to the sixth embodiment.

FIG. 55 is a flow chart showing the operation of the speech to digital converter 240 according to the sixth embodiment.

FIG. 56 is a figure showing the configuration of the first modification 140A of the speech decoding device according to the sixth embodiment.

FIG. 57 is a flow chart showing the operation of the first modification 140A of the speech decoding device according to the sixth embodiment.

FIG. 58 is a figure showing the configuration of the second modification 140B of the speech decoding device according to the sixth embodiment.

FIG. 59 is a figure showing the configuration of the 3rd modification 140C of the speech decoding device according to the sixth embodiment.

FIG. 60 is a flow chart showing the operation of the 3rd modification 140C of the speech decoding device according to the sixth embodiment.

FIG. 61 is a figure showing the configuration of the 4th modification 140D of the speech decoding device according to the sixth embodiment.

FIG. 62 is a flow chart showing the operation of the 4th modification 140D of the speech decoding device according to the sixth embodiment.

FIG. 63 is a figure showing the configuration of the fifth modification 140E of the speech decoding device according to the sixth embodiment.

FIG. 64 is a flow chart showing the operation of the fifth modification 140E of the speech decoding device according to the sixth embodiment.

FIG. 65 is a figure showing the configuration of the sixth modification 140F of the speech decoding device according to the sixth embodiment.

FIG. 66 is a flow chart showing the operation of the sixth modification 140F of the speech decoding device according to the sixth embodiment.

FIG. 67 is a figure showing the configuration of the seventh modification 140G of the speech decoding device according to the sixth embodiment.

FIG. 68 is a flow chart showing the operation of the seventh modification 140G of the speech decoding device according to the sixth embodiment.

FIG. 69 is a figure showing the configuration of the eighth modification 140H of the speech decoding device according to the sixth embodiment.

FIG. 70 is a flow chart showing the operation of the eighth modification 140H of the speech decoding device according to the sixth embodiment.

FIG. 71 is a figure showing the configuration of the ninth modification 140I of the speech decoding device according to the sixth embodiment.

FIG. 72 is a flow chart showing the operation of the ninth modification 140I of the speech decoding device according to the sixth embodiment.

FIG. 73 is a figure showing the configuration of the tenth modification 140J of the speech decoding device according to the sixth embodiment.

FIG. 74 is a flow chart showing the operation of the tenth modification 140J of the speech decoding device according to the sixth embodiment.

FIG. 75 is a figure showing the configuration of the 11th modification 140K of the speech decoding device according to the sixth embodiment.

FIG. 76 is a flow chart showing the operation of the 11th modification 140K of the speech decoding device according to the sixth embodiment.

FIG. 77 is a figure showing the configuration of the 12th modification 140L of the speech decoding device according to the sixth embodiment.

FIG. 78 is a flow chart showing the operation of the 12th modification 140L of the speech decoding device according to the sixth embodiment.

FIG. 79 is a figure showing the configuration of the 13th modification 140M of the speech decoding device according to the sixth.

FIG. 80 is a flow chart showing the operation of the 13th modification 140M of the speech decoding device according to the sixth embodiment.

FIG. 81 is a figure showing the configuration of the 14th modification 140N of the speech decoding device according to the sixth embodiment.

FIG. 82 is a flow chart showing the operation of the 14th modification 140N of the speech decoding device according to the sixth embodiment.

FIG. 83 is a figure showing the configuration of the speech decoding device 150 according to a seventh embodiment.

FIG. 84 is a flow chart showing the operation of the speech decoding device according to the seventh embodiment.

FIG. 85 is a figure showing the configuration of the speech to digital converter 250 according to the seventh embodiment.

FIG. 86 is a flow chart showing the operation of the speech to digital converter 250 according to the seventh embodiment.

FIG. 87 is a figure showing the configuration of the first modification 150A of the speech decoding device according to the seventh embodiment.

FIG. 88 is a flow chart showing the operation of the first modification 150A of the speech decoding device according to the seventh embodiment.

FIG. 89 is a figure showing the configuration of the second modification 150B of the speech decoding device according to the seventh embodiment.

FIG. 90 is a figure showing the configuration of the 3rd modification 150C of the speech decoding device according to the seventh embodiment.

FIG. 91 is a flow chart showing the operation of the 3rd modification 150C of the speech decoding device according to the seventh embodiment.

FIG. 92 is a figure showing the configuration of the 4th modification 150D of the speech decoding device according to the seventh embodiment.

FIG. 93 is a flow chart showing the operation of the 4th modification 150D of the speech decoding device according to the seventh embodiment.

FIG. 94 is a figure showing the configuration of the fifth modification 150E of the speech decoding device according to the seventh embodiment.

FIG. 95 is a flow chart showing the operation of the fifth modification 150E of the speech decoding device according to the seventh embodiment.

FIG. 96 is a figure showing the configuration of the sixth modification 150F of the speech decoding device according to the seventh embodiment.

FIG. 97 is a flow chart showing the operation of the sixth modification 150F of the speech decoding device according to the seventh embodiment.

FIG. 98 is a figure showing the configuration of the seventh modification 150G of the speech decoding device according to the seventh embodiment.

FIG. 99 is a flow chart showing the operation of the seventh modification 150G of the speech decoding device according to the seventh embodiment.

FIG. 100 is a figure showing the configuration of the eighth modification 150H of the speech decoding device according to the seventh embodiment.

FIG. 101 is a flow chart showing the operation of the eighth modification 150H of the speech decoding device according to the seventh embodiment.

FIG. 102 is a figure showing the configuration of the ninth modification 150I of the speech decoding device according to the seventh embodiment.

FIG. 103 is a flow chart showing the operation of the ninth modification 150I of the speech decoding device according to the seventh embodiment.

FIG. 104 is a figure showing the configuration of the tenth modification 150J of the speech decoding device according to the seventh embodiment.

FIG. 105 is a flow chart showing the operation of the tenth modification 150J of the speech decoding device according to the seventh embodiment.

FIG. 106 is a figure showing the configuration of the 11th modification 150K of the speech decoding device according to the seventh embodiment.

FIG. 107 is a flow chart showing the operation of the 11th modification 150K of the speech decoding device according to the seventh embodiment.

FIG. 108 is a figure showing the configuration of the 12th modification 150L of the speech decoding device according to the seventh embodiment.

FIG. 109 is a flow chart showing the operation of the 12th modification 150L of the speech decoding device according to the seventh embodiment.

FIG. 110 is a figure showing the configuration of the 13th modification 150M of the speech decoding device according to the seventh embodiment.

FIG. 111 is a flow chart showing the operation of the 13th modification 150M of the speech decoding device according to the seventh embodiment.

FIG. 112 is a figure showing the configuration of the 14th modification 150N of the speech decoding device according to the seventh embodiment.

FIG. 113 is a flow chart showing the operation of the 14th modification 150N of the speech decoding device according to the seventh embodiment.

FIG. 114 is a figure showing the configuration of the speech decoding device 160 according to an eighth embodiment.

FIG. 115 is a flow chart showing the operation of the speech decoding device according to the eighth embodiment.

FIG. 116 is a figure showing the configuration of the speech to digital converter 260 according to the eighth embodiment.

FIG. 117 is a flow chart showing the operation of the speech to digital converter 260 according to the eighth embodiment.

FIG. 118 is a figure showing the configuration of the first modification 160A of the speech decoding device according to the eighth embodiment.

FIG. 119 is a flow chart showing the operation of the first modification 160A of the speech decoding device according to the eighth embodiment.

FIG. 120 is a figure showing the configuration of the second modification 160B of the speech decoding device according to the eighth embodiment.

FIG. 121 is a figure showing the configuration of the 3rd modification 160C of the speech decoding device according to the eighth embodiment.

FIG. 122 is a flow chart showing the operation of the 3rd modification 160C of the speech decoding device according to the eighth embodiment.

FIG. 123 is a figure showing the configuration of the 4th modification 160D of the speech decoding device according to the eighth embodiment.

FIG. 124 is a flow chart showing the operation of the 4th modification 160D of the speech decoding device according to the eighth embodiment.

FIG. 125 is a figure showing the configuration of the fifth modification 160E of the speech decoding device according to the eighth embodiment.

FIG. 126 is a flow chart showing the operation of the fifth modification 160E of the speech decoding device according to the eighth embodiment.

FIG. 127 is a figure showing the configuration of the sixth modification 160F of the speech decoding device according to the eighth embodiment.

FIG. 128 is a flow chart showing the operation of the sixth modification 160F of the speech decoding device according to the eighth embodiment.

FIG. 129 is a figure showing the configuration of the seventh modification 160G of the speech decoding device according to the eighth embodiment.

FIG. 130 is a flow chart showing the operation of the seventh modification 160G of the speech decoding device according to the eighth embodiment.

FIG. 131 is a figure showing the configuration of the eighth modification 160H of the speech decoding device according to the eighth embodiment.

FIG. 132 is a flow chart showing the operation of the eighth modification 160H of the speech decoding device according to the eighth embodiment.

FIG. 133 is a figure showing the configuration of the ninth modification 160I of the speech decoding device according to the eighth embodiment.

FIG. 134 is a flow chart showing the operation of the ninth modification 160I of the speech decoding device according to the eighth embodiment.

FIG. 135 is a figure showing the configuration of the tenth modification 160J of the speech decoding device according to the eighth embodiment.

FIG. 136 is a flow chart showing the operation of the tenth modification 160J of the speech decoding device according to the eighth embodiment.

FIG. 137 is a figure showing the configuration of the 11th modification 160K of the speech decoding device according to the eighth embodiment.

FIG. 138 is a flow chart showing the operation of the 11th modification 160K of the speech decoding device according to the eighth embodiment.

FIG. 139 is a figure showing the configuration of the 12th modification 160L of the speech decoding device according to the eighth embodiment.

FIG. 140 is a flow chart showing the operation of the 12th modification 160L of the speech decoding device according to the eighth embodiment.

FIG. 141 is a figure showing the configuration of the 13th modification 160M of the speech decoding device according to the eighth embodiment.

FIG. 142 is a flow chart showing the operation of the 13th modification 160M of the speech decoding device according to the eighth embodiment.

FIG. 143 is a figure showing the configuration of the 14th modification 160N of the speech decoding device according to the eighth embodiment.

FIG. 144 is a flow chart showing the operation of the 14th modification 160N of the speech decoding device according to the eighth embodiment.

FIG. 145 is a figure showing the configuration of the speech decoding device 380 according to a ninth embodiment.

FIG. 146 is a flow chart showing the operation of the speech decoding device 380 according to the ninth embodiment.

FIG. 147 is a figure showing the configuration of the first modification 380A of the speech decoding device according to the ninth embodiment.

FIG. 148 is a flow chart showing the operation of the first modification 380A of the speech decoding device according to the ninth embodiment.

FIG. 149 is a figure showing the configuration of the speech decoding device 390 according to a tenth embodiment.

FIG. 150 is a flow chart showing the operation of the speech decoding device 390 according to the tenth embodiment.

### DETAILED DESCRIPTION OF THE PREFERRED EMBODIMENTS

Various embodiments will be described with reference to the accompanying drawings. The same parts are denoted with the same reference signs, if possible, and an overlapping description will be omitted.

### First Embodiment

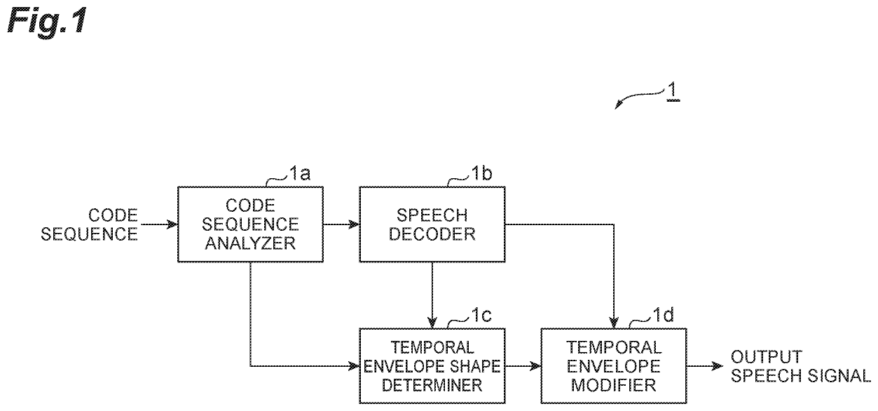

FIG. 1 is a diagram showing the configuration of a speech decoding device 1 according to a first embodiment. A communication device of the speech decoding device 1 receives a multiplexed code sequence output from a speech encoding device 2 described below and outputs a decoded speech signal to the outside. As shown in FIG. 1, the speech decoding device 1 functionally includes a code sequence analyzer 1a, a speech decoder 1b, a temporal envelope shape determiner 1c, and a temporal envelope modifier 1d.

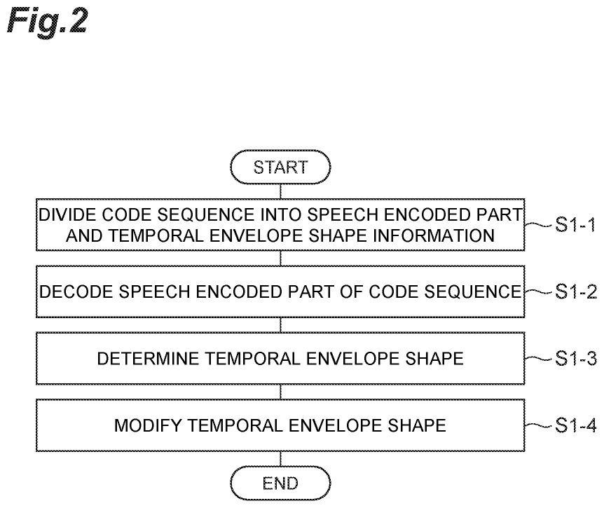

FIG. 2 is a flowchart showing the operation of the speech decoding device 1 according to the first embodiment.

The code sequence analyzer 1a analyzes a code sequence and divides the code sequence into a speech encoded part and information about the temporal envelope shape (step S1-1).

The speech decoder 1b decodes the speech encoded part of the code sequence to obtain a decoded signal (step S1-2).

The temporal envelope shape determiner 1c determines the temporal envelope shape of the decoded signal, based on at least one of the information about the temporal envelope shape divided by the code sequence analyzer 1a and the decoded signal obtained by the speech decoder 1b (step S1-3).

For example, it is determined that the temporal envelope shape of the decoded signal is flat. For example, parameters representing the power of the decoded signal or parameters similar thereto are calculated. Thereafter, the dispersion, or a parameter similar thereto, of the parameters is calculated. The calculated parameter is compared with a predetermined threshold to determine whether the temporal envelope shape is flat or determine the degree of flatness. In another example, the ratio, or a parameter similar thereto, of an arithmetic mean to a geometric mean of the parameters, or parameters similar thereto, representing the power of the decoded signal and is compared with a predetermined threshold to determine whether the temporal envelope shape is flat or determine the degree of flatness. The method of determining that the temporal envelope shape of the decoded signal is flat is not limited to the above examples.

For example, it is determined that the temporal envelope shape of the decoded signal is onset. For example, parameters, or parameters similar thereto, representing the power of the decoded signal are determined, differential values of the parameters in time direction are calculated, and the maximum value in the differential values in an arbitrary time segment is calculated. The maximum value is compared with a predetermined threshold to determine whether the temporal envelope shape is rising or determine the degree of onset. The method of determining that the temporal envelope shape of the decoded signal is onset is not limited to the above examples.

For example, it is determined that the temporal envelope shape of a low frequency signal is offset. For example, parameters, or parameters similar thereto, representing the power of the decoded signal are determined, differential values of the parameters in time direction are calculated, and the minimum value of the differential values in an arbitrary time segment is calculated. The minimum value is compared with a predetermined threshold to determine whether the temporal envelope shape is offset or determine the degree of offset. The method of determining that the temporal envelope shape of the decoded signal is offset is not limited to the above examples.

The above examples can also be applied to a case where the decoded signal is output as a time domain signal from the speech decoder 1b, and can also be applied to a case where the decoded signal is output as a plurality of subband signals.

The temporal envelope modifier 1d modifies the shape of the temporal envelope of the decoded signal output from the speech decoder 1b, based on the temporal envelope shape determined by the temporal envelope shape determiner 1c (step S1-4).

For example, if the decoded signal is expressed by a plurality of subband signals, the temporal envelope modifier 1d uses a predetermined function F(X_{dec}(k,i)) for a plurality of subband signals X_{dec}(k,i) (0≤k<kₕ, t(l)≤i<t(l+1)) of the decoded signal within an arbitrary time segment to calculate X′_{dec}(k,i) using the following equation (1):

X_{dec}′(k,i)=F(X_{dec})(k,i)) [Eq. 1]

X′_{dec}(k,i) being calculated as subband signals of the decoded signal whose temporal envelope shape is modified. The temporal envelope modifier 1d synthesizes a time domain signal from the subband signals and outputs the synthesized signal.

For example, when it is determined that the temporal envelope shape of the decoded signal is flat, the temporal envelope shape of the decoded signal can be modified by the following process. For example, the subband signals X_{dec}(k,i) are divided into M_{dec} frequency bands having boundaries represented by B_{dec}(m) (m=0, . . . , M_{dec}, M_{dec}≥1) (B_{dec}(0)≥0, B_{dec}(M_{dec})<kₕ) and, using a predetermined function F(X_{dec}(k,i) expressed by the equations below for the subband signals X_{dec}(k,i) (B_{dec}(m)<k<B_{dec}(m+1)) t(l)≤i<t(l+1)) included in the m-th frequency band,

$$\begin{matrix}F ( {X}_{dec} ( k , i ) ) = \sqrt{\frac{{\sum }_{n = {t}_{E} ( l )}^{{t}_{E} ( l + 1 ) - 1} {\sum }_{j = {B}_{dec} ( m )}^{{B}_{dec} ( m + 1 ) - 1} {\vert {X}_{dec} ( j , n ) \vert}^{2}}{( {t}_{E} ( l + 1 ) - {t}_{E} ( l ) ) \cdot ( {B}_{dec} ( m + 1 ) - {B}_{dec} ( m ) )}} \frac{{X}_{dec} ( k , i )}{\sqrt{{\vert {X}_{dec} ( k , i ) \vert}^{2}}} & [ Eq . 2 ] \\ or & \\ F ( {X}_{dec} ( k , i ) ) = \sqrt{\frac{{\sum }_{n = {t}_{E} ( l )}^{{t}_{E} ( l + 1 ) - 1} {\sum }_{j = {B}_{dec} ( m )}^{{B}_{dec} ( m + 1 ) - 1} {\vert {X}_{dec} ( j , n ) \vert}^{2}}{{t}_{E} ( l + 1 ) - {t}_{E} ( l )}} \frac{{X}_{dec} ( k , i )}{\sqrt{{\sum }_{j = {B}_{dec} ( m )}^{{B}_{dec} ( m + 1 ) - 1} {\vert {X}_{dec} ( j , n ) \vert}^{2}}} & \end{matrix}$$

X′_{dec}(k,i) is calculated as subband signals of the decoded signal whose temporal envelope shape is modified. In another example, a predetermined function F(X_{dec}(k,i)) defined by is used to perform a smoothing filter process on the subband signals X_{dec}(k,i).

$$F ( {X}_{dec} ( k , i ) ) = {\sum }_{p = 0}^{{N}_{filt} - 1} a ( p ) {X}_{dec} ( k , i - p ) \qquad [ Eq . 3 ]$$

With the definition of (N_{filt}≥1), X′_{dec}(k,i) are calculated as subband signals of the decoded signal whose temporal envelope shape is modified. The process can be performed such that the powers of the subband signals before and after the filter process are matched in each frequency band having the boundaries represented by the B_{dec}(m).

In another example, the subband signals X_{dec}(k,i) are linearly predicted in the frequency direction in each frequency band having the boundaries represented by the B_{dec}(m) to obtain a linear prediction coefficient αₚ(m) (m=0, . . . , M_{dec-1}), and a predetermined function F(X_{dec}(k,i)) is used to perform a linear prediction inverse filter process on the subband signals X_{dec}(k,i).

$$F ( {X}_{dec} ( k , i ) ) = {X}_{dec} ( k , i ) + {\sum }_{p = 1}^{{N}_{pred}} {α}_{p} ( m ) {X}_{dec} ( k - p , i ) \qquad [ Eq . 4 ]$$

With the definition of (N_{pred}≥1), X′_{dec}(k,i) are calculated as subband signals of the decoded signal whose temporal envelope shape is modified.

The process of modifying the temporal envelope into a flat shape can be carried out in any combination of the above examples.

The processes performed by the temporal envelope modifier 1d to modify the temporal envelope of the decoded signal into a flat shape are not limited to the above examples.

For example, when it is determined that the temporal envelope shape of the decoded signal is onset, the temporal envelope shape of the decoded signal can be modified by the following process.

For example, a predetermined function F(X_{dec}(k,i)) set forth below is defined using a function incr(i) that monotonously increases relative to i.

$$F ( {X}_{dec} ( k , i ) ) = i n c r ( i ) \frac{{X}_{dec} ( k , i )}{\sqrt{{\vert {X}_{dec} ( k , i ) \vert}^{2}}} \qquad [ Eq . 5 ]$$

X′_{dec}(k,i) are calculated as the subband signals of the decoded signal whose temporal envelope shape is modified. A process can be performed such that the powers of the subband signals before and after modification of the temporal envelope shape are matched in each frequency band having the boundaries represented by the B_{dec}(m).

The temporal envelope modifier 1d carries out a process of modifying the temporal envelope shape of a plurality of subband signals of the decoded signal when it is onset, and the process is not limited to the above examples.

For example, when it is determined that the temporal envelope shape of the decoded signal is offset, the temporal envelope shape of the decoded signal can be modified by the following process.

For example, a predetermined function F(X_{dec}(k,i)) set forth below includes a function decr(i) that monotonously decreases relative to i.

$$F ( {X}_{dec} ( k , i ) ) = decr ( i ) \frac{{X}_{dec} ( k , i )}{\sqrt{{\vert {X}_{dec} ( k , i ) \vert}^{2}}} \qquad [ Eq . 6 ]$$

X′_{dec}(k,i) are calculated as subband signals of the low frequency signal whose temporal envelope shape is modified. A process can be performed such that the powers of the subband signals before and after modification of the temporal envelope shape are matched in each frequency band having the boundaries represented by the B_{dec}(m).

The temporal envelope modifier 1d performs a process of modifying the temporal envelope shape of a plurality of subband signals of the decoded signal when it is offset, and the process is not limited to the above examples.

For example, if the decoded signal can be represented as a time domain signal, as shown below, the temporal envelope modifier 1d applies a predetermined function Fₜ(x_{dec}(i)) for the decoded signal x_{dec}(i) (t(l)≤i<t(l+1)) in an arbitrary time segment to obtain x′_{dec}(i).

x_{dec}′(i)=Fₜ(x_{dec}(i)) [Eq. 7]

Which is output as a decoded signal whose temporal envelope shape is modified.

For example, when it is determined that the temporal envelope shape of the decoded signal is flat, the temporal envelope shape of the decoded signal can be modified by the following process. For example, a predetermined function Fₜ(x_{dec}(i)) set forth below for the decoded signal x_{dec}(i) is used.

$${F}_{t} ( {x}_{dec} ( i ) ) = \sqrt{\frac{{\sum }_{n = {t}_{E} ( l )}^{{t}_{E} ( l + 1 ) - 1} {\vert {X}_{dec} ( n ) \vert}^{2}}{( {t}_{E} ( l + 1 ) - {t}_{E} ( l ) )}} \frac{{x}_{dec} ( i )}{\sqrt{{\vert {x}_{dec} ( i ) \vert}^{2}}} \qquad [ Eq . 8 ]$$

To output x′_{dec}(i) as a decoded signal whose temporal envelope shape is modified.

In another example, a predetermined function Fₜ(x_{dec}(i)) set forth below to perform a smoothing filter process on the decoded signal x_{dec}(i).

$${F}_{t} ( {X}_{dec} ( i ) ) = {\sum }_{p = 0}^{{N}_{filt} - 1} a ( p ) {x}_{dec} ( i - p ) \qquad [ Eq . 9 ]$$

With a definition of (N_{filt}≥1), x′_{dec}(i) is output as a decoded signal whose temporal envelope shape is modified.

The process of modifying the temporal envelope into a flat shape can be carried out in any combination of the above examples.

For example, when it is determined that the temporal envelope shape of the decoded signal is onset, the temporal envelope shape of the decoded signal can be modified by the following process.

For example, a predetermined function Fₜ(x_{dec}(i)) set forth below uses a function incr(i) that monotonously increases relative to i.

$${F}_{t} ( {x}_{dec} ( i ) ) = i n c r ( i ) \frac{{x}_{dec} ( i )}{\sqrt{{\vert {x}_{dec} ( i ) \vert}^{2}}} \qquad [ Eq . 10 ]$$

x′_{dec}(i) is output as a decoded signal whose temporal envelope shape is modified.

The temporal envelope modifier 1d carries out a process of modifying the temporal envelope of the decoded signal when it is onset, and the process is not limited to the above examples.

For example, when it is determined that the temporal envelope shape of the decoded signal is offset, the temporal envelope shape of the decoded signal can be modified by the following process.

For example, a predetermined function Fₜ(x_{dec}(i)) set forth below uses a function decr(i) that monotonously decreases relative to i.

$${F}_{t} ( {x}_{dec} ( i ) ) = decr ( i ) \frac{{x}_{dec} ( i )}{\sqrt{{\vert {x}_{dec} ( i ) \vert}^{2}}} \qquad [ Eq . 11 ]$$

x′dec(i) is output as a decoded signal whose temporal envelope shape is modified. The temporal envelope modifier 1d carries out a process of modifying the temporal envelope of the decoded signal when it is offset, and the process is not limited to the above examples.

For example, if the decoded signal is expressed by frequency domain transform coefficients X_{dec}(k) (0≤k<kₕ) by a time-frequency transform, such as the discrete Fourier transform, the discrete cosine transform, or the modified discrete cosine transform, a predetermined function F_{f}(X_{dec}(k) is used in the following equation (12).

[Eq. 12]

X_{dec}′(k)=Fⱼ(X_{dec}(k)) formula (51)

X′_{dec}(k) are calculated as frequency domain transform coefficients of the decoded signal whose temporal envelope shape is modified, and then transformed into a time domain signal by a predetermined frequency transform to be output.

For example, when it is determined that the temporal envelope shape of the decoded signal is flat, the temporal envelope shape of the decoded signal can be modified by the following process.

In M_{dec} arbitrary frequency bands B_{dec}(m) having boundaries represented by B_{dec}(m) (m=0, . . . , M_{dec}, M_{dec}≥1) (B_{dec}(0)≥0, B_{dec}(M_{dec})<kₕ), a linear prediction coefficient αₚ(m) (m=0, . . . , M_{dec}−1) is obtained by linear prediction in a frequency direction, and a predetermined function F_{f}(X_{dec}(k)) set forth below is used to perform a linear prediction inverse filter process on the transform coefficients X_{dec}(k).

$${F}_{f} ( {X}_{dec} ( k ) ) = {X}_{dec} ( k ) + {\sum }_{p = 1}^{{N}_{pred}} {α}_{p} ( m ) {X}_{dec} ( k - p ) \qquad [ Eq . 13 ]$$

With a definition of (N_{pred}≥1), X′_{dec}(k,i) are calculated as transform coefficients of the decoded signal whose temporal envelope shape is modified.

The temporal envelope modifier 1d performs a process of modifying the temporal envelope of the decoded signal into a flat shape, and the process is not limited to the above examples.

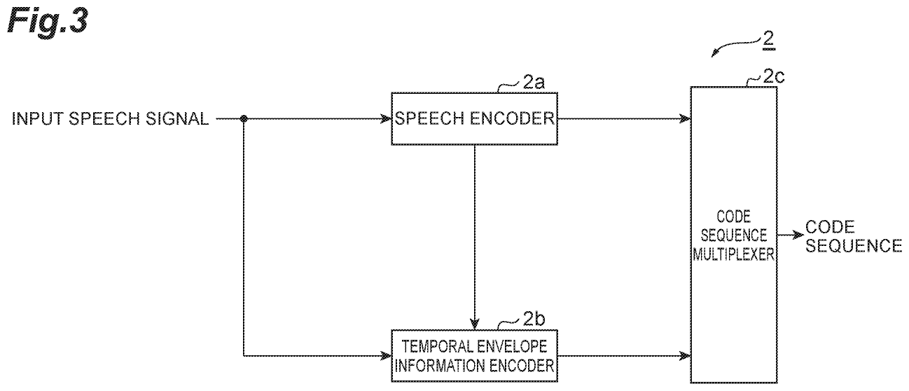

FIG. 3 is a diagram showing the configuration of a speech encoding device 2 according to the first embodiment. A communication device of the speech encoding device 2 receives a speech signal to be encoded from the outside and outputs the encoded code sequence to the outside. As shown in FIG. 3, the speech encoding device 2 functionally includes a speech coder 2a, a temporal envelope information encoder 2b, and a code sequence multiplexer 2c.

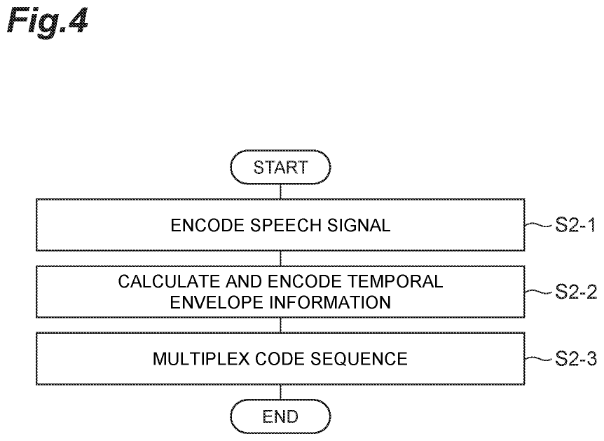

FIG. 4 is a flowchart showing the operation of the speech encoding device 2 according to the first embodiment.

The speech coder 2a encodes an input speech signal (step S2-1).

The temporal envelope information encoder 2b calculates and encodes temporal envelope information, based on at least one of the input speech signal and information obtained in the encoding process including the encoding result of the input speech signal in the speech coder 2a (step S2-2).

For example, the temporal envelope Eₜ(i) of the input speech signal x(i), which is a time domain signal in an arbitrary time segment t(l)≤i<(l+1)), can be calculated as the power of the decoded signal normalized in the time segment.

$${E}_{t} ( i ) = \frac{{\vert x ( i ) \vert}^{2}}{{\sum }_{n = t ( l )}^{t ( l + 1 ) - 1} {\vert x ( n ) \vert}^{2}} \qquad [ Eq . 14 ]$$

For example, if the input speech signal is calculated as a plurality of subband signals X(k,i) in the speech coder 2a, as the time envelop of the input speech signal, the temporal envelope E(k,i) of the subband signals X(k,i) (B(m)≤k<B(m+1), t(l)≤i<t(l+1)) of the input speech signal divided into M frequency bands having boundaries represented by B(m) (m=0, . . . , M, M≥1) (B(0)≥0, B(M)<kₕ) in an arbitrary time segment t(l)<i<t(l+1) and included in the m-th frequency band can be calculated as the power of the subband signals of the input speech signal normalized in the time segment.

$$E ( k , i ) = \frac{{\sum }_{j = B ( m )}^{B ( m + 1 ) - 1} {\vert X ( j , n ) \vert}^{2}}{{\sum }_{n = t ( l )}^{t ( l + 1 ) - 1} {\sum }_{j = B ( m )}^{B ( m + 1 ) - 1} {\vert X ( j , n ) \vert}^{2}} \qquad [ Eq . 15 ]$$

The temporal envelope of the input speech signal is not limited to the above examples as long as it is a parameter indicating variations of the magnitude of the input speech signal in the time direction.

For example, the decoded signal x_{dec}(i) is calculated based on the encoding result of the input speech signal in the speech coder 2a, and the temporal envelope E_{dec,t}(i) of the decoded signal x_{dec}(i) in an arbitrary time segment t(l)≤i<t(l+1) can be calculated as the power of the decoded signal normalized in the time segment.

$${E}_{dec , t} ( i ) = \frac{{\vert {x}_{dec} ( i ) \vert}^{2}}{{\sum }_{n = t ( l )}^{t ( l + 1 ) - 1} {\vert {x}_{dec} ( n ) \vert}^{2}} \qquad [ Eq . 16 ]$$

For example, if the subband signals X_{dec}(k,i) of the decoded signal are calculated during the process of encoding the input speech signal in the speech coder 2a or based on the encoding result, as the time envelop of the decoded signal, the temporal envelope E_{dec}(k,i) of the subband signals X_{dec}(k,i) (B(m)≤k<B(m+1), t(l)≤i<t(l+1)) of the input speech signal divided into M frequency bands having boundaries represented by B(m) (m=0, . . . M, M≥1) (B(0)≥0, B(M)<kₕ) in an arbitrary time segment t(l)≤i<t(l+1) and included in the m-th frequency band can be calculated as the power of the subband signals of the input speech signal normalized in the time segment.

$${E}_{dec} ( k , i ) = \frac{{\sum }_{j = B ( m )}^{B ( m + 1 ) - 1} {\vert {X}_{dec} ( j , n ) \vert}^{2}}{{\sum }_{n = t ( l )}^{t ( l + 1 ) - 1} {\sum }_{j = B ( m )}^{B ( m + 1 ) - 1} {\vert {X}_{dec} ( j , n ) \vert}^{2}} \qquad [ Eq . 17 ]$$

For example, the temporal envelope information encoder 2b calculates information representing the degree of flatness as temporal envelope information. For example, at least one of a parameter, and a parameter similar thereto, representing the dispersion of the temporal envelope of the input speech signal and the decoded signal is calculated. In another example, at least one of the ratio, and a parameter similar thereto, of an arithmetic mean to a geometric mean of the temporal envelope of the input speech signal and the decoded signal is calculated. In this case, the temporal envelope information encoder 2b may calculate information representing the flatness of the temporal envelope of the input speech signal as the temporal envelope information, and the process thereby is not limited to the above examples. The parameter is then encoded. For example, the differential value of the parameter of the input speech signal and the decoded signal or the absolute value of the differential value is encoded. For example, at least one of the value of the parameter of the input speech signal and the absolute value is encoded. For example, if the flatness of the temporal envelope is expressed by information of being flat or not, the information can be encoded by one bit. For example, for the time domain input speech signal, the information can be encoded by one bit in the arbitrary time segment. For example, when the information is encoded for each of the M frequency bands of the subband signals of the input speech signal, it can be encoded by M bits. The method of encoding the temporal envelope information is not limited to the above examples.

For example, the temporal envelope information encoder 2b calculates information representing the degree of onset as the temporal envelope information. For example, in an arbitrary time segment t(l)≤i<t(l+1), the maximum value of the differential value of the temporal envelope of the input speech signal in time direction is calculated.

d_{Et,max}(k)=max(Eₜ(k,i)−Eₜ(k,i−1))

d_{Edec,t,max}(k)=max(E_{dec,t}(k,i)−E_{dec,t}(k,i−1))

or

d_{E max}(k)=max(E(k,i)−E(k,i−1))

d_{Edec,max}(k)=max(E_{dec}(k,i)−E_{dec}(k,i−1)) [Eq. 18]

In these equations, the maximum value of the differential value of a parameter in time direction, the parameter being obtained by smoothing the temporal envelope in time direction, can be calculated in place of the temporal envelope.

In this case, the temporal envelope information encoder 2b may calculate information representing the degree of onset of the temporal envelope of the input speech signal as the temporal envelope information, and the process thereby is not limited to the above examples. The parameter is then encoded. For example, at least one of the differential value of the parameter of the input speech signal and the decoded signal and the absolute value of the differential value is encoded. For example, if the rise of the temporal envelope is represented by information of being onset or not, the information can be encoded by one bit. For example, for the time domain input speech signal, the information can be encoded by one bit in the arbitrary time segment. For example, when the information is encoded for each of the M frequency bands of the subband signals of the input speech signal, it can be encoded by M bits. The method of encoding the temporal envelope information is not limited to the above examples.

For example, the temporal envelope information encoder 2b calculates information representing the degree of offset as the temporal envelope information. For example, in the arbitrary time segment t(l)≤i<t(l+1), the minimum value of the differential value in time direction of the temporal envelope of the input speech signal is calculated.

d_{Et,min}(k)=min(Eₜ)(k,i)−Eₜ(k,i−1))

d_{Edec,t,min}(k)=min(E_{dec,t}(k,i)−E_{dec,t}(k,i−1))

or

d_{Emin}(k)=min(E(k,i)−E(k,i−1))

d_{Edec,min}(k)=min(E_{dec}(k,i)−E_{dec}(k,i−1)) [Eq. 19]

In these equations, the minimum value of the differential value of a parameter in time direction, the parameter being obtained by smoothing the temporal envelope in time direction, can be calculated in place of the temporal envelope. In this case, the temporal envelope information encoder 2b may calculate information representing the degree of offset of the temporal envelope of the subband signals of the input speech signal as the temporal envelope information, and the process thereby is not limited to the above examples. The parameter is then encoded. For example, at least one of the differential value of the parameter of the input speech signal and the decoded signal and the absolute value of the differential value is encoded. For example, if the fall of the temporal envelope is represented by information of being offset or not, the information can be encoded by one bit. For example, for the time domain input speech signal, the information can be encoded by one bit in the arbitrary time segment. For example, when the information is encoded for each of the M frequency bands of the subband signals of the input speech signal, it can be encoded by M bits. The method of encoding the temporal envelope information is not limited to the above examples.

In the above examples, in the arbitrary time segment t(l)<i<t(l+1), an encoding parameter (for example, the gain of a codebook in CELP encoding) having a correlation to the power of a time segment shorter than the time segment can be used in the speech coder 2a, in place of the temporal envelope of the input speech signal.

The code sequence multiplexer 2c receives the code sequence of the input speech signal from the speech coder 2a, receives the temporal envelope shape information encoded by the temporal envelope information encoder 2b and outputs a multiplexed code sequence (step S2-3).

### Second Embodiment

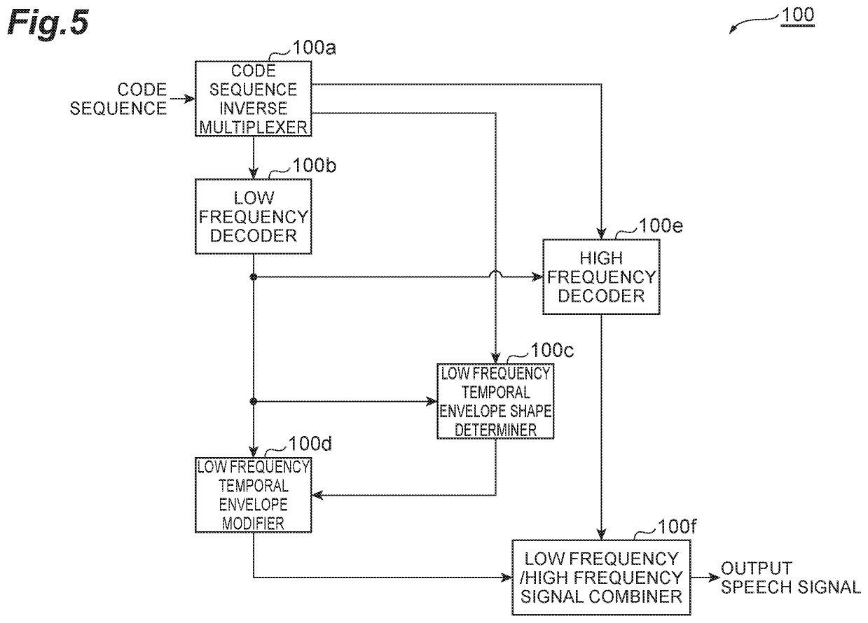

FIG. 5 is a diagram showing the configuration of a speech decoding device 100 according to an second embodiment. A communication device of the speech decoding device 100 receives a multiplexed code sequence output from a speech encoding device 200 described below and outputs a decoded speech signal to the outside. As shown in FIG. 5, the speech decoding device 100 functionally includes a code sequence demultiplexer 100a, a low frequency decoder 100b, a low frequency temporal envelope shape determiner 100c, a low frequency temporal envelope modifier 100d, a high frequency decoder 100e, and a low frequency/high frequency signal combiner 100f.

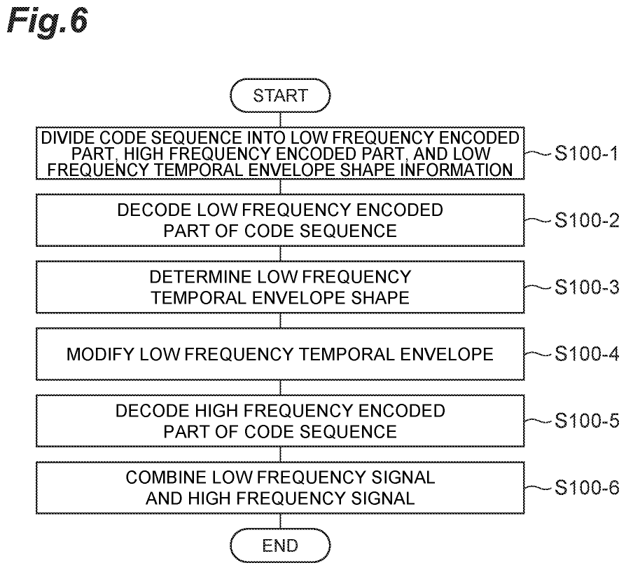

FIG. 6 is a flowchart showing the operation of the speech decoding device according to the second embodiment.

The code sequence demultiplexer 100a divides a code sequence into a low frequency encoded part, which is the encoded low frequency signal, and a high frequency encoded part, which is the encoded high frequency signal (step S100-1).

The low frequency decoder 100b decodes the low frequency encoded part divided by the code sequence demultiplexer 100a to obtain a low frequency signal (step S100-2).

The low frequency temporal envelope shape determiner 100c determines the temporal envelope shape of the low frequency signal, based on at least one of information about the low frequency temporal envelope shape divided by the code sequence demultiplexer 100a and the low frequency signal obtained by the low frequency decoder 100b (step S100-3).

Examples include a case where it is determined that the temporal envelope shape of the low frequency signal is flat, a case where it is determined that the temporal envelope shape of the low frequency signal is onset, and a case where it is determined that the temporal envelope shape of the low frequency signal is offset.

The temporal envelope shape of the low frequency signal is determined, for example, by replacing the decoded signal obtained by the speech decoder 1b with the low frequency signal obtained by the low frequency decoder 100b in the process of determining the temporal envelope shape of the decoded signal by the temporal envelope shape determiner 1c.

The low frequency temporal envelope modifier 100d modifies the shape of the temporal envelope of the low frequency signal output from the low frequency decoder 100b, based on the temporal envelope shape determined by the low frequency temporal envelope shape determiner 100c (step S100-4).

The temporal envelope shape of the low frequency signal can be modified, for example, by replacing the decoded signal obtained by the speech decoder 1b with the low frequency signal obtained by the low frequency decoder 100b in the process of modifying the temporal envelope shape of the decoded signal in the temporal envelope modifier 1d.

The high frequency decoder 100e decodes the high frequency encoded part divided by the code sequence demultiplexer 100a to obtain a high frequency signal (step S100-5).

The decoding of the high frequency signal in the high frequency decoder 100e can be performed by a method of decoding a code sequence in which a high frequency signal is encoded by at least one of domain signals of a time domain signal, a subband signal, and a frequency domain signal.

For example, in some speech decoding devices, a high frequency signal can be generated by a bandwidth extension technique that generates a high frequency signal using the decoding result obtained by the low frequency decoder. In such speech decoding devices, if information required to generate a high frequency signal by a bandwidth extension technique is included in the code sequence, part of the code sequence that includes the information is the high frequency encoded part. A high frequency signal is then generated by decoding the high frequency encoded part divided by the code sequence demultiplexer 100a and obtaining the information required for the bandwidth extension technique. By contrast, if information required to generate a high frequency signal by a bandwidth extension technique is not included in the code sequence, the code sequence demultiplexer 100a inputs nothing to the high frequency decoder 100e and generates a high frequency signal through a predetermined process or a process using the decoding result obtained by the low frequency decoder.

The low frequency/high frequency signal combiner 100f combines the low frequency signal having the temporal envelope shape modified by the low frequency temporal envelope modifier 100d and the high frequency signal obtained by the high frequency decoder 100e to output a speech signal including a low frequency component and a high frequency component (step S100-6).

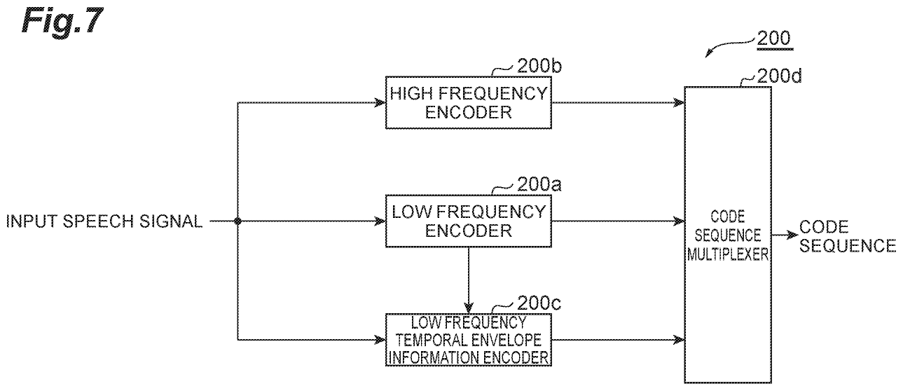

FIG. 7 is a diagram showing the configuration of the speech encoding device 200 according to the second embodiment. A communication device of the speech encoding device 200 receives a speech signal to be encoded from the outside and outputs the encoded code sequence to the outside. As shown in FIG. 1, the speech encoding device 200 functionally includes a low frequency encoder 200a, a high frequency encoder 200b, a low frequency temporal envelope information encoder 200c, and a code sequence multiplexer 200d.

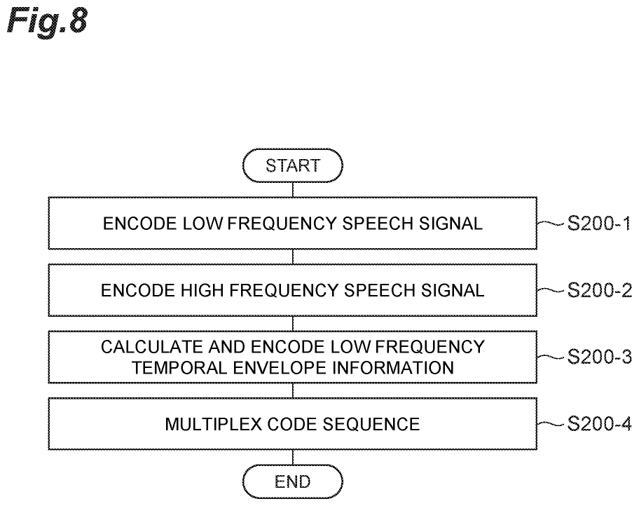

FIG. 8 is a flowchart showing the operation of the speech encoding device 200 according to the second embodiment.

The low frequency encoder 200a encodes a low frequency signal corresponding to the low frequency component of the input speech signal (step S200-1).

The high frequency encoder 200b encodes a high frequency signal corresponding to the high frequency component of the input speech signal (step S200-2).

The low frequency temporal envelope information encoder 200c calculates and encodes low frequency temporal envelope shape information, based on at least one of the input speech signal and information obtained in the encoding process including the encoding result of the input speech signal in the low frequency encoder 200a (step S200-3).

The process of calculating and encoding low frequency temporal envelope shape information can be performed in the same manner, for example, by using the low frequency signal of the input speech signal in place of the input speech signal and using the low frequency decoded signal obtained by decoding the encoding result in the low frequency encoder 200a in place of the decoded signal, in the process of calculating and encoding temporal envelope information on the input speech signal in the temporal envelope information encoder 2b.

The code sequence multiplexer 200d receives the code sequence of the low frequency speech signal from the low frequency encoder 200a, receives the code sequence of the high frequency speech signal from the high frequency encoder 200b, receives the low frequency temporal envelope shape information encoded by the low frequency temporal envelope information encoder 200c and outputs a multiplexed code sequence (step S200-4).

### [First Modification of Speech Decoding Device of Second Embodiment]

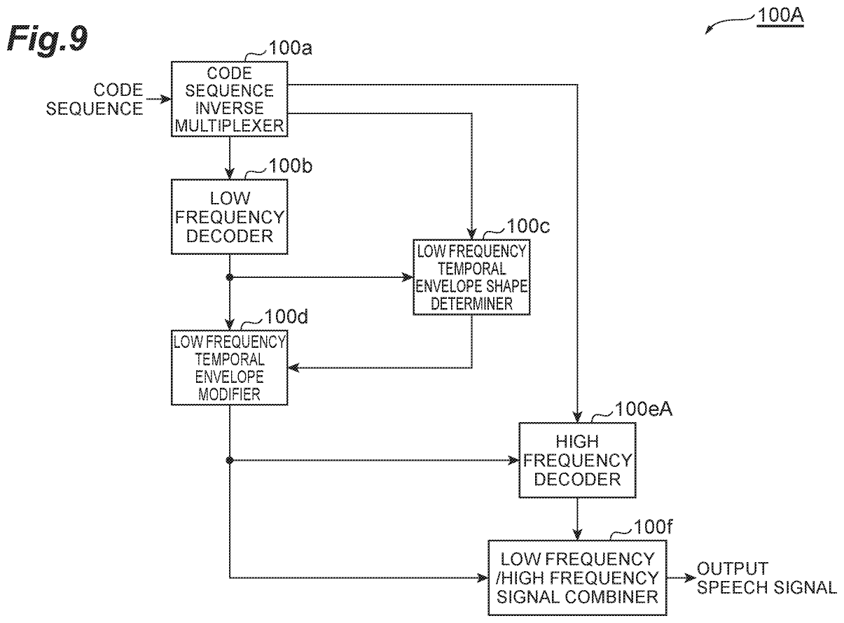

FIG. 9 is a diagram showing the configuration of a first modification 100A of the speech decoding device according to the second embodiment.

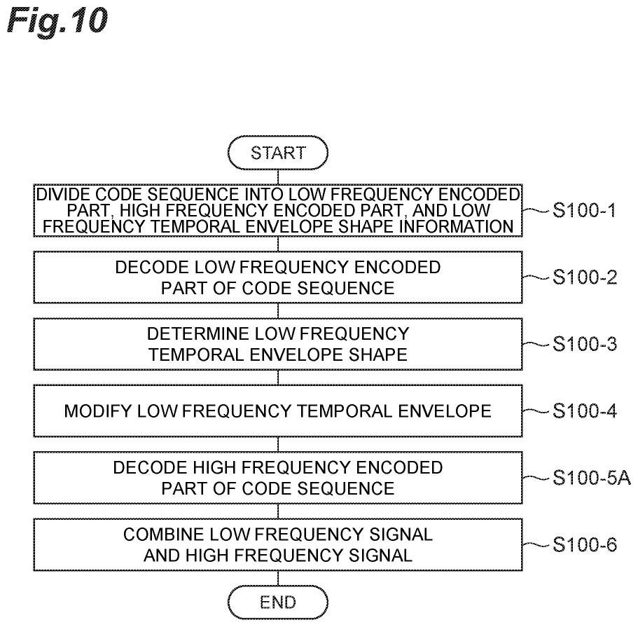

FIG. 10 is a flowchart showing the operation of the first modification 100A of the speech decoding device according to the second embodiment.

A high frequency decoder 100eA decodes the high frequency encoded part divided by the code sequence demultiplexer 100a to obtain a high frequency signal (step S100-5A).

The high frequency decoder 100eA differs from the high frequency decoder 100e in that the low frequency signal having the temporal envelope shape modified by the low frequency temporal envelope modifier 100d is used when the low frequency decoded signal obtained by the low frequency decoder is used in decoding of the high frequency signal.

### [Second Modification of Speech Decoding Device of Second Embodiment]

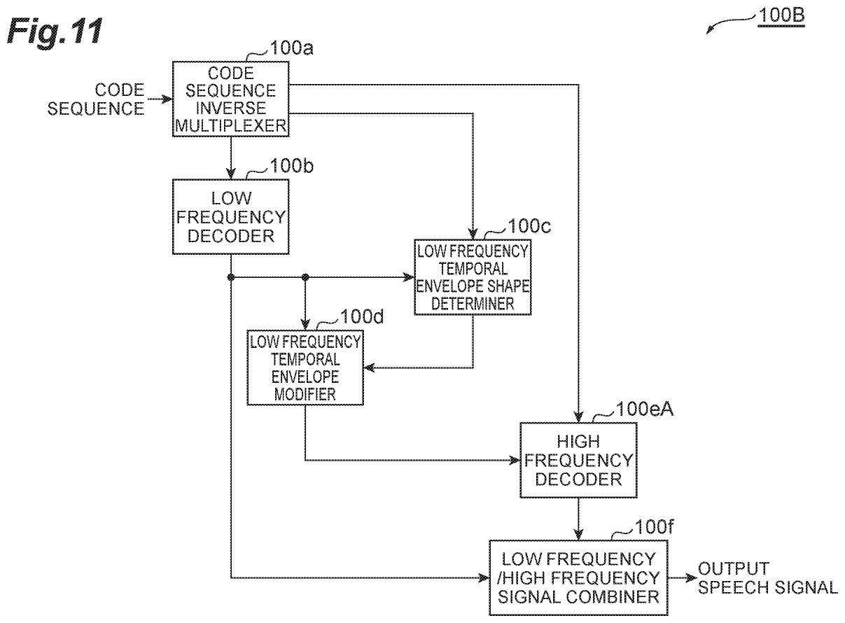

FIG. 11 is a diagram showing the configuration of a first modification 100A of the speech decoding device according to the second embodiment.

The difference from the first modification of the speech decoding device in the second embodiment is that the low frequency signal input to the low frequency/high frequency signal combiner 100f is not output from the low frequency temporal envelope modifier 100d but output from the low frequency decoder 100b.

### Third Embodiment

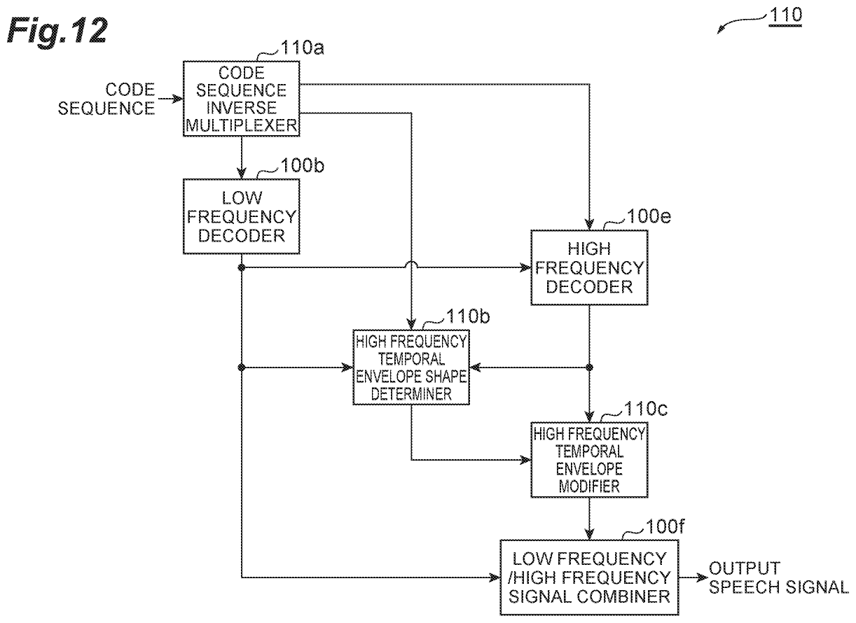

FIG. 12 is a diagram showing the configuration of a speech decoding device 110 according to a third embodiment. A communication device of the speech decoding device 110 receives a multiplexed code sequence output from a speech encoding device 210 described below and outputs a decoded speech signal to the outside. As shown in FIG. 12, the speech decoding device 110 functionally includes a code sequence demultiplexer 110a, a low frequency decoder 100b, a high frequency decoder 100e, a high frequency temporal envelope shape determiner 110b, a high frequency temporal envelope modifier 110c, and a low frequency/high frequency signal combiner 100f.

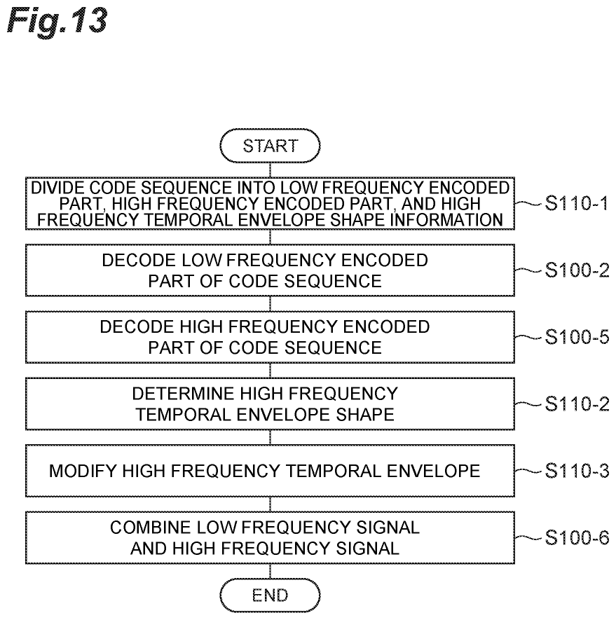

FIG. 13 is a flowchart showing the operation of the speech decoding device according to the third embodiment.

The code sequence demultiplexer 110a divides a code sequence into a low frequency encoded part, a high frequency encoded part and information about the high frequency temporal envelope shape (step S110-1).

The high frequency temporal envelope shape determiner 110b determines the temporal envelope shape of the high frequency signal, based on at least one of information about the high frequency temporal envelope shape divided by the code sequence demultiplexer 110a, the high frequency signal obtained by the high frequency decoder 100e and the low frequency signal obtained by the low frequency decoder 100b (step S110-2).

Examples include a case where it is determined that the temporal envelope shape of the high frequency signal is flat, a case where it is determined that the temporal envelope shape of the high frequency signal is onset, and a case where it is determined that the temporal envelope shape of the high frequency signal is offset.

The temporal envelope shape of the high frequency signal is determined, for example, by replacing the decoded signal obtained by the speech decoder 1b with the high frequency signal obtained by the high frequency decoder 100e in the process of determining the temporal envelope shape of the decoded signal in the temporal envelope shape determiner 1c. Similarly, the decoded signal obtained by the speech decoder 1b can be replaced with the low frequency signal obtained by the low frequency decoder 100b.

The high frequency temporal envelope modifier 110c modifies the shape of the temporal envelope of the high frequency signal output from the high frequency decoder 110e, based on the temporal envelope shape determined by the high frequency temporal envelope shape determiner 110b (step S110-3). For example, when it is determined that the temporal envelope shape of the high frequency signal is flat, the temporal envelope shape of the high frequency signal can be modified by the following process.

The temporal envelope shape of the high frequency signal can be modified, for example, by replacing the decoded signal obtained by the speech decoder 1b with the high frequency signal obtained by the high frequency decoder 100e in the process of modifying the temporal envelope shape of the decoded signal in the temporal envelope modifier 1d.

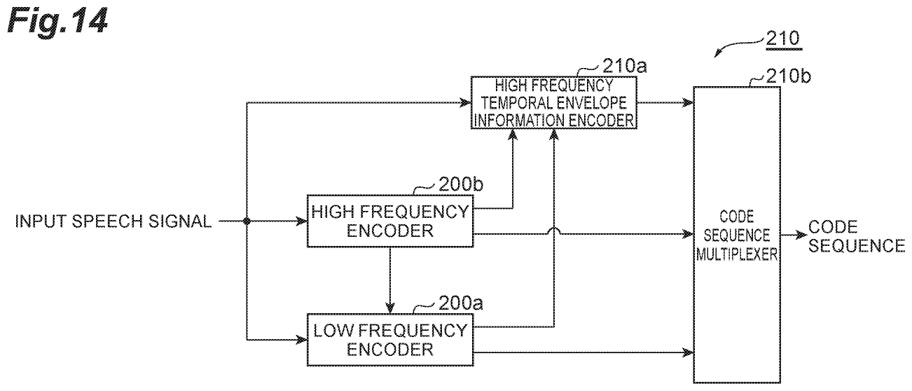

FIG. 14 is a diagram showing the configuration of the speech encoding device 210 according to the third embodiment. A communication device of the speech encoding device 210 receives a speech signal to be encoded from the outside and outputs the encoded code sequence to the outside. As shown in FIG. 14, the speech encoding device 210 functionally includes a low frequency encoder 200a, a high frequency encoder 200b, a high frequency temporal envelope information encoder 210a, and a code sequence multiplexer 210b.

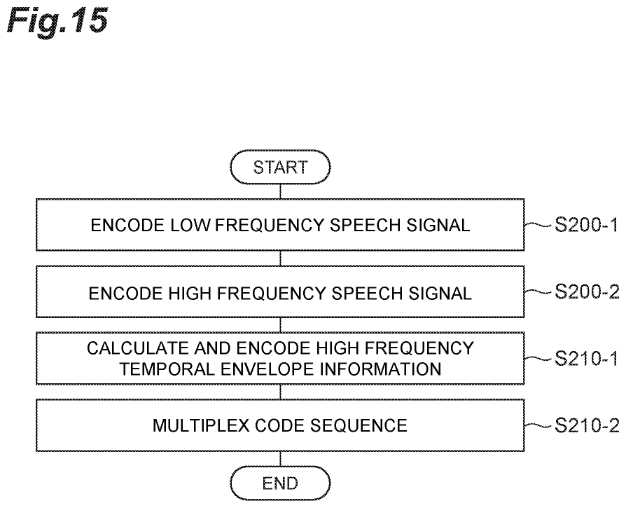

FIG. 15 is a flowchart showing the operation of the speech encoding device 210 according to the third embodiment.

The high frequency temporal envelope information encoder 210a calculates and encodes high frequency temporal envelope shape information, based on at least one of the input speech signal, information obtained in the encoding process including the encoding result of the input speech signal in the low frequency encoder 200a, and information obtained in the encoding process including the encoding result of the input speech signal in the high frequency encoder 200b (step S210-1).

Calculating and encoding high frequency temporal envelope shape information can be performed similarly, for example, in the process of calculating and encoding the temporal envelope information on the input speech signal in the temporal envelope information encoder 2b where the high frequency signal of the input speech signal is used in place of the input speech signal, and the high frequency decoded signal obtained by decoding the encoding result in the high frequency encoder 200b is used in place of the decoded signal.

The code sequence multiplexer 210b receives the code sequence of the low frequency speech signal from the low frequency encoder 200a, receives the code sequence of the high frequency speech signal from the high frequency encoder 200b, receives the encoded high frequency temporal envelope shape information from the high frequency temporal envelope information encoder 210a and outputs a multiplexed code sequence (step S210-2).

### Fourth Embodiment

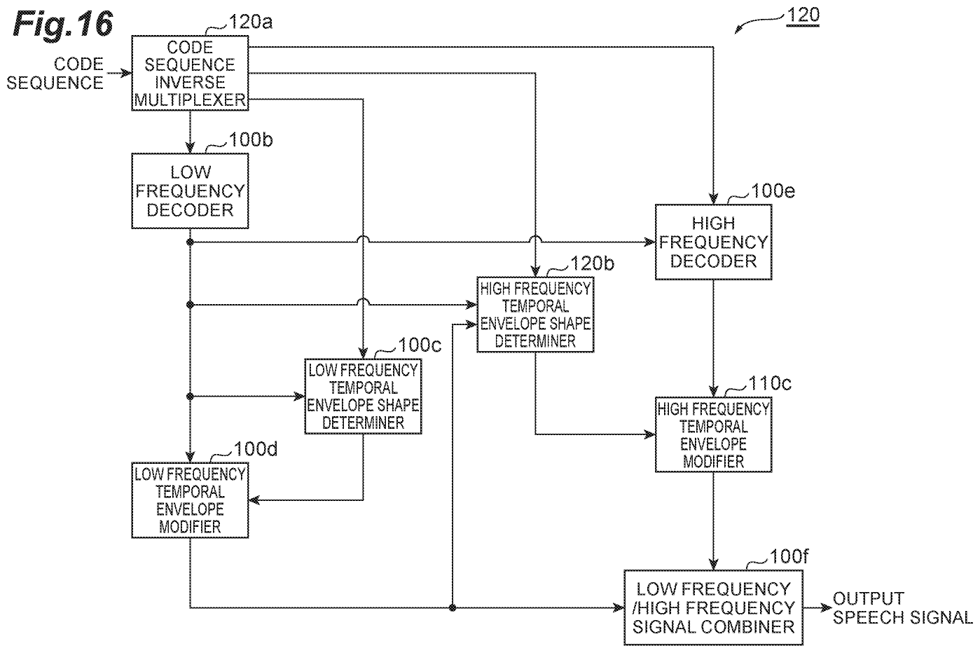

FIG. 16 is a diagram showing the configuration of a speech decoding device 120 according to a fourth embodiment. A communication device of the speech decoding device 120 receives a multiplexed code sequence output from a speech encoding device 220 described below and outputs a decoded speech signal to the outside. As shown in FIG. 16, the speech decoding device 120 functionally includes a code sequence demultiplexer 120a, a low frequency decoder 100b, a low frequency temporal envelope shape determiner 100c, a low frequency temporal envelope modifier 100d, a high frequency decoder 100e, a high frequency temporal envelope shape determiner 120b, a high frequency temporal envelope modifier 110c, and a low frequency/high frequency signal combiner 100f.

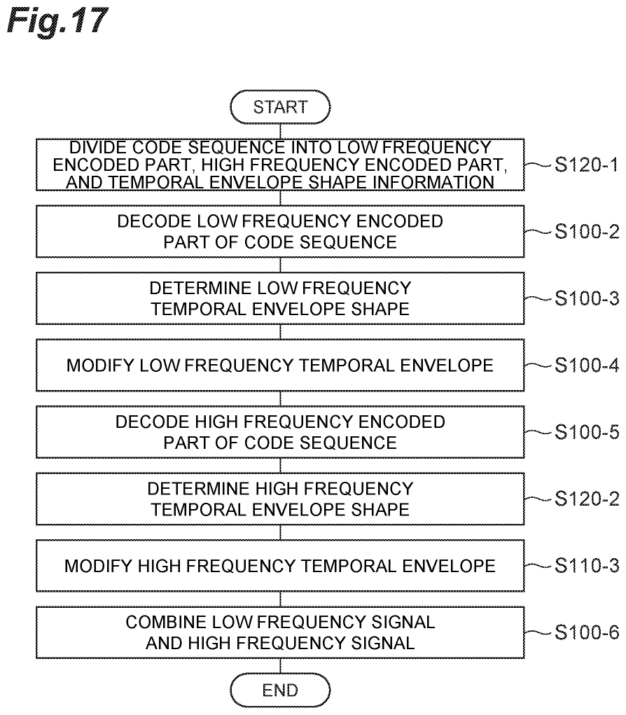

FIG. 17 is a flowchart showing the operation of the speech decoding device 120 according to the fourth embodiment.

The code sequence demultiplexer 120a divides a code sequence into a low frequency encoded part, a high frequency encoded part, information about the low frequency temporal envelope shape and information about the high frequency temporal envelope shape (step S120-1).

In doing so, the information about the low frequency temporal envelope shape and the information about the high frequency temporal envelope shape can be divided, for example, from a code sequence including information about the low frequency temporal envelope shape and information about the high frequency temporal envelope shape that are separately encoded or can be divided from a code sequence including information about the frequency temporal envelope shape and information about the high frequency temporal envelope shape that are encoded in combination. For example, they can be divided from a code sequence including information in which information about the low frequency temporal envelope shape and information about the high frequency temporal envelope shape are represented by a single piece of information and encoded.

The high frequency temporal envelope shape determiner 120b determines the temporal envelope shape of the high frequency signal, based on at least one of the information about the high frequency temporal envelope shape divided by the code sequence demultiplexer 120a, the low frequency signal obtained by the low frequency decoder 100b, and the low frequency signal having the temporal envelope shape modified by the low frequency temporal envelope modifier 100d (step S120-2).

Examples include a case where it is determined that the temporal envelope shape of the high frequency signal is flat, a case where it is determined that the temporal envelope shape of the high frequency signal is onset, and a case where it is determined that the temporal envelope shape of the high frequency signal is offset.

If the process of determining the high frequency temporal envelope shape in the high frequency temporal envelope shape determiner 120b is based on the low frequency signal having the temporal envelope shape modified by the low frequency temporal envelope modifier 100d, the decoded signal obtained by the speech decoder 1b can be replaced with the low frequency signal having the temporal envelope shape modified by the low frequency temporal envelope modifier 100d in the process of determining the temporal envelope shape of the decoded signal in the temporal envelope shape determiner 1c.

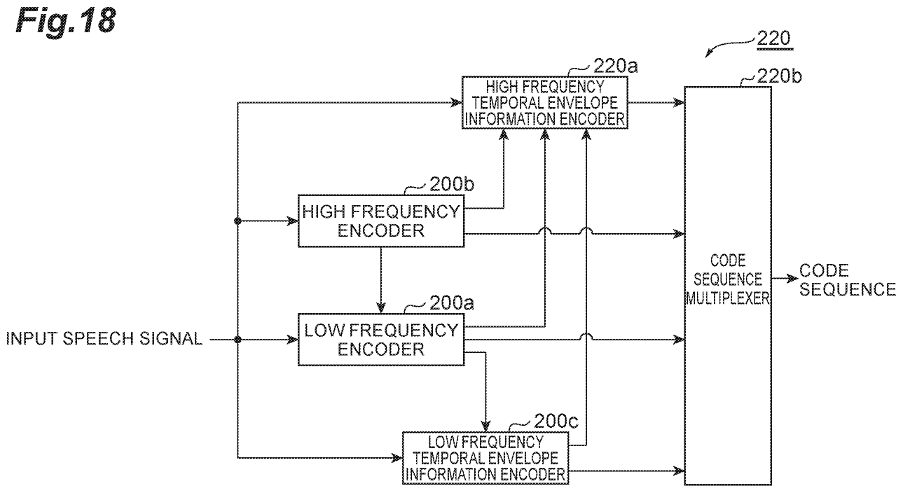

FIG. 18 is a diagram showing the configuration of the speech encoding device 220 according to the fourth embodiment. A communication device of the speech encoding device 220 receives a speech signal to be encoded from the outside and outputs the encoded code sequence to the outside. As shown in FIG. 18, the speech encoding device 220 functionally includes a low frequency encoder 200a, a high frequency encoder 200b, a low frequency temporal envelope information encoder 200c, a high frequency temporal envelope information encoder 220a, and a code sequence multiplexer 220b.

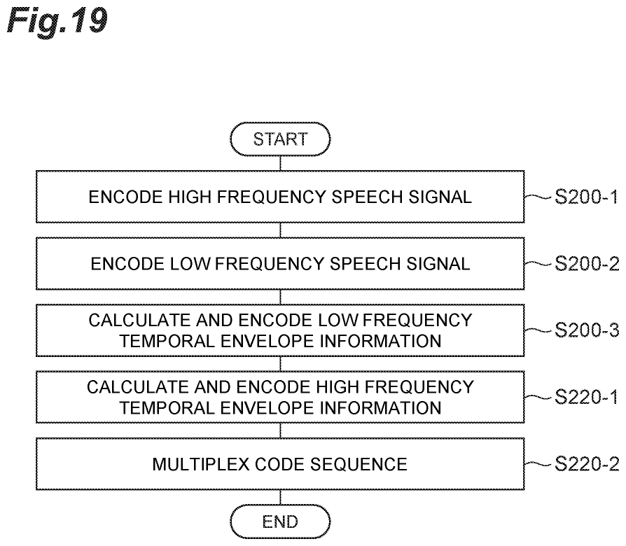

FIG. 19 is a flowchart showing the operation of the speech encoding device 220 according to the fourth embodiment.

The high frequency temporal envelope information encoder 220a calculates and encodes high frequency temporal envelope shape information, based on at least one of the input speech signal, information obtained in the encoding process including the encoding result of the input speech signal in the low frequency encoder 200a, information obtained in the encoding process including the encoding result of the input speech signal in the high frequency encoder 200b, and information obtained in the encoding process including the encoding result of the low frequency temporal envelope information in the low frequency temporal envelope information encoder 200c (step S220-1).

Calculating and encoding high frequency temporal envelope shape information can be performed, for example, in the process of calculating and encoding the temporal envelope information on the high frequency signal by the high frequency temporal envelope information encoder 210a. For example, the process may be based on the encoding result of the low frequency temporal envelope information. For example, only when the result indicating that the low frequency temporal envelope is flat is obtained as the encoding result of the low frequency temporal envelope information, can whether the high frequency temporal envelope is flat be encoded as the high frequency temporal envelope information.

The code sequence multiplexer 220b receives the code sequence of the low frequency speech signal from the low frequency encoder 200a, receives the code sequence of the high frequency speech signal from the high frequency encoder 200b, receives the encoded low frequency temporal envelope shape information from the low frequency temporal envelope information encoder 200c, receives the encoded high frequency temporal envelope shape information from the high frequency temporal envelope information encoder 210a, and outputs a multiplexed code sequence (step S220-2).

In doing so, in the encoding of the information about the low frequency temporal envelope shape and the information about the high frequency temporal envelope shape, for example, separately encoded information about the low frequency temporal envelope shape and information about the high frequency temporal envelope shape may be received, or unitedly encoded information about the frequency temporal envelope shape and information about the high frequency temporal envelope shape may be received. For example, information about the low frequency temporal envelope shape and information about the high frequency temporal envelope shape, both being represented by a single piece of information and encoded, may be received.

### [First Modification of Speech Decoding Device of Fourth Embodiment]

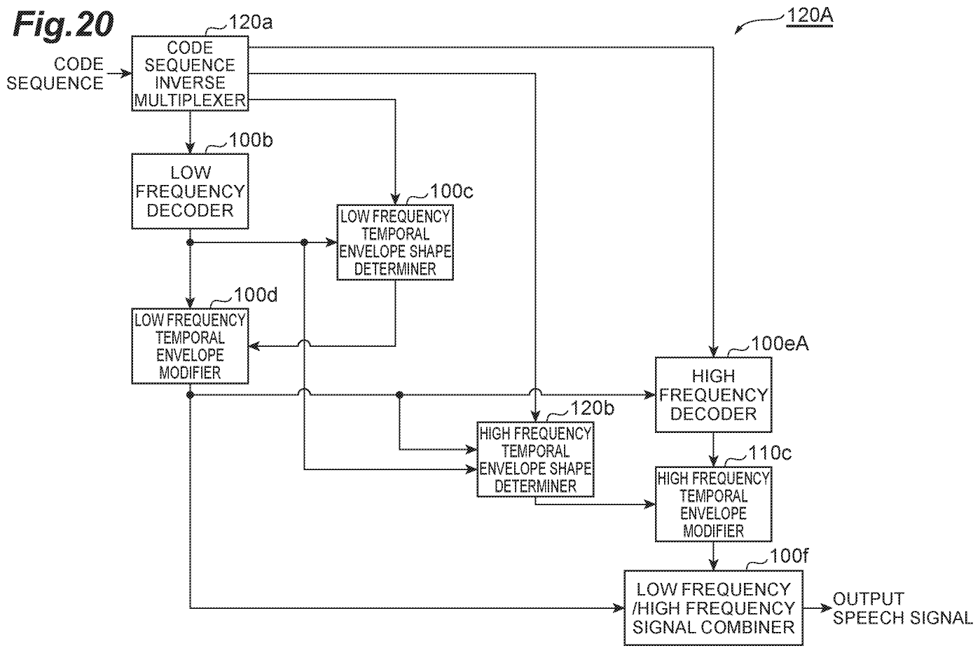

FIG. 20 is a diagram showing the configuration of a first modification 120A of the speech decoding device according to the fourth embodiment. The difference from the speech decoding device 120 in the fourth embodiment is that the low frequency signal having the temporal envelope shape modified by the low frequency temporal envelope modifier 100d is used in decoding a high frequency signal in the high frequency decoder 100eA.

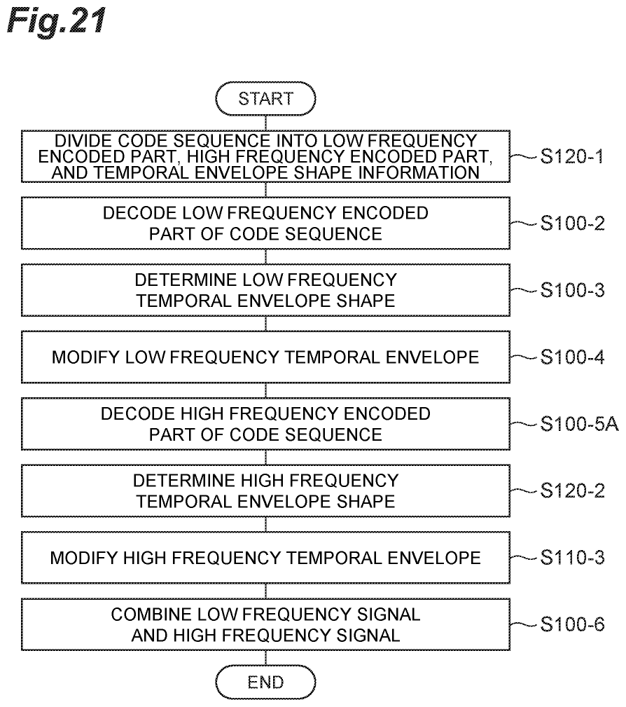

FIG. 21 is a flowchart showing the operation of the first modification 120A of the speech decoding device according to the fourth embodiment. In step 100-5A in FIG. 21, when the low frequency decoded signal obtained by the low frequency decoder 100b is used in decoding a high frequency signal, the low frequency signal having the temporal envelope shape modified by the low frequency temporal envelope modifier 100d is used.

### [Second Modification of Speech Decoding Device of Fourth Embodiment]

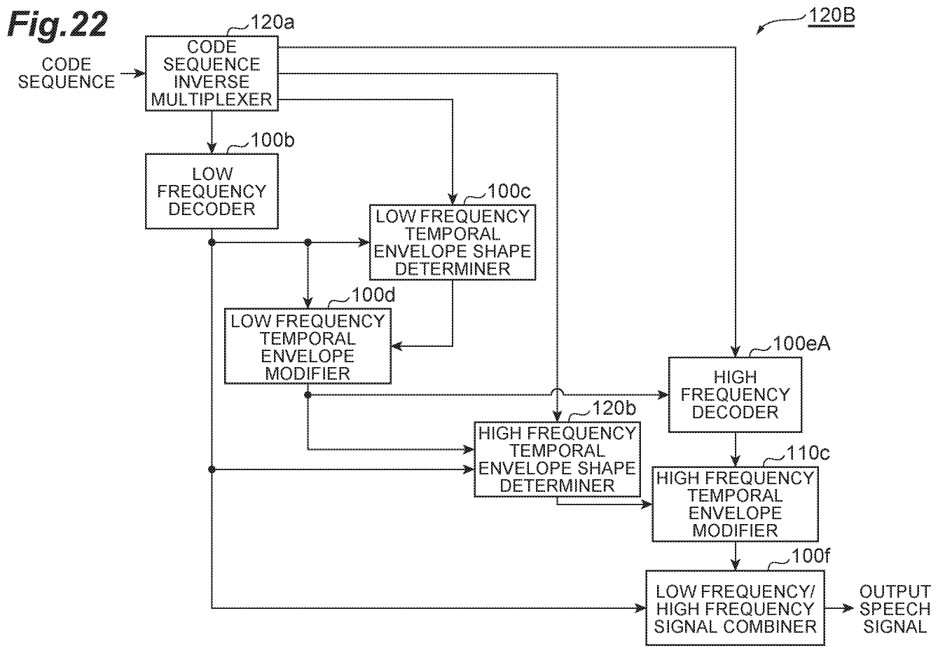

FIG. 22 is a diagram showing the configuration of a second modification 120B of the speech encoding device according to the fourth embodiment. The difference from the first modification of the speech decoding device in the fourth embodiment is that the low frequency signal input to the low frequency/high frequency signal combiner 100f is not output from the low frequency temporal envelope modifier 100d but output from the low frequency decoder 100b.

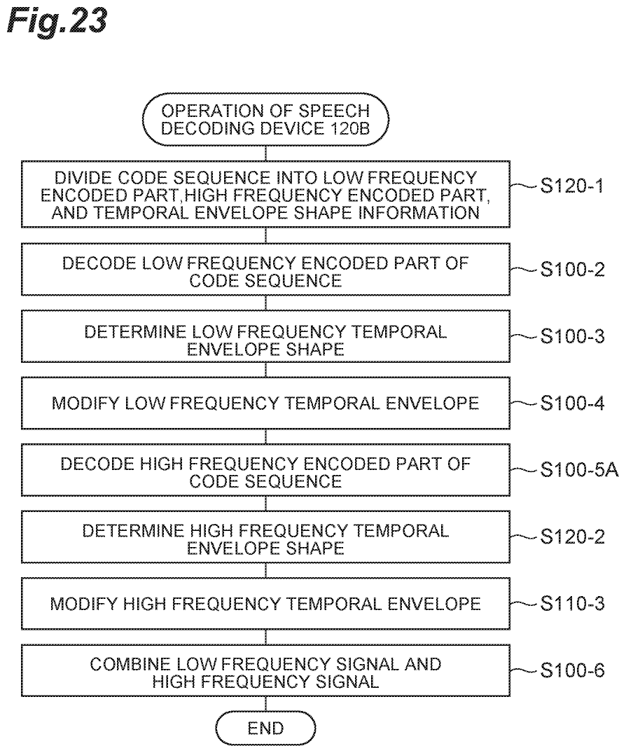

FIG. 23 is a flowchart showing the operation of the second modification 120B of the speech decoding device according to the fourth embodiment. In step S100-6 in FIG. 23, the low frequency signal from the low frequency decoder 100b and the high frequency signal from the high frequency temporal envelope modifier 110c are combined.

### [Third Modification of Speech Decoding Device of Fourth Embodiment]

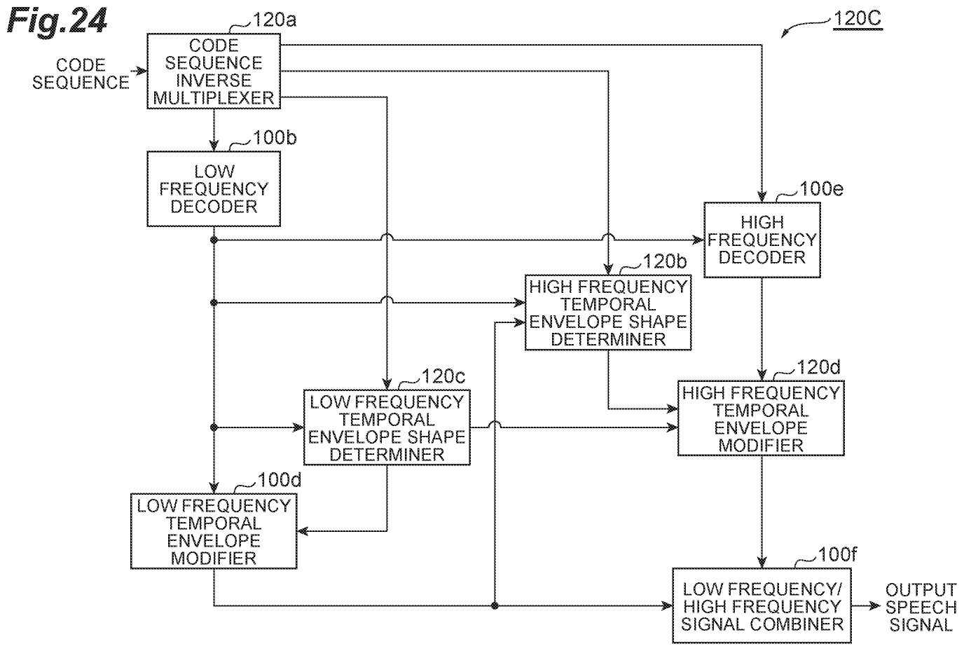

FIG. 24 is a diagram showing the configuration of a third modification 120C of the speech decoding device according to the fourth embodiment.

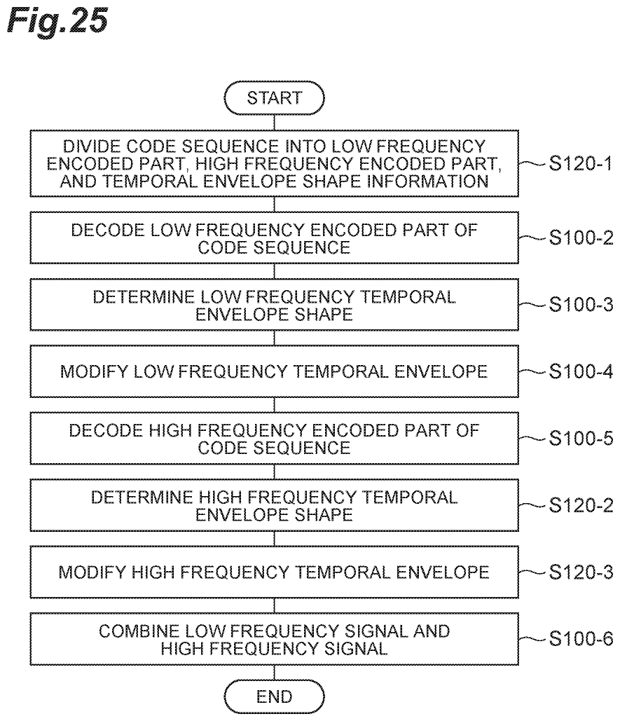

FIG. 25 is a flowchart showing the operation of the third modification 120C of the speech decoding device according to the fourth embodiment.

The present modification differs from the speech decoding device 120 according to the fourth embodiment in that it includes a low frequency temporal envelope shape determiner 120c and a high frequency temporal envelope modifier 120d in place of the low frequency temporal envelope shape determiner 100c and the high frequency temporal envelope modifier 110c.

In the present modification, the low frequency temporal envelope shape determiner 120c differs from the low frequency temporal envelope shape determiner 100c in that it also notifies the high frequency temporal envelope modifier 120d of the determined temporal envelope shape.

The high frequency temporal envelope modifier 120d differs from the high frequency temporal envelope modifier 110c in that the shape of the temporal envelope of the high frequency signal output from the high frequency decoder 100e is modified, based on at least one of the temporal envelope shape determined by the high frequency temporal envelope shape determiner 120b and the temporal envelope shape determined by the low frequency temporal envelope shape determiner 120c (S120-3).

For example, if the low frequency temporal envelope shape determiner 120c determines that the temporal envelope shape is flat, the temporal envelope of the high frequency signal output from the high frequency decoder 100e is modified into a flat shape, irrespective of the temporal envelope shape determined by the high frequency temporal envelope shape determiner 120b. For example, if the low frequency temporal envelope shape determiner 120c determines that the temporal envelope shape is not flat, the temporal envelope of the high frequency signal output from the high frequency decoder 100e is not modified into a flat shape, irrespective of the temporal envelope shape determined by the high frequency temporal envelope shape determiner 120b. This is applicable to the cases of onset and offset and is not limited to any specific temporal envelope shape.

### [Fourth Modification of Speech Decoding Device of Fourth Embodiment]

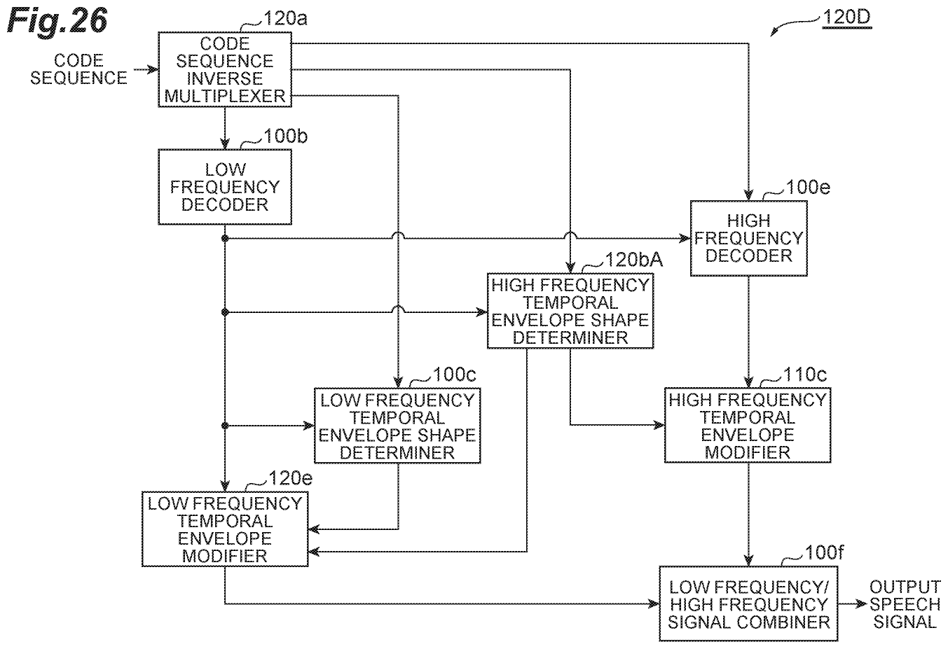

FIG. 26 is a diagram showing the configuration of a fourth modification 120D of the speech decoding device according to the fourth embodiment.

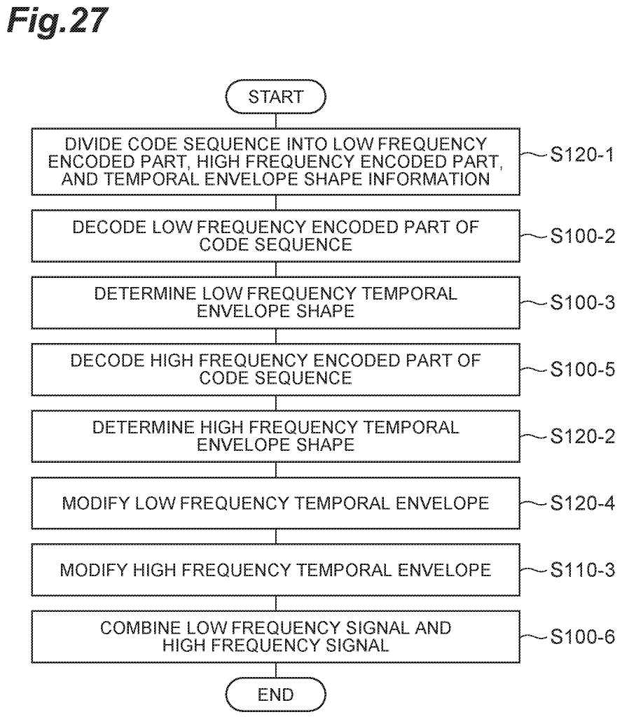

FIG. 27 is a flowchart showing the operation of the fourth modification 120D of the speech decoding device according to the fourth embodiment.

The present modification differs from the speech decoding device 120 according to the fourth embodiment in that it includes a high frequency temporal envelope shape determiner 120bA and a low frequency temporal envelope modifier 120e in place of the high frequency temporal envelope shape determiner 120b and the low frequency temporal envelope modifier 100d.

In the present modification, the high frequency temporal envelope shape determiner 120bA differs from the high frequency temporal envelope shape determiner 120b in that it also notifies the low frequency temporal envelope modifier 120e of the determined temporal envelope shape.

The determination of the temporal envelope shape in the high frequency temporal envelope shape determiner 120bA can be based, for example, on the frequency power distribution of the low frequency signal, in addition to the above examples. For example, the frame length in the decoding of the high frequency signal obtained from the code sequence demultiplexer 120a can be used. For example, it can be determined that the shape is flat if the frame length is long, and it can be determined that the shape is onset or offset if the frame length is short. The high frequency temporal envelope shape determiner 120b can also determine in the same manner.

The low frequency temporal envelope modifier 120e differs from the low frequency temporal envelope modifier 100d in that the shape of the temporal envelope of the low frequency signal output from the low frequency decoder 100b is modified, based on at least one of the temporal envelope shape determined by the low frequency temporal envelope shape determiner 100c and the temporal envelope shape determined by the high frequency temporal envelope shape determiner 120bA (S120-4).

For example, if the high frequency temporal envelope shape determiner 120bA determines that the temporal envelope shape is flat, the temporal envelope of the low frequency signal output from the low frequency decoder 100b is modified into a flat shape, irrespective of the temporal envelope shape determined by the low frequency temporal envelope shape determiner 100c. For example, if the high frequency temporal envelope shape determiner 120bA determines that the temporal envelope shape is flat, the temporal envelope of the low frequency signal output from the low frequency decoder 100b is not modified into a flat shape, irrespective of the temporal envelope shape determined by the low frequency temporal envelope shape determiner 100c. This is applicable to the cases of onset and offset and is not limited to any specific temporal envelope shape.

### [Fifth Modification of Speech Decoding Device of Fourth Embodiment]

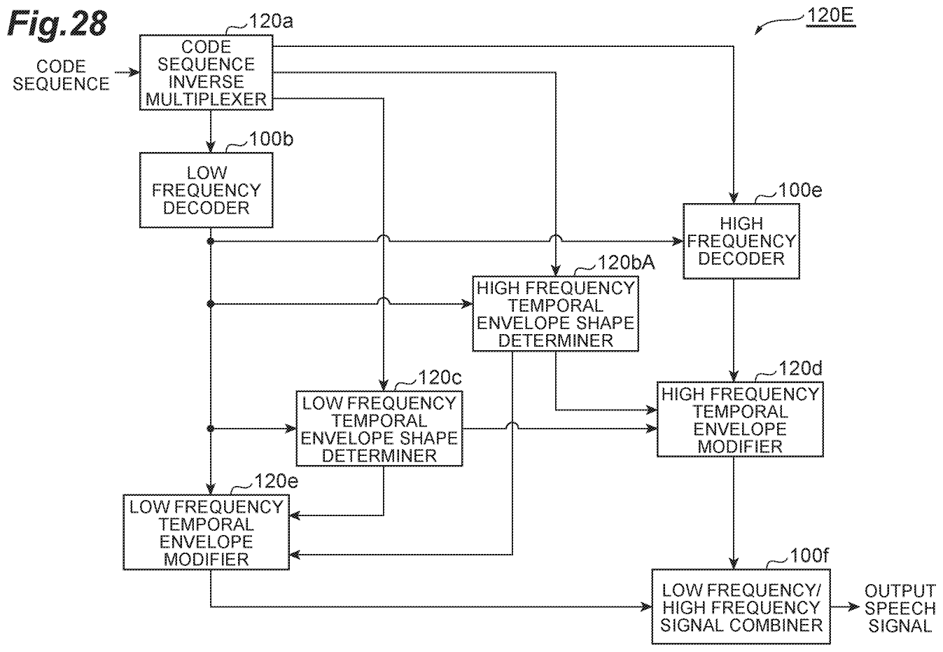

FIG. 28 is a diagram showing the configuration of a fifth modification 120E of the speech decoding device according to the fourth embodiment.

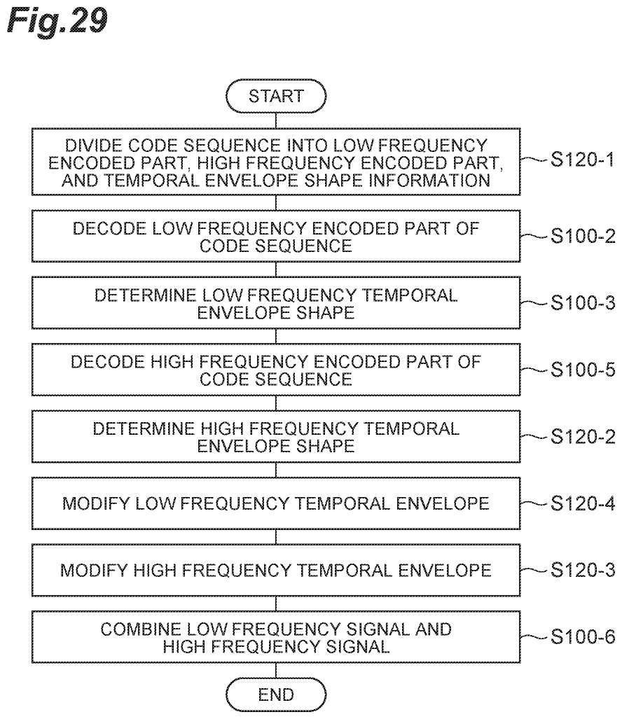

FIG. 29 is a flowchart showing the operation of the fifth modification 120E of the speech decoding device according to the fourth embodiment.

The present modification includes the low frequency temporal envelope shape determiner 120c, the high frequency temporal envelope modifier 120d, the high frequency temporal envelope shape determiner 120bA, and the low frequency temporal envelope modifier 120e.

### [Sixth Modification of Speech Decoding Device of Fourth Embodiment]

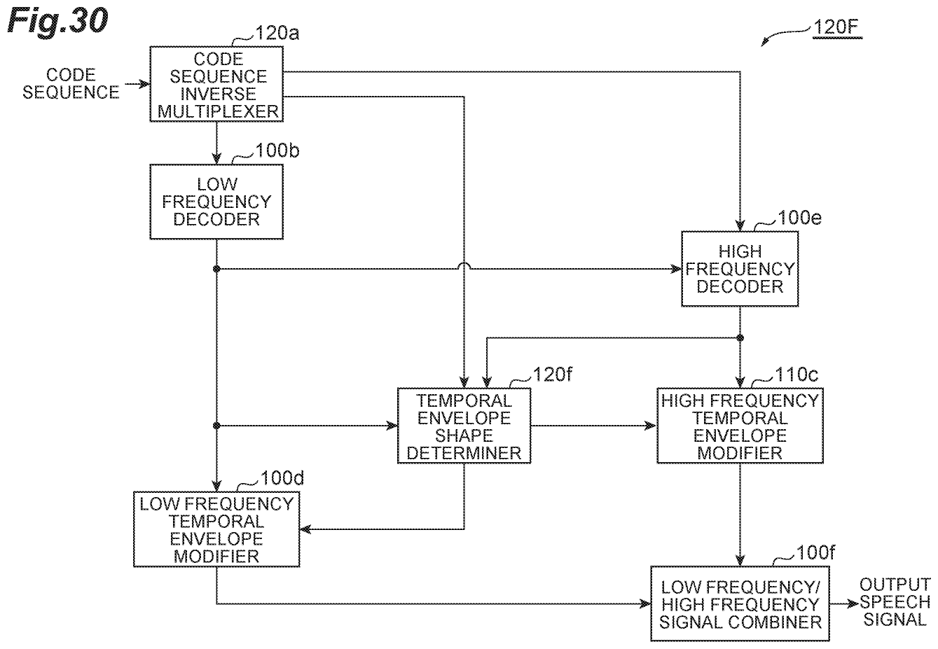

FIG. 30 is a diagram showing the configuration of a sixth modification 120F of the speech decoding device according to the fourth embodiment.

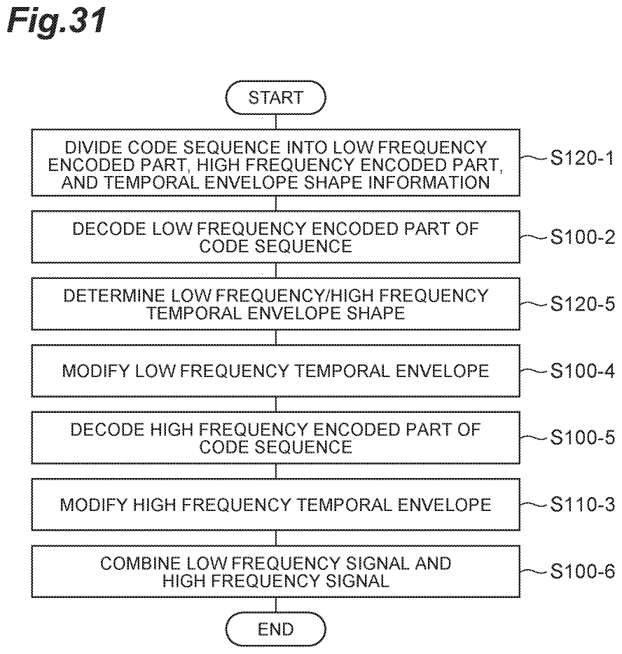

FIG. 31 is a flowchart showing the operation of the sixth modification 120F of the speech decoding device according to the fourth embodiment.

The present modification differs from the speech decoding device 120 according to the fourth embodiment in that it includes a temporal envelope shape determiner 120f in place of the low frequency temporal envelope shape determiner 100c and the high frequency temporal envelope shape determiner 120b.

The temporal envelope shape determiner 120f determines the temporal envelope shape, based on at least one of information about the low frequency temporal envelope shape from the code sequence demultiplexer 120a, information about the high frequency temporal envelope shape, the low frequency signal from the low frequency decoder 100b, and the high frequency signal from the high frequency decoder 100e (S120-5). The low frequency temporal envelope modifier 100d and the high frequency temporal envelope modifier 110c are notified of the determined temporal envelope shape.

For example, it may be determined that the temporal envelope shape is flat. For example, it may be determined that the temporal envelope shape is onset. For example, it may be determined that the temporal envelope shape is offset. The determined temporal envelope shape is not limited to the above examples.

The temporal envelope shape determiner 120f can determine the temporal envelope shape, for example, as performed by the low frequency temporal envelope shape determiners 100c and 120c, and the high frequency temporal envelope shape determiners 120b and 120bA. The method of determining the temporal envelope shape is not limited to the above examples.

### [Seventh Modification of Speech Decoding Device of Fourth Embodiment]

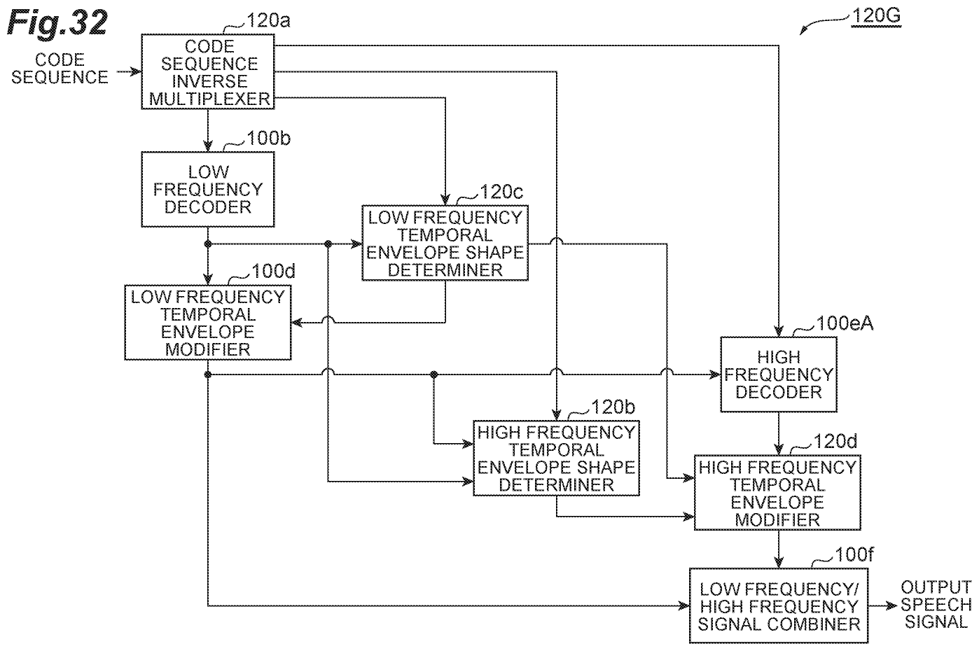

FIG. 32 is a diagram showing the configuration of a seventh modification 120G of the speech decoding device according to the fourth embodiment.

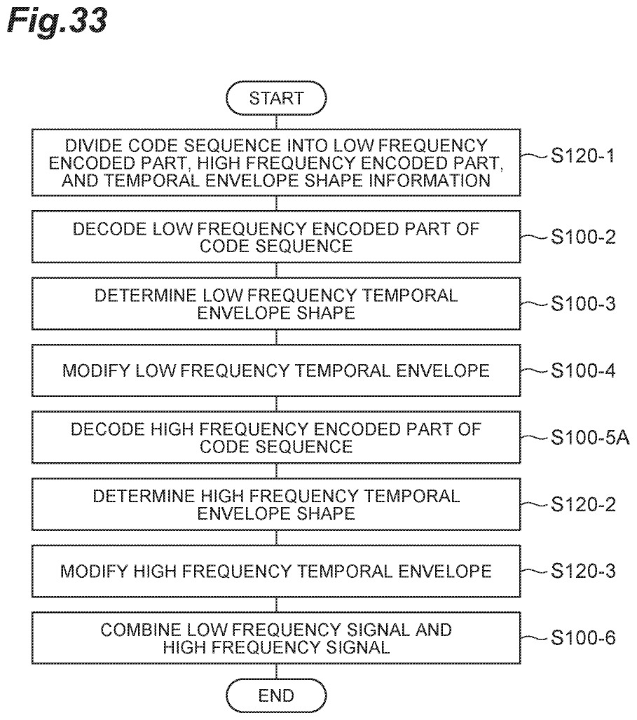

FIG. 33 is a flowchart showing the operation of the seventh modification 120G of the speech decoding device according to the fourth embodiment.

The present modification differs from the first modification 120A of the speech decoding device according to the fourth embodiment in that it includes a low frequency temporal envelope shape determiner 120c and a high frequency temporal envelope modifier 120d in place of the low frequency temporal envelope shape determiner 100c and the high frequency temporal envelope modifier 110c.

### [Eighth Modification of Speech Decoding Device of Fourth Embodiment]

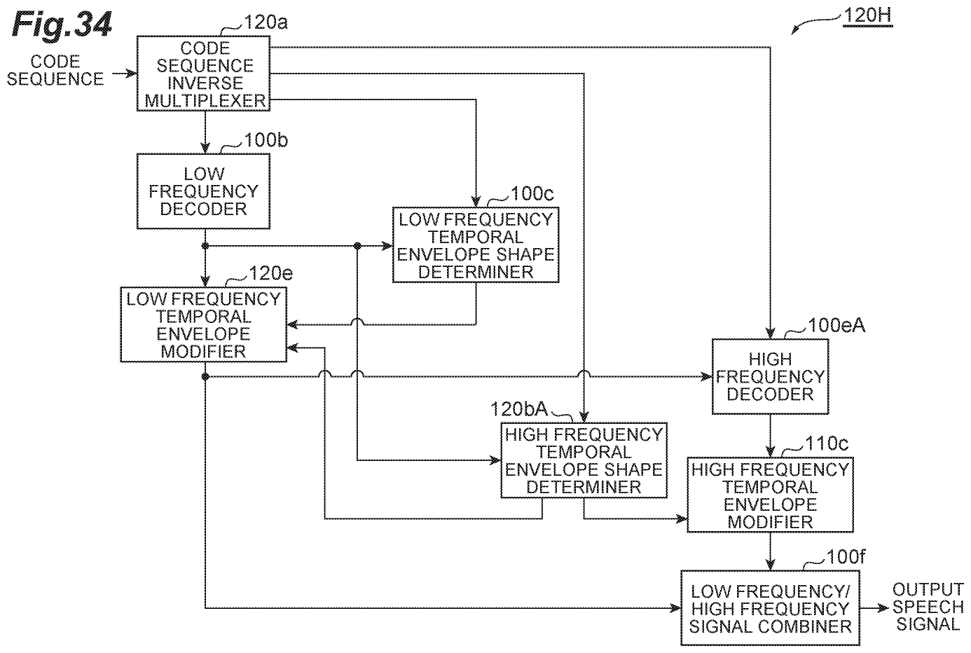

FIG. 34 is a diagram showing the configuration of an eighth modification 120H of the speech decoding device according to the fourth embodiment.

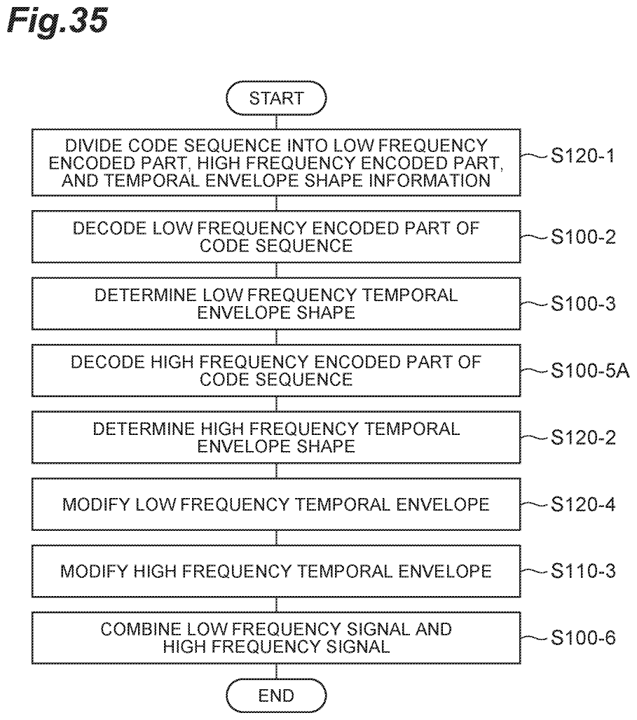

FIG. 35 is a flowchart showing the operation of the eighth modification 120H of the speech decoding device according to the fourth embodiment.

The present modification differs from the first modification 120A of the speech decoding device according to the fourth embodiment in that it includes a high frequency temporal envelope shape determiner 120bA and a low frequency temporal envelope modifier 120e in place of the high frequency temporal envelope shape determiner 120b and the low frequency temporal envelope modifier 100d.

### [Ninth Modification of Speech Decoding Device of Fourth Embodiment]

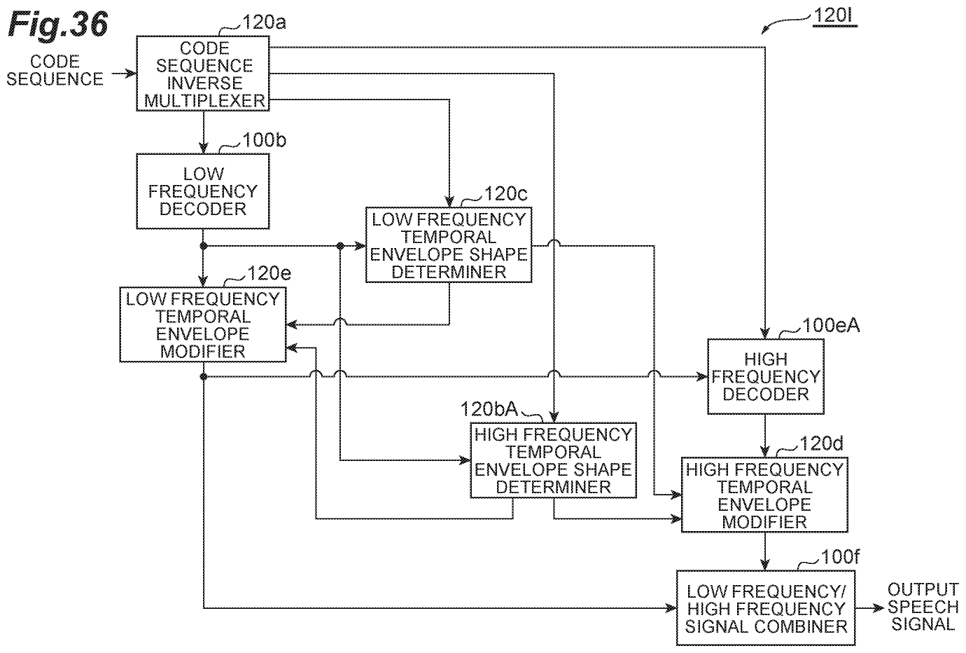

FIG. 36 is a diagram showing the configuration of a ninth modification 120I of the speech decoding device according to the fourth embodiment.

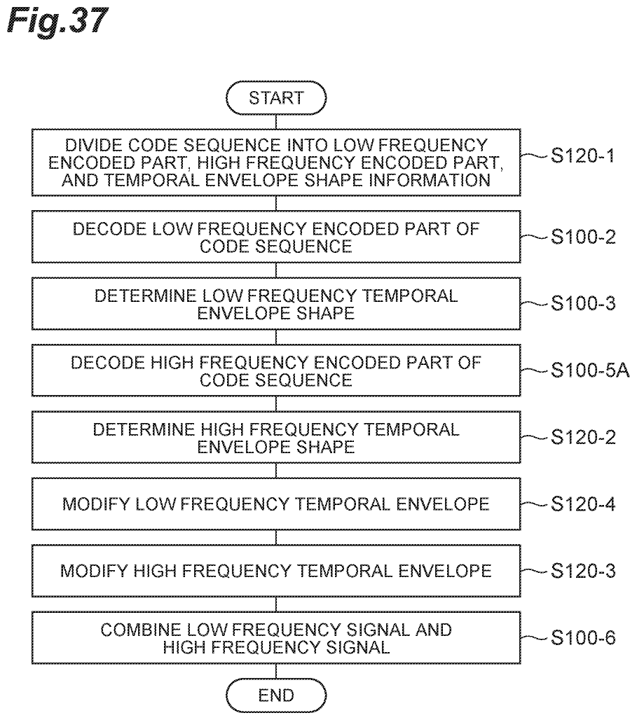

FIG. 37 is a flowchart showing the operation of the ninth modification 120I of the speech decoding device according to the fourth embodiment.

The present modification includes the low frequency temporal envelope shape determiner 120c, the high frequency temporal envelope modifier 120d, the high frequency temporal envelope shape determiner 120bA, and the low frequency temporal envelope modifier 120e.

### [Tenth Modification of Speech Decoding Device of Fourth Embodiment]

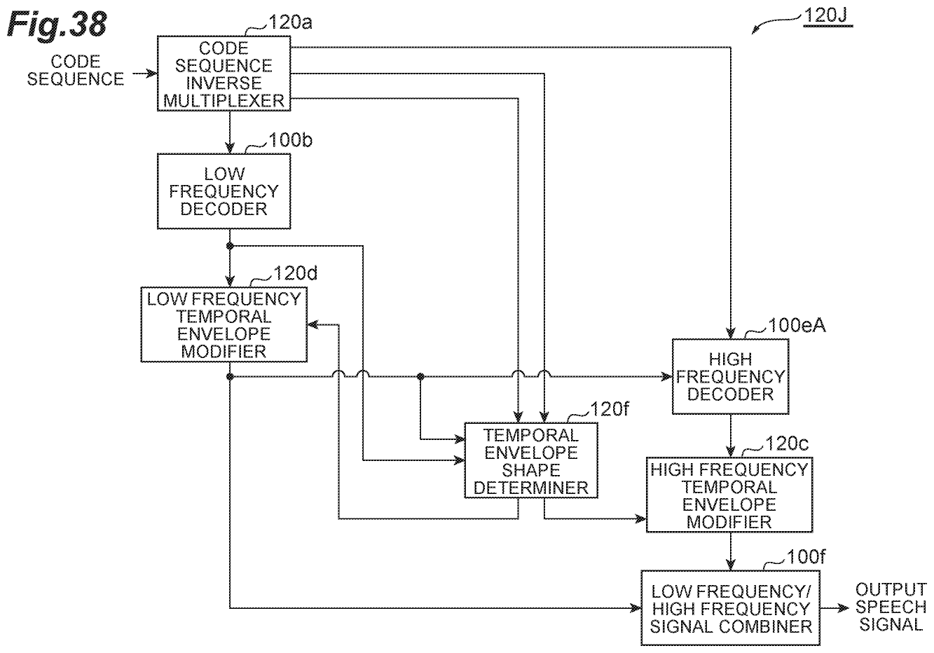

FIG. 38 is a diagram showing the configuration of a tenth modification 120J of the speech decoding device according to the fourth embodiment.

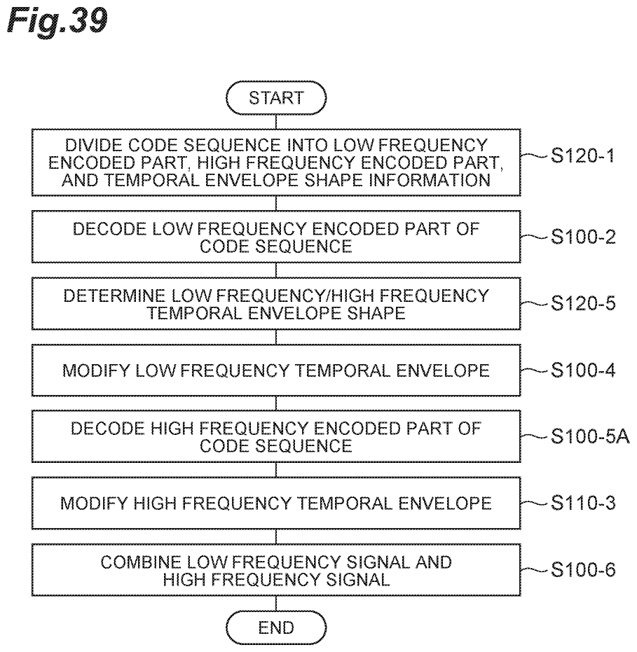

FIG. 39 is a flowchart showing the operation of the tenth modification 120J of the speech decoding device according to the fourth embodiment.

The present modification differs from the first modification 120A of the speech decoding device according to the fourth embodiment in that it includes a temporal envelope shape determiner 120f in place of the low frequency temporal envelope shape determiner 100c and the high frequency temporal envelope shape determiner 120b.

### [Eleventh Modification of Speech Decoding Device of Fourth Embodiment]

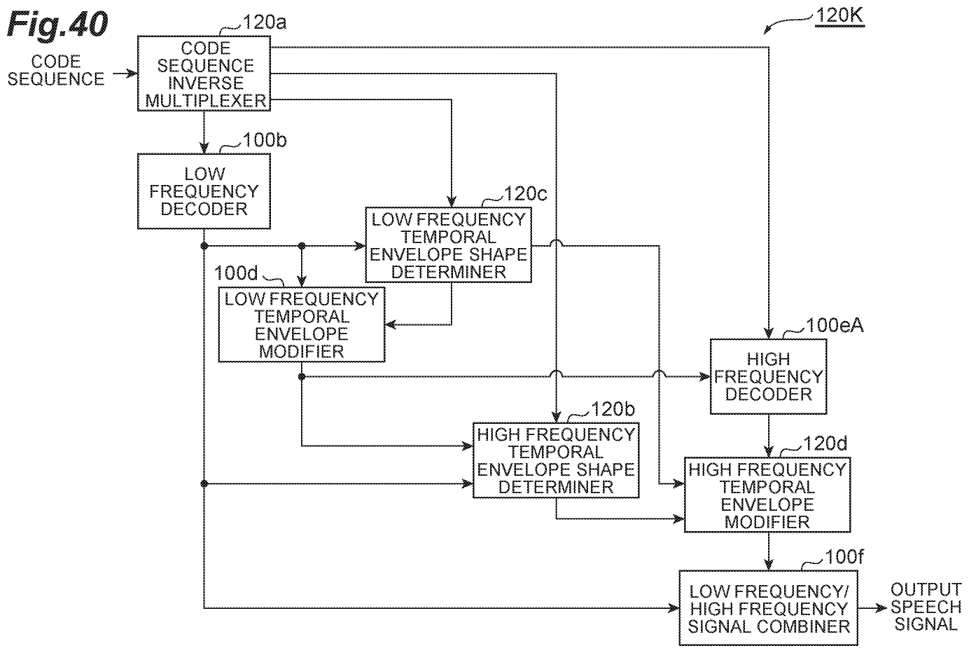

FIG. 40 is a diagram showing the configuration of an eleventh modification 120K of the speech decoding device according to the fourth embodiment.

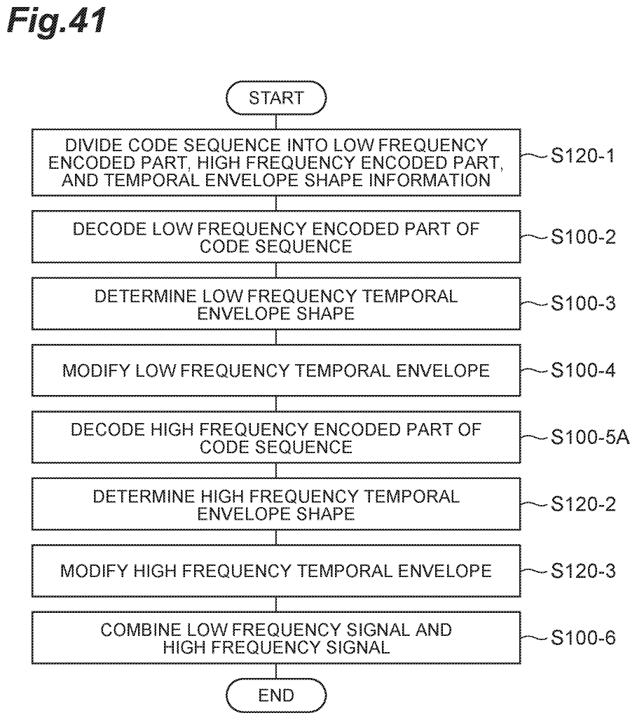

FIG. 41 is a flowchart showing the operation of the eleventh modification 120K of the speech decoding device according to the fourth embodiment.

The present modification differs from the second modification 120B of the speech decoding device according to the fourth embodiment in that it includes a low frequency temporal envelope shape determiner 120c and a high frequency temporal envelope modifier 120d in place of the low frequency temporal envelope shape determiner 100c and the high frequency temporal envelope modifier 110c.

### [Twelfth Modification of Speech Decoding Device of Fourth Embodiment]

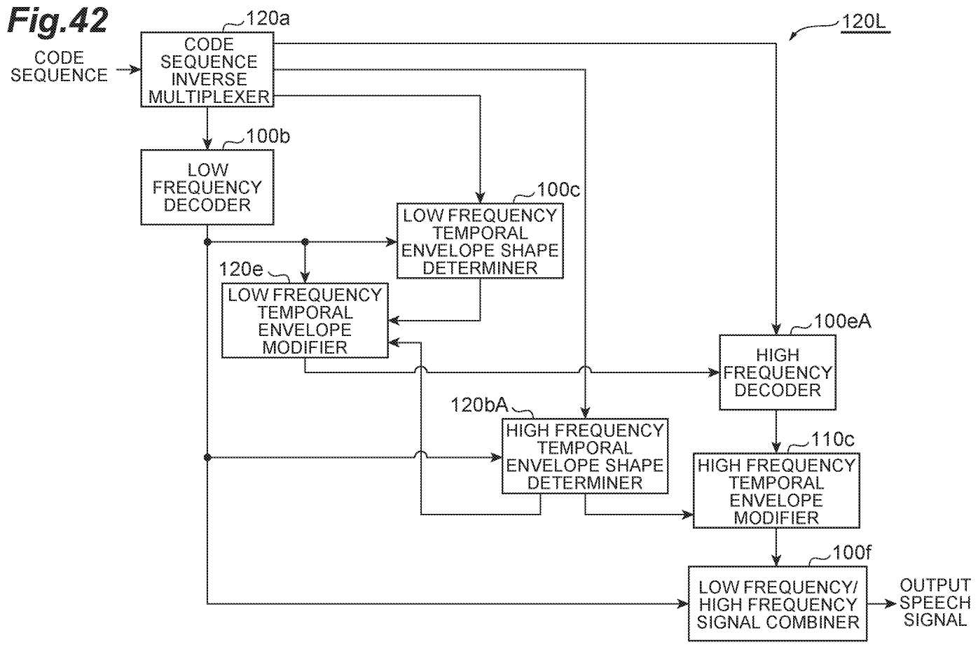

FIG. 42 is a diagram showing the configuration of a twelfth modification 120L of the speech decoding device according to the fourth embodiment.

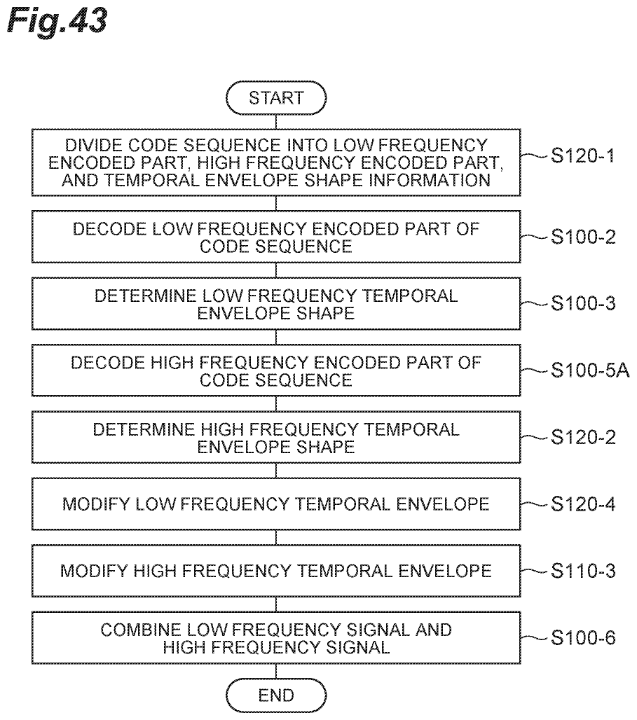

FIG. 43 is a flowchart showing the operation of the twelfth modification 120L of the speech decoding device according to the fourth embodiment.

The present modification differs from the second modification 120B of the speech decoding device according to the fourth embodiment in that it includes a high frequency temporal envelope shape determiner 120bA and a low frequency temporal envelope modifier 120e in place of the high frequency temporal envelope shape determiner 120b and the low frequency temporal envelope modifier 100d.

### [Thirteenth Modification of Speech Decoding Device of Fourth Embodiment]

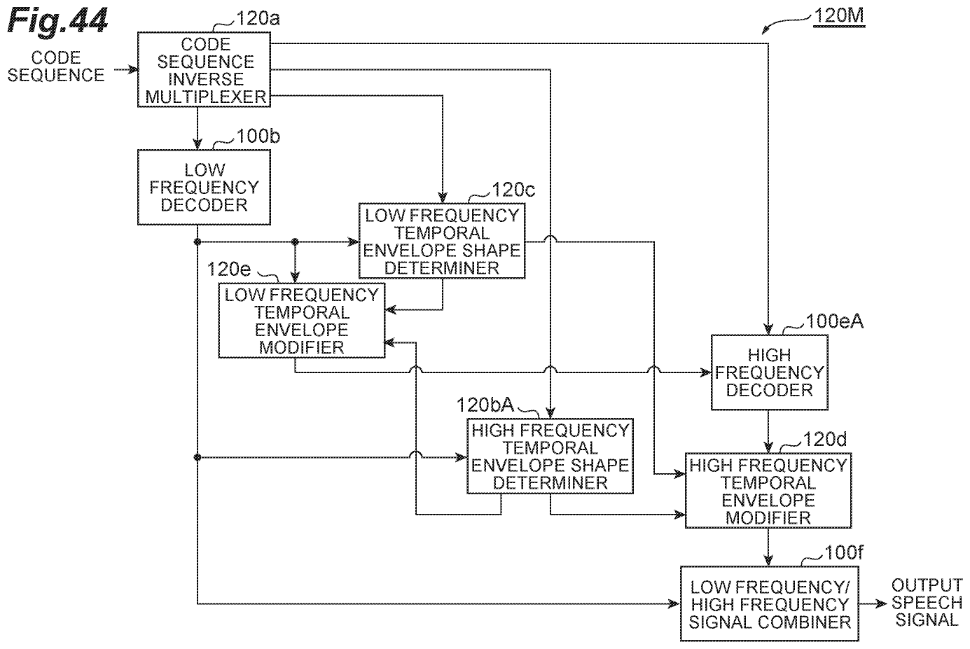

FIG. 44 is a diagram showing the configuration of a thirteenth modification 120M of the speech decoding device according to the fourth embodiment.

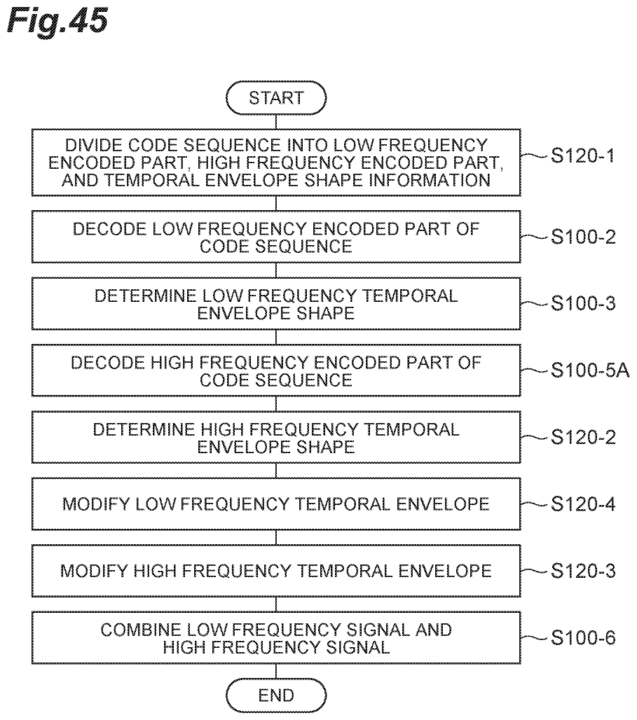

FIG. 45 is a flowchart showing the operation of the thirteenth modification 120M of the speech decoding device according to the fourth embodiment.

The present modification includes the low frequency temporal envelope shape determiner 120c, the high frequency temporal envelope modifier 120d, the high frequency temporal envelope shape determiner 120bA, and the low frequency temporal envelope modifier 120e.

### [Fourteenth Modification of Speech Decoding Device of Fourth Embodiment]

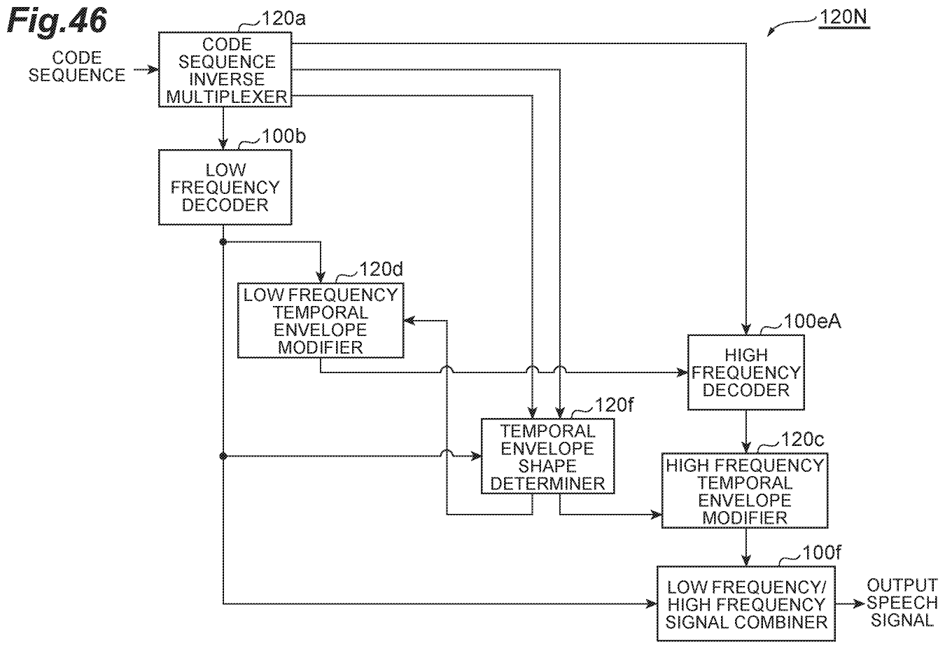

FIG. 46 is a diagram showing the configuration of a fourteenth modification 120N of the speech decoding device according to the fourth embodiment.

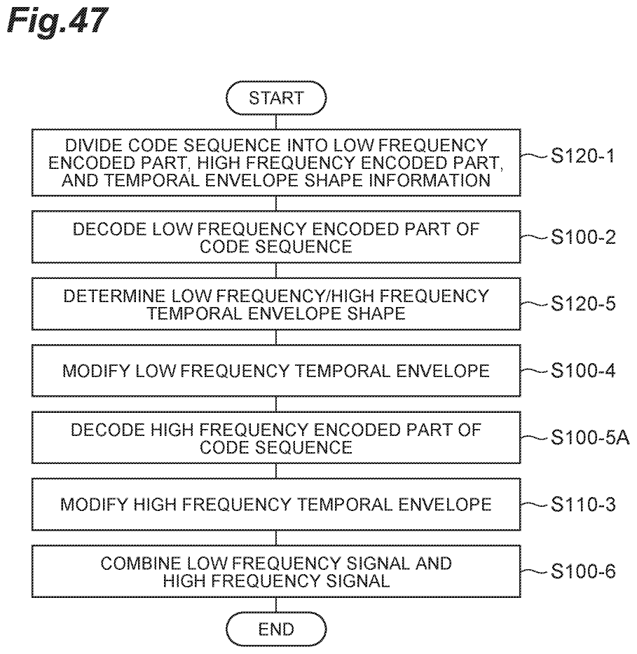

FIG. 47 is a flowchart showing the operation of the fourteenth modification 120N of the speech decoding device according to the fourth embodiment.

The present modification differs from the second modification 120B of the speech decoding device according to the fourth embodiment in that it includes a temporal envelope shape determiner 120f in place of the low frequency temporal envelope shape determiner 100c and the high frequency temporal envelope shape determiner 120b.

### Fifth Embodiment

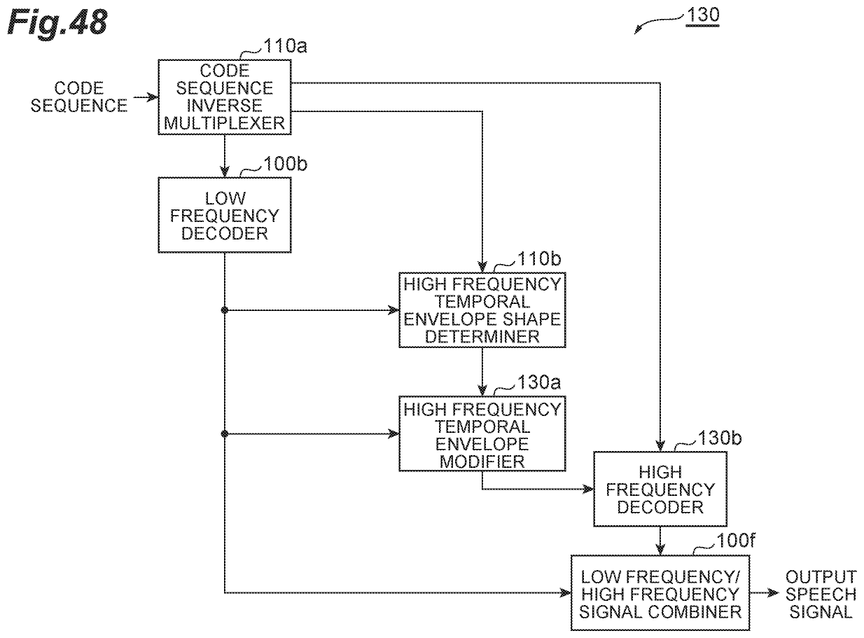

FIG. 48 is a diagram showing the configuration of a speech decoding device 130 according to a fifth embodiment. A communication device of the speech decoding device 130 receives a multiplexed code sequence output from a speech encoding device 230 described below and outputs a decoded speech signal to the outside. As shown in FIG. 48, the speech decoding device 130 functionally includes a code sequence demultiplexer 110a, a low frequency decoder 100b, a high frequency temporal envelope shape determiner 110b, a high frequency temporal envelope modifier 130a, a high frequency decoder 130b, and a low frequency/high frequency signal combiner 100f.

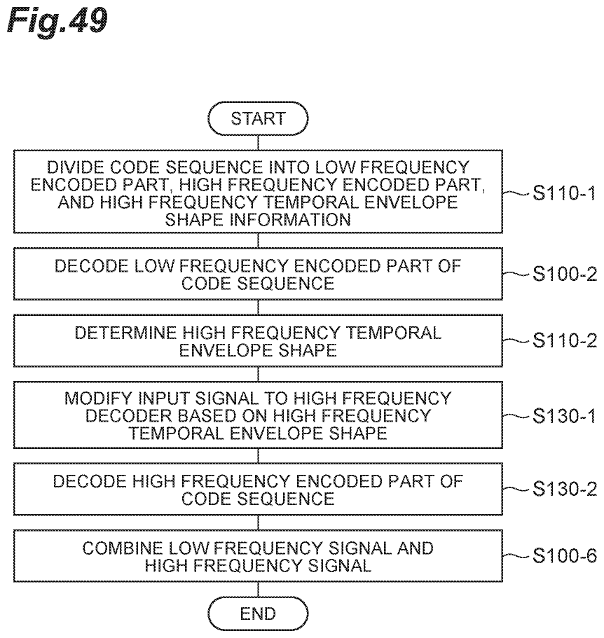

FIG. 49 is a flowchart showing the operation of the speech decoding device according to the fourth embodiment.

The high frequency temporal envelope modifier 130a modifies the shape of the temporal envelope of the low frequency signal input to the high frequency decoder 130b, based on the temporal envelope shape determined by the high frequency temporal envelope shape determiner 110b (step S130-1). The modification of the temporal envelope shape in the high frequency temporal envelope modifier 130a is performed, for example, in the process of modifying the temporal envelope shape of the decoded signal in the temporal envelope modifier 1d in which the decoded signal obtained by the speech decoder 1b is replaced with the low frequency signal obtained by the low frequency decoder 100b.

The high frequency decoder 130b decodes the high frequency encoded part divided by the code sequence demultiplexer 100a to obtain a high frequency signal (step S130-2).

The high frequency decoder 130b differs from the high frequency decoder 100e in that the low frequency signal having the temporal envelope shape modified by the high frequency temporal envelope modifier 130a is used when the low frequency decoded signal obtained by the low frequency decoder is used in decoding the high frequency signal.

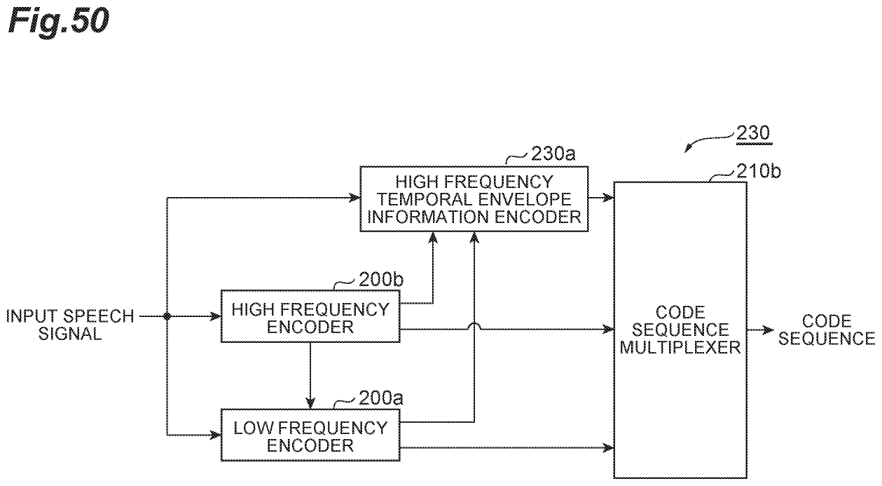

FIG. 50 is a diagram showing the configuration of the speech encoding device 230 according to the fifth embodiment. A communication device of the speech encoding device 230 receives a speech signal to be encoded from the outside and outputs the encoded code sequence to the outside. As shown in FIG. 50, the speech encoding device 230 functionally includes a low frequency encoder 200a, a high frequency encoder 200b, a high frequency temporal envelope information encoder 230a, and a code sequence multiplexer 210b.

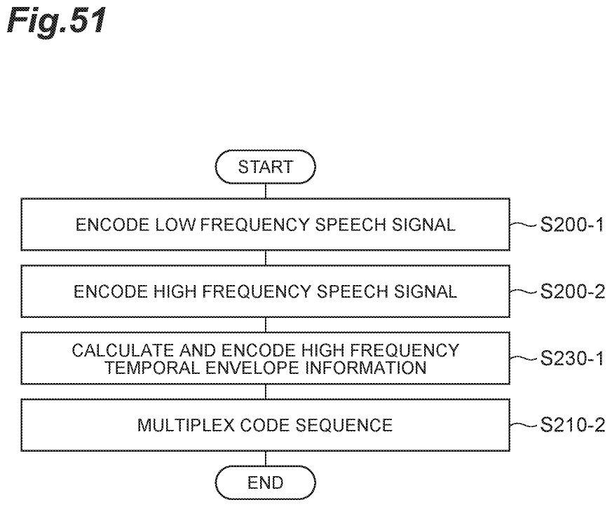

FIG. 51 is a flowchart showing the operation of the speech encoding device 230 according to the fifth embodiment.

The high frequency temporal envelope information encoder 230a calculates and encodes the high frequency temporal envelope shape information, based on at least one of the input speech signal, information obtained in the encoding process including the encoding result of the input speech signal in the low frequency encoder 200a, and information obtained in the encoding process including the encoding result of the input speech signal in the high frequency encoder 200b (step S230-1).

Calculating and encoding high frequency temporal envelope shape information can be performed, for example, in the process, by the low frequency temporal envelope information encoder 200c, of calculating and encoding the temporal envelope information on the low frequency signal. However, the process of calculating and encoding high frequency temporal envelope shape information differs from the process of calculating and encoding the temporal envelope information on the low frequency signal using the low frequency decoded signal of the input speech signal in that the information obtained in the encoding process including the encoding result of the input speech signal in the high frequency encoder 200b can be additionally used.

### Sixth Embodiment

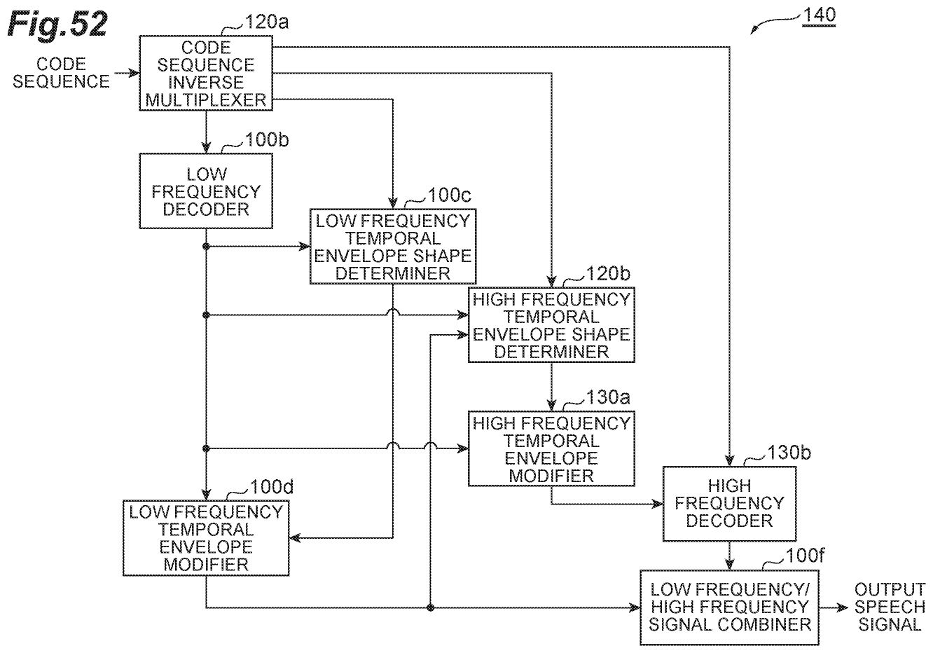

FIG. 52 is a diagram showing the configuration of a speech decoding device 140 according to a sixth embodiment. A communication device of the speech decoding device 140 receives a multiplexed code sequence output from a speech encoding device 240 described below and outputs a decoded speech signal to the outside. As shown in FIG. 52, the speech decoding device 140 functionally includes a code sequence demultiplexer 120a, a low frequency decoder 100b, a low frequency temporal envelope shape determiner 100c, a low frequency temporal envelope modifier 100d, a high frequency temporal envelope shape determiner 120b, a high frequency temporal envelope modifier 130a, a high frequency decoder 130b, and a low frequency/high frequency signal combiner 100f.

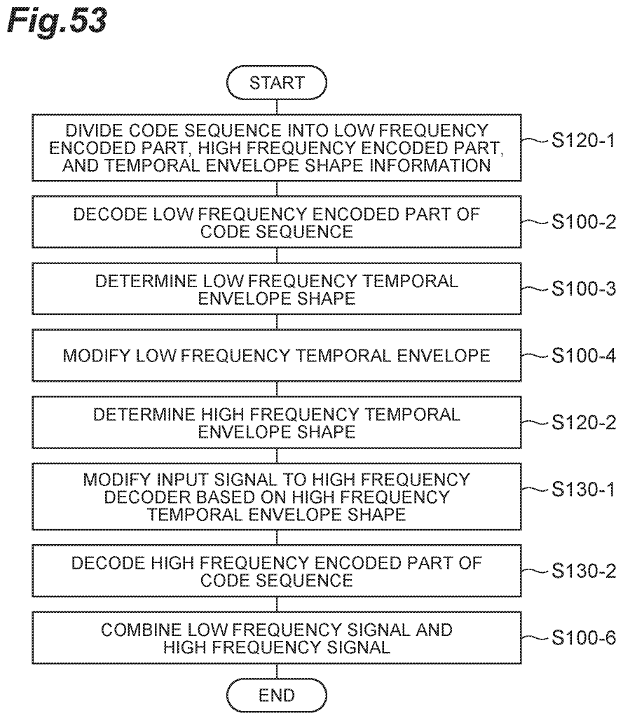

FIG. 53 is a flowchart showing the operation of the speech decoding device according to the sixth embodiment. The code sequence demultiplexer 120a and the high frequency temporal envelope shape determiner 120b perform the same operation as the code sequence demultiplexer 120a and the high frequency temporal envelope shape determiner 120b in the fourth embodiment (steps S120-1, S120-2). The high frequency temporal envelope modifier 130a and the high frequency decoder 130b perform the same operation as the high frequency temporal envelope modifier 130a and the high frequency decoder 130b in the fifth embodiment (steps S130-1, S130-2).

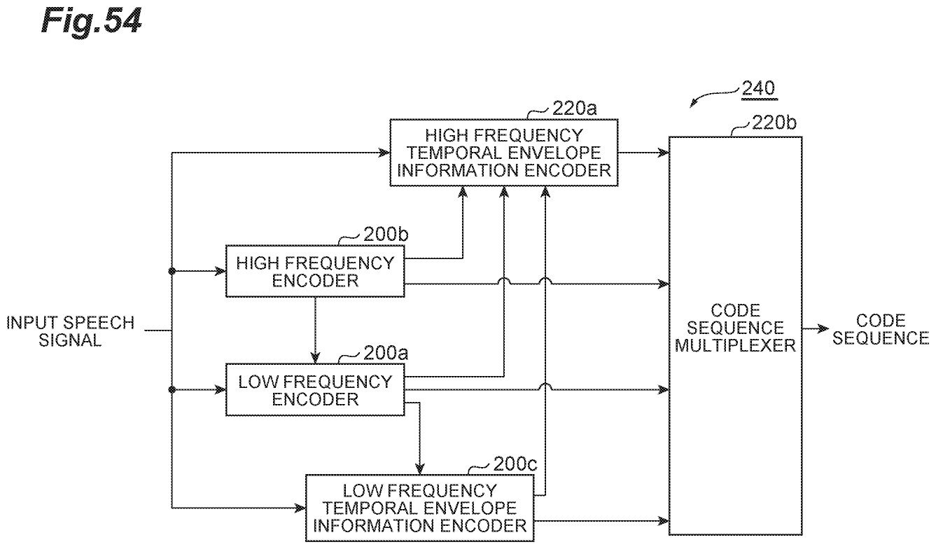

FIG. 54 is a diagram showing the configuration of the speech encoding device 240 according to the sixth embodiment. A communication device of the speech encoding device 240 receives a speech signal to be encoded from the outside and outputs the encoded code sequence to the outside. As shown in FIG. 54, the speech encoding device 240 functionally includes a low frequency encoder 200a, a high frequency encoder 200b, a low frequency temporal envelope information encoder 200c, a high frequency temporal envelope information encoder 220a, and a code sequence multiplexer 220b.

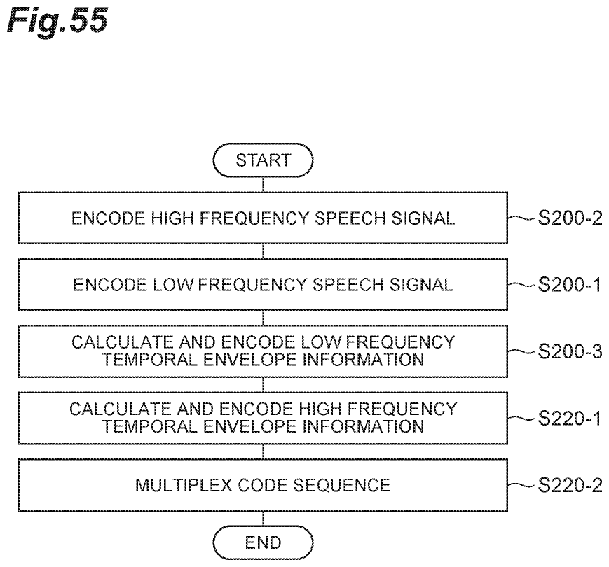

FIG. 55 is a flowchart showing the operation of the speech encoding device 240 according to the sixth embodiment.

### [First Modification of Speech Decoding Device of Sixth Embodiment]

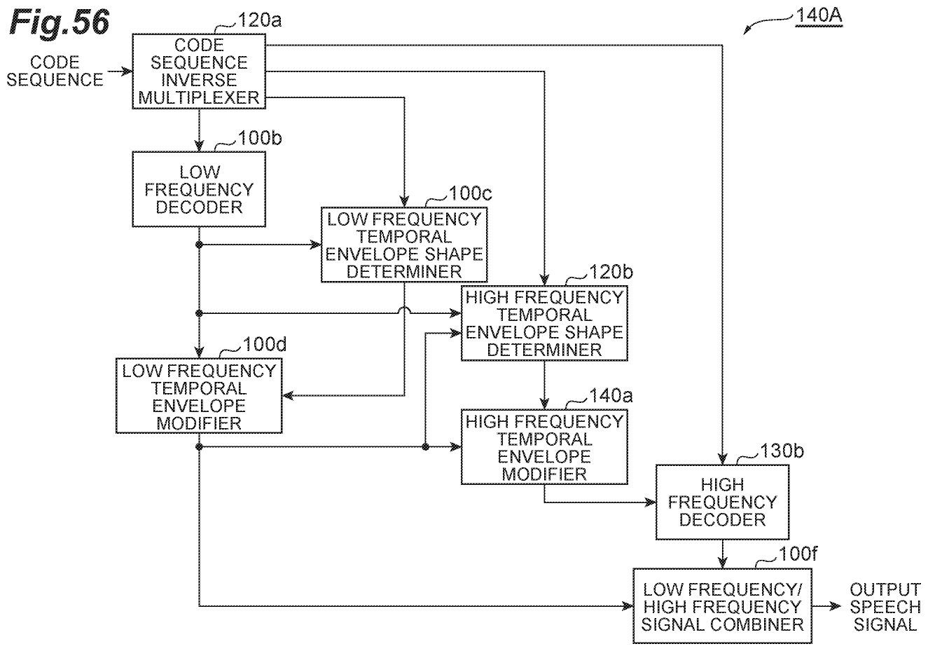

FIG. 56 is a diagram showing the configuration of a first modification 140A of the speech decoding device according to the sixth embodiment.

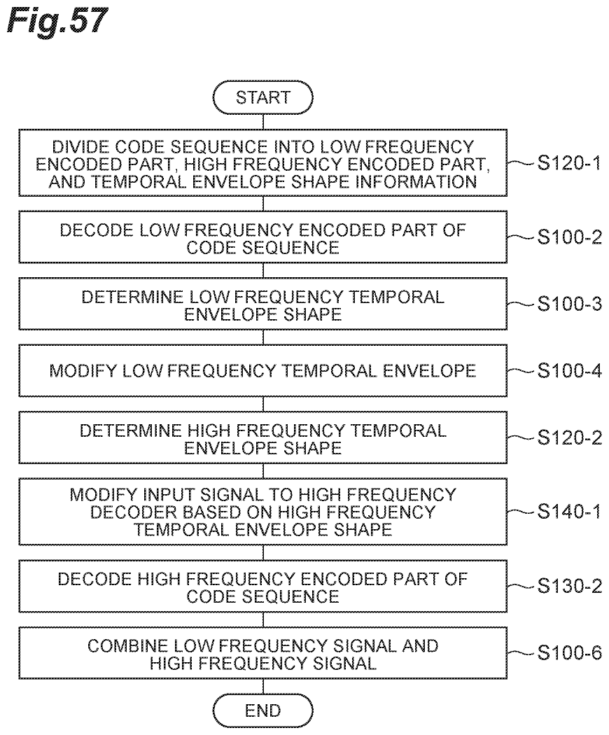

FIG. 57 is a flowchart showing the operation of the first modification 140A of the speech decoding device according to the sixth embodiment.

A high frequency temporal envelope modifier 140a modifies the shape of the temporal envelope of the low frequency signal having the temporal envelope shape modified by the low frequency temporal envelope modifier 100d, based on the temporal envelope shape determined by the high frequency temporal envelope shape determiner 120b (step S140-1). The difference from the high frequency temporal envelope modifier 130a is that the input signal is the low frequency signal having the temporal envelope shape modified by the low frequency temporal envelope modifier 100d.

### [Second Modification of Speech Decoding Device of Sixth Embodiment]

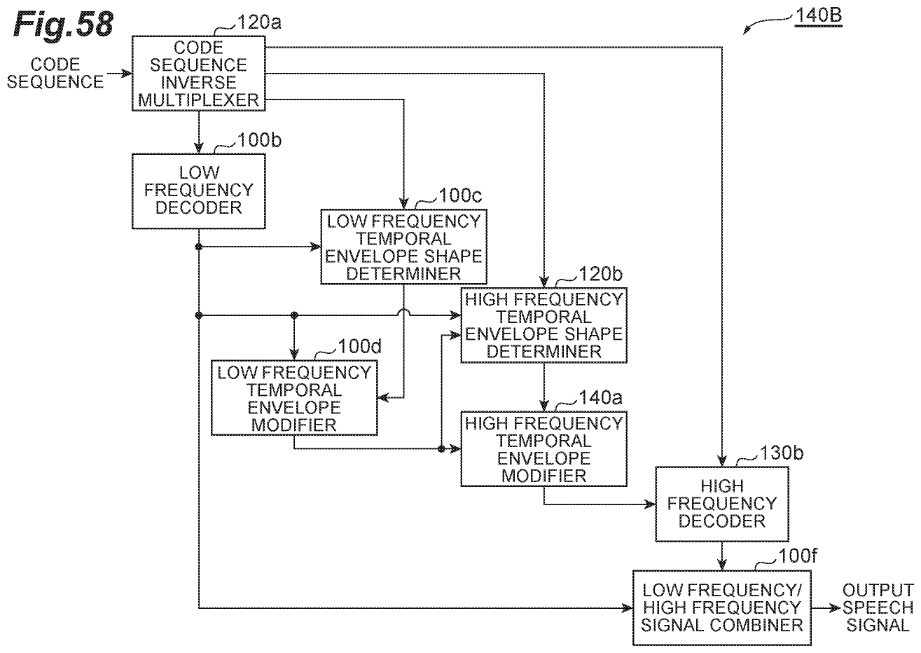

FIG. 58 is a diagram showing the configuration of a second modification 140B of the speech encoding device according to the sixth embodiment.

The difference from the first modification of the speech decoding device in the present embodiment is that the low frequency signal to be used in the combining process by the low frequency/high frequency signal combiner 100f is not the low frequency signal having the temporal envelope shape modified by the low frequency temporal envelope modifier 100d but the low frequency signal decoded by the low frequency decoder 100b.

### [Third Modification of Speech Decoding Device of Sixth Embodiment]

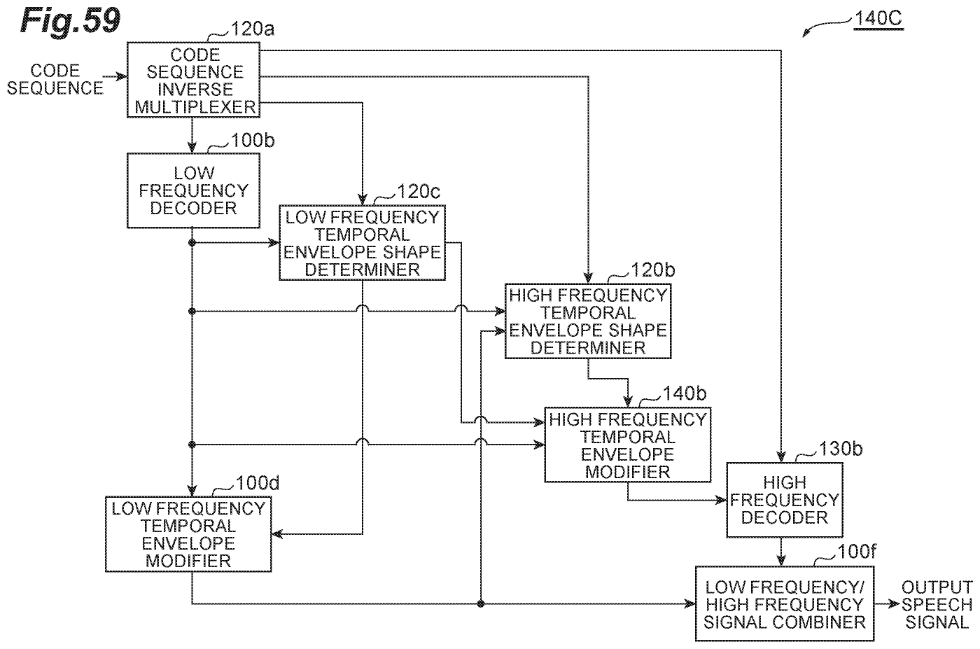

FIG. 59 is a diagram showing the configuration of a third modification 140C of the speech decoding device according to the sixth embodiment.

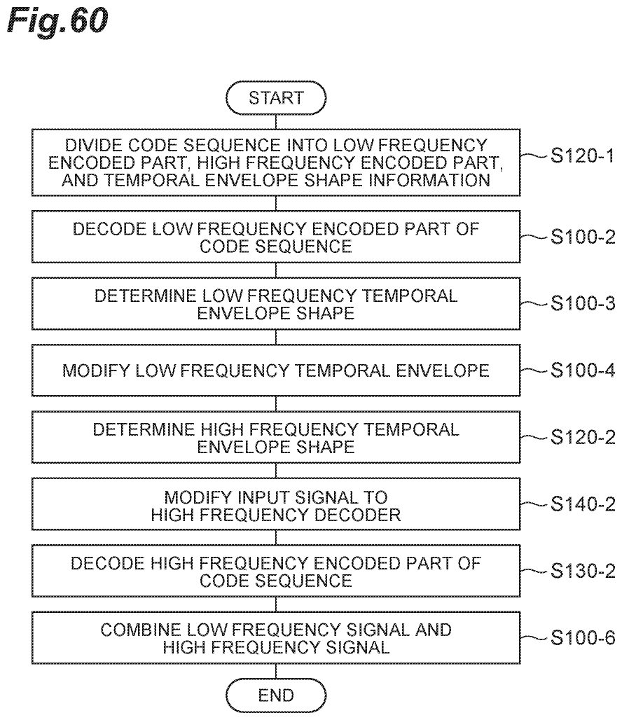

FIG. 60 is a flowchart showing the operation of the third modification 140C of the speech decoding device according to the sixth embodiment.

The present modification differs from the speech decoding device 140 according to the sixth embodiment in that it includes a low frequency temporal envelope shape determiner 120c and a high frequency temporal envelope modifier 140b in place of the low frequency temporal envelope shape determiner 100c and the high frequency temporal envelope modifier 130a.

The high frequency temporal envelope modifier 140b differs from the high frequency temporal envelope modifier 130a in that the shape of the temporal envelope of the low frequency signal input to the high frequency decoder 130b is modified based on at least one of the temporal envelope shape determined by the high frequency temporal envelope shape determiner 120b and the temporal envelope shape determined by the low frequency temporal envelope shape determiner 120c (S140-2).

For example, if the low frequency temporal envelope shape determiner 120c determines that the temporal envelope shape is flat, the temporal envelope of the low frequency signal input to the high frequency decoder 130b is modified into a flat shape, irrespective of the temporal envelope shape determined by the high frequency temporal envelope shape determiner 120b. For example, if the low frequency temporal envelope shape determiner 120c determines that the temporal envelope shape is not flat, the temporal envelope of the low frequency signal input to the high frequency decoder 130b is not modified into a flat shape, irrespective of the temporal envelope shape determined by the high frequency temporal envelope shape determiner 120b. This is applicable to the cases of onset and offset and is not limited to any specific temporal envelope shape.

### [Fourth Modification of Speech Decoding Device of Sixth Embodiment]

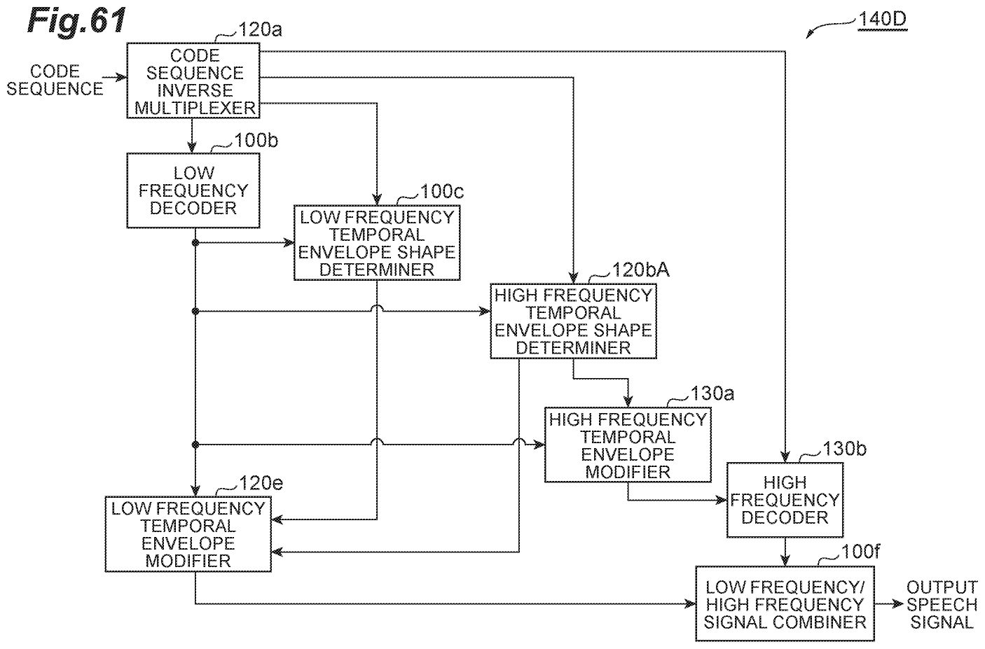

FIG. 61 is a diagram showing the configuration of a fourth modification 140D of the speech decoding device according to the sixth embodiment.

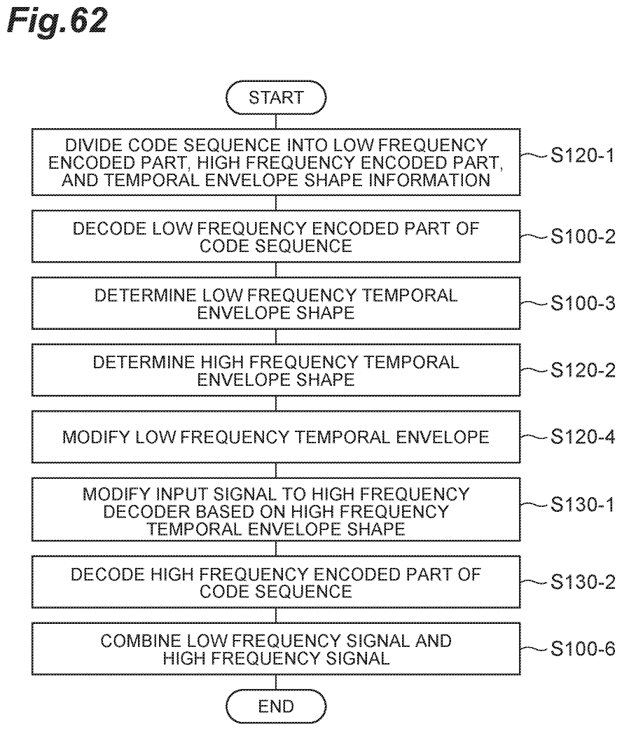

FIG. 62 is a flowchart showing the operation of the fourth modification 140D of the speech decoding device according to the sixth embodiment.

The present modification differs from the speech decoding device 140 according to the sixth embodiment in that it includes a high frequency temporal envelope shape determiner 120bA and a low frequency temporal envelope modifier 120e in place of the high frequency temporal envelope shape determiner 120b and the low frequency temporal envelope modifier 100d.

### [Fifth Modification of Speech Decoding Device of Sixth Embodiment]

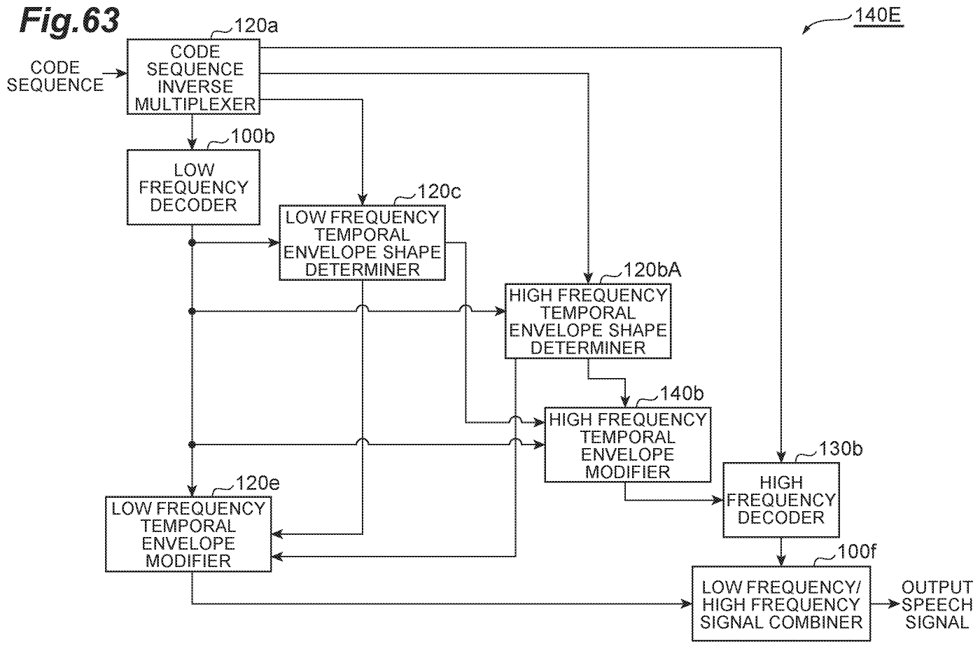

FIG. 63 is a diagram showing the configuration of a fifth modification 140E of the speech decoding device according to the sixth embodiment.

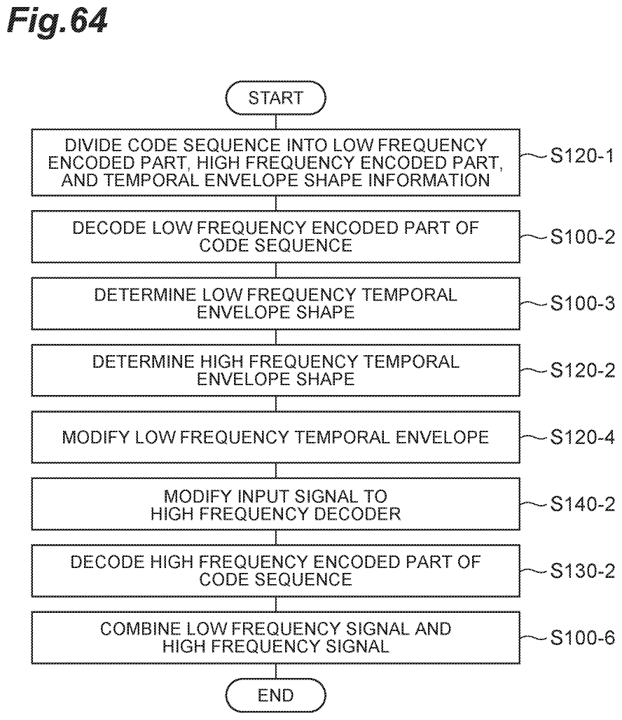

FIG. 64 is a flowchart showing the operation of the fifth modification 140E of the speech decoding device according to the sixth embodiment.

The present modification includes the low frequency temporal envelope shape determiner 120c, the high frequency temporal envelope modifier 140b, the high frequency temporal envelope shape determiner 120bA, and the low frequency temporal envelope modifier 120e.

### [Sixth Modification of Speech Decoding Device of Sixth Embodiment]

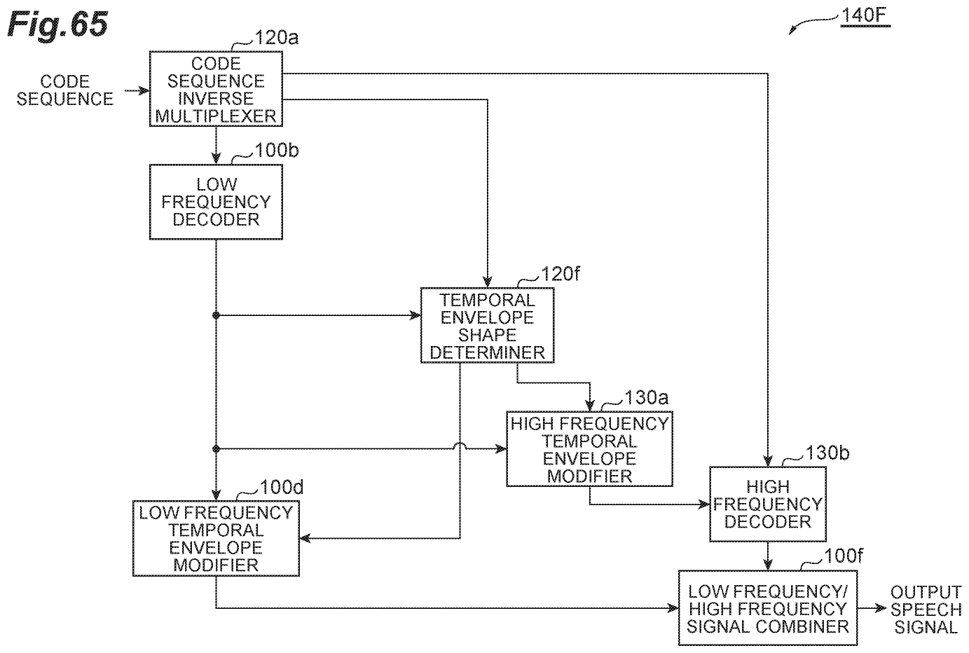

FIG. 65 is a diagram showing the configuration of a sixth modification 140F of the speech decoding device according to the sixth embodiment.

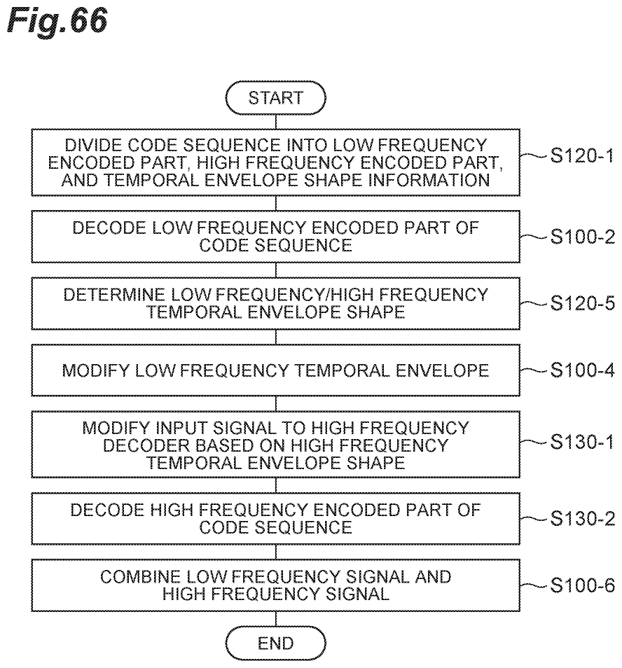

FIG. 66 is a flowchart showing the operation of the sixth modification 140F of the speech decoding device according to the sixth embodiment.

The present modification differs from the speech decoding device 140 according to the sixth embodiment in that it includes a temporal envelope shape determiner 120f in place of the low frequency temporal envelope shape determiner 100c and the high frequency temporal envelope shape determiner 120b.

### [Seventh Modification of Speech Decoding Device of Sixth Embodiment]

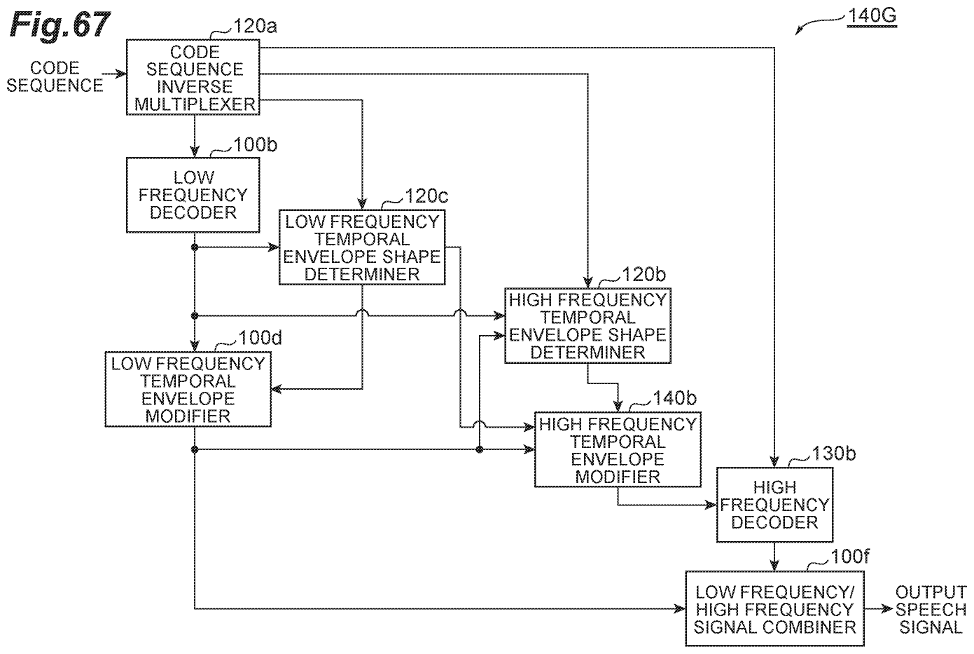

FIG. 67 is a diagram showing the configuration of a seventh modification 140G of the speech decoding device according to the sixth embodiment.

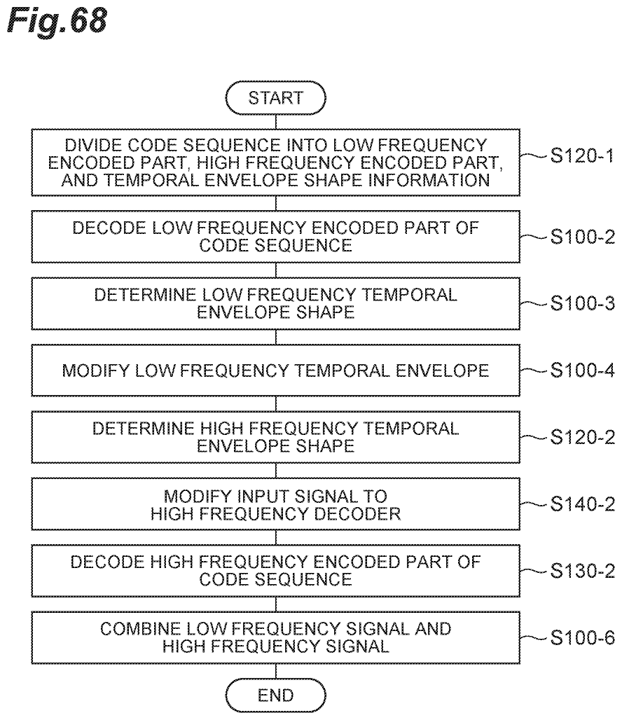

FIG. 68 is a flowchart showing the operation of the seventh modification 140G of the speech decoding device according to the sixth embodiment.

The present modification differs from the first modification 140A of the speech decoding device according to the sixth embodiment in that it includes a low frequency temporal envelope shape determiner 120c and a high frequency temporal envelope modifier 140b in place of the low frequency temporal envelope shape determiner 100c and the high frequency temporal envelope modifier 140a.

In the present modification, the high frequency temporal envelope modifier 140b modifies the shape of the temporal envelope of the low frequency signal having the temporal envelope shape modified to be input to the high frequency decoder 130b, based on at least one of the temporal envelope shape determined by the high frequency temporal envelope shape determiner 120b and the temporal envelope shape determined by the low frequency temporal envelope shape determiner 120c (S140-2).

### [Eighth Modification of Speech Decoding Device of Sixth Embodiment]

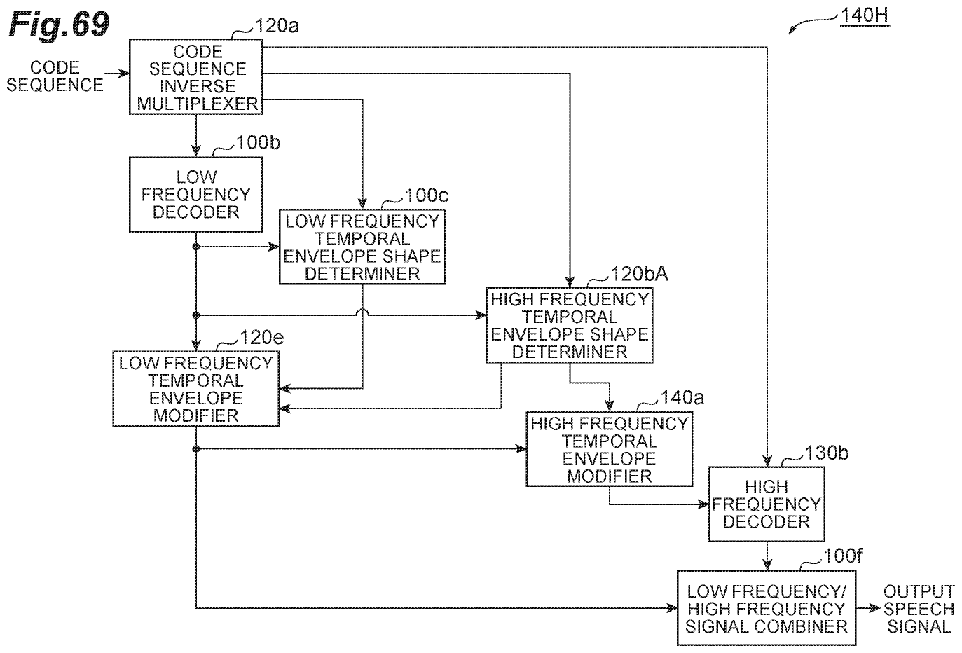

FIG. 69 is a diagram showing the configuration of an eighth modification 140H of the speech decoding device according to the sixth embodiment.

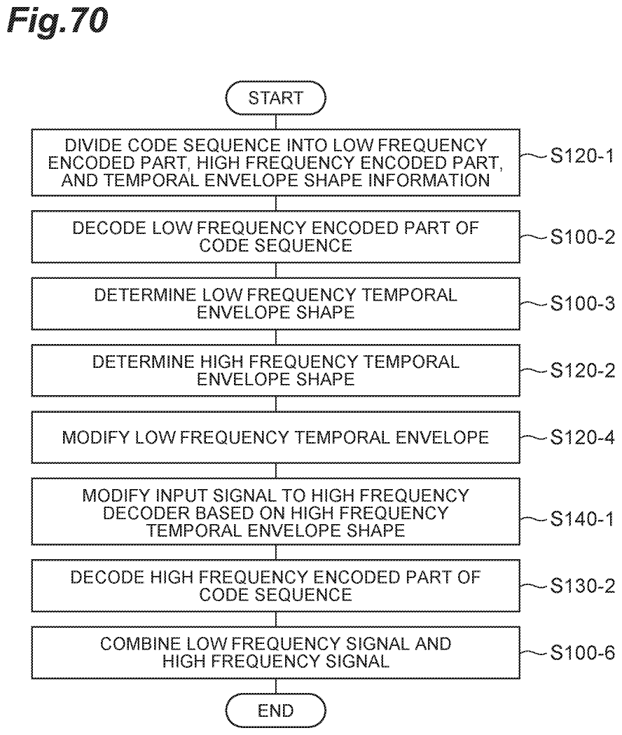

FIG. 70 is a flowchart showing the operation of the eighth modification 140H of the speech decoding device according to the sixth embodiment.

The present modification differs from the first modification 140A of the speech decoding device according to the sixth embodiment in that it includes a high frequency temporal envelope shape determiner 120bA and a low frequency temporal envelope modifier 120e in place of the high frequency temporal envelope shape determiner 120b and the low frequency temporal envelope modifier 100d.

### [Ninth Modification of Speech Decoding Device of Sixth Embodiment]

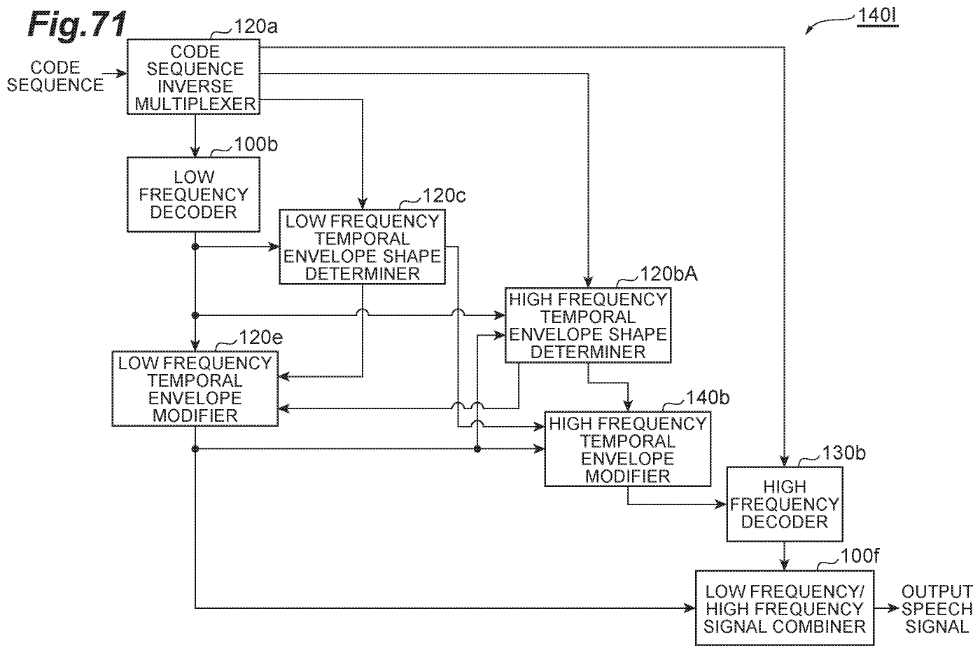

FIG. 71 is a diagram showing the configuration of a ninth modification 140I of the speech decoding device according to the sixth embodiment.

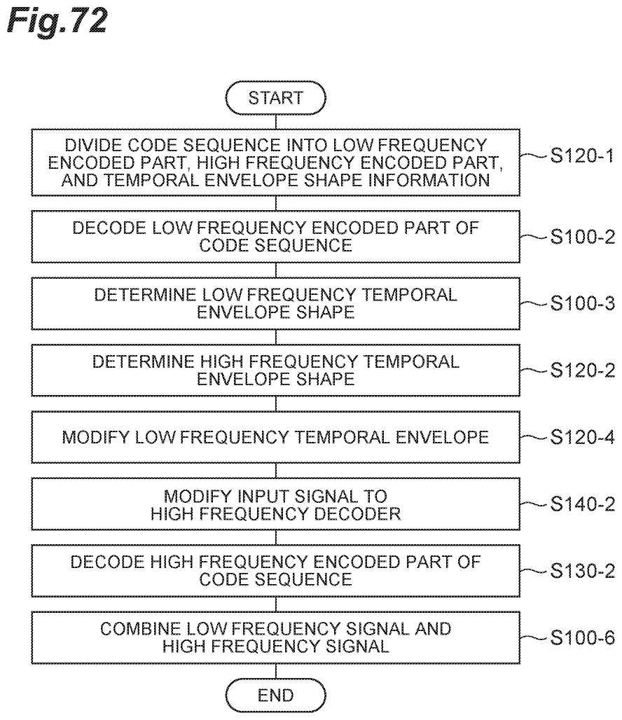

FIG. 72 is a flowchart showing the operation of the ninth modification 140I of the speech decoding device according to the sixth embodiment.

The present modification includes the low frequency temporal envelope shape determiner 120c, the high frequency temporal envelope modifier 140b, the high frequency temporal envelope shape determiner 120bA, and the low frequency temporal envelope modifier 120e.

### [Tenth Modification of Speech Decoding Device of Sixth Embodiment]

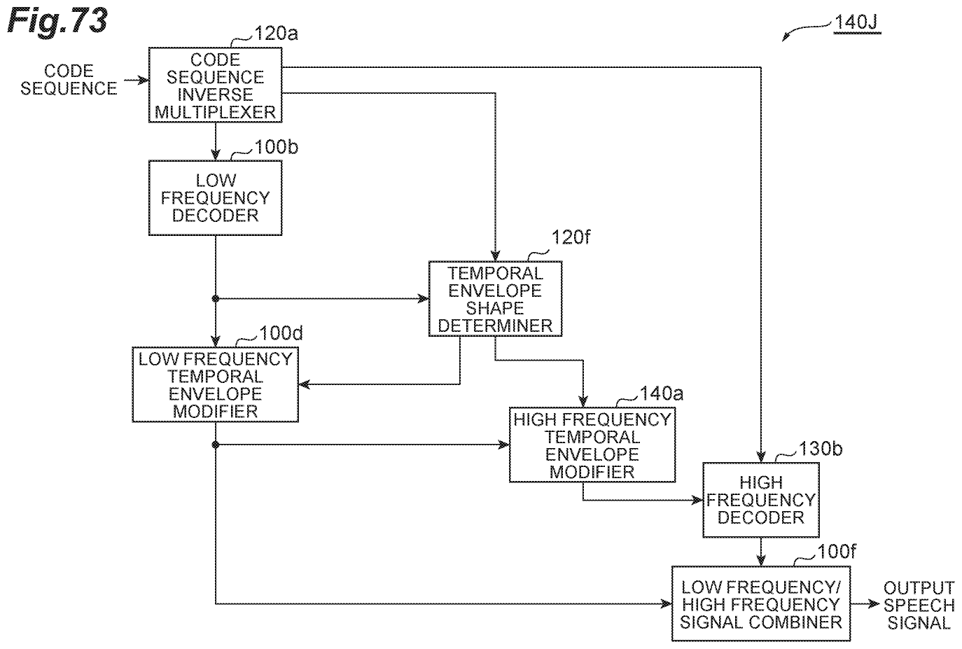

FIG. 73 is a diagram showing the configuration of a tenth modification 140J of the speech decoding device according to the sixth embodiment.

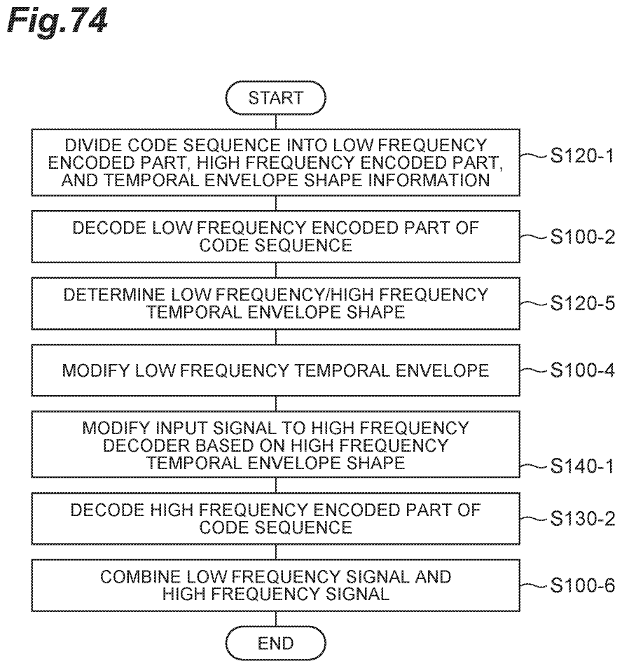

FIG. 74 is a flowchart showing the operation of the tenth modification 140J of the speech decoding device according to the sixth embodiment.

The present modification differs from the first modification 140A of the speech decoding device according to the sixth embodiment in that it includes a temporal envelope shape determiner 120f in place of the low frequency temporal envelope shape determiner 100c and the high frequency temporal envelope shape determiner 120b.

### [Eleventh Modification of Speech Decoding Device of Sixth Embodiment]

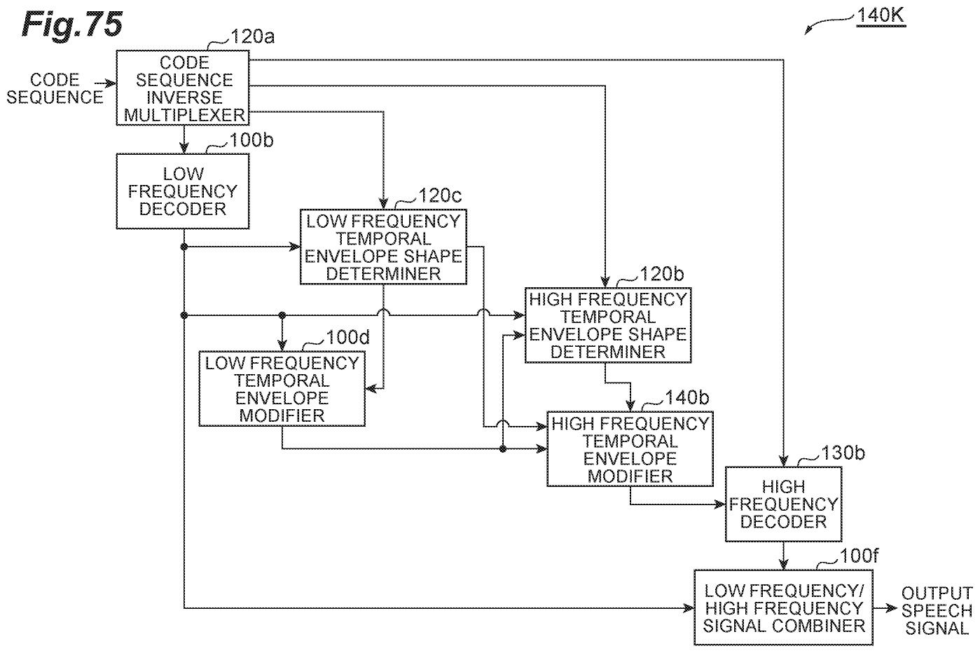

FIG. 75 is a diagram showing the configuration of an eleventh modification 140K of the speech decoding device according to the sixth embodiment.

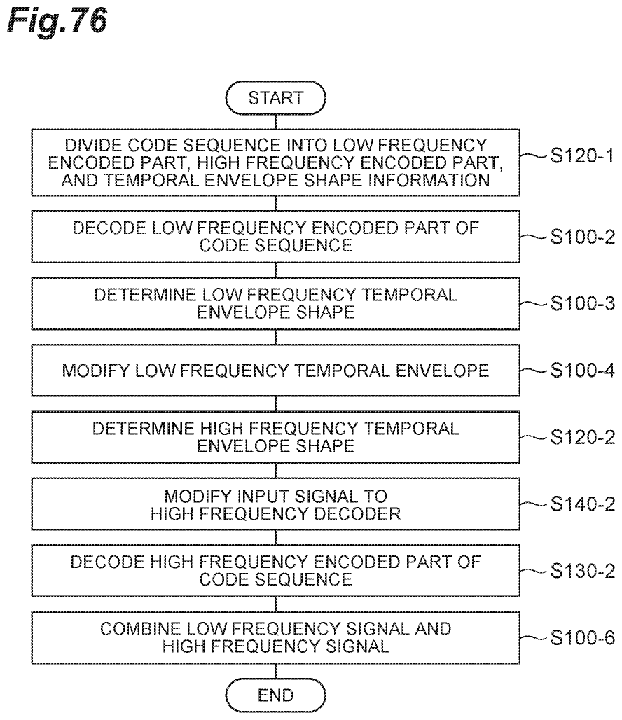

FIG. 76 is a flowchart showing the operation of the eleventh modification 140K of the speech decoding device according to the sixth embodiment.

The present modification differs from the second modification 140B of the speech decoding device according to the sixth embodiment in that it includes a low frequency temporal envelope shape determiner 120c and a high frequency temporal envelope modifier 140b in place of the low frequency temporal envelope shape determiner 100c and the high frequency temporal envelope modifier 140a.

### [Twelfth Modification of Speech Decoding Device of Sixth Embodiment]

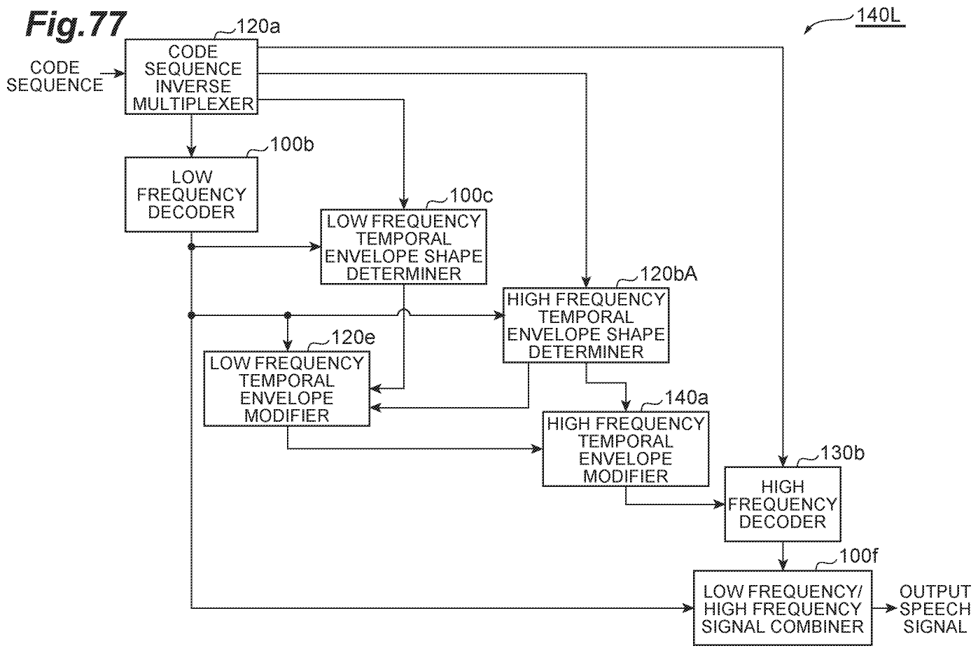

FIG. 77 is a diagram showing the configuration of a twelfth modification 140L of the speech decoding device according to the sixth embodiment.

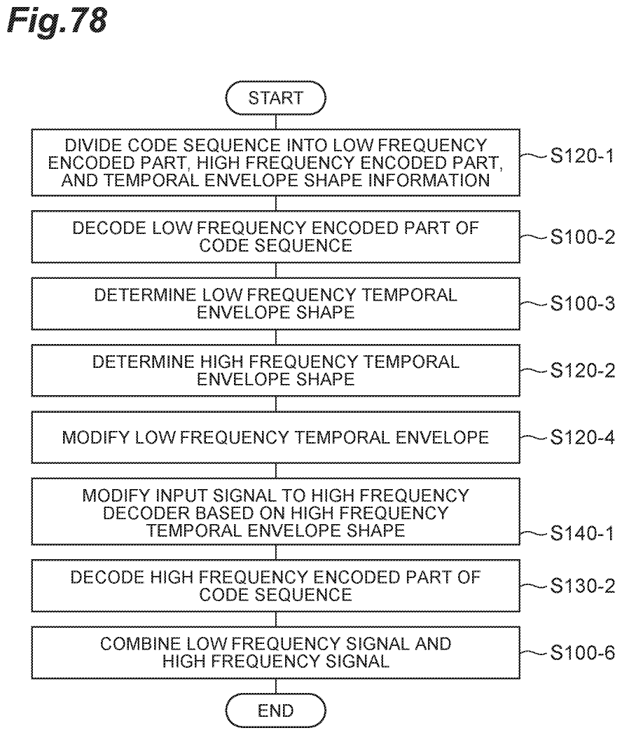

FIG. 78 is a flowchart showing the operation of the twelfth modification 140L of the speech decoding device according to the sixth embodiment.

The present modification differs from the second modification 140B of the speech decoding device according to the sixth embodiment in that it includes a high frequency temporal envelope shape determiner 120bA and a low frequency temporal envelope modifier 120e in place of the high frequency temporal envelope shape determiner 120b and the low frequency temporal envelope modifier 100d.

### [Thirteenth Modification of Speech Decoding Device of Sixth Embodiment]

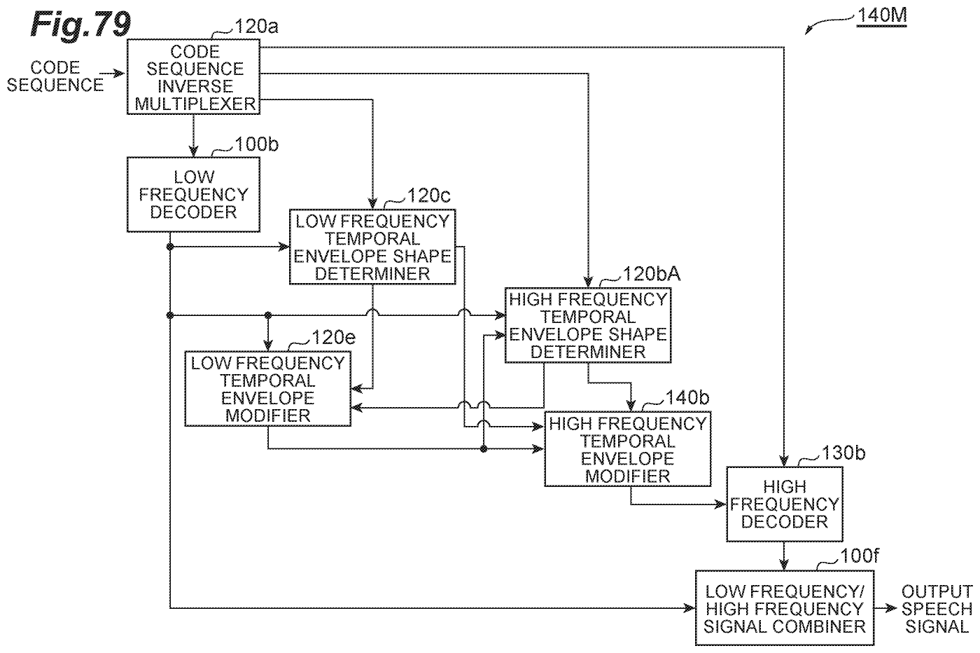

FIG. 79 is a diagram showing the configuration of a thirteenth modification 140M of the speech decoding device according to the sixth embodiment.

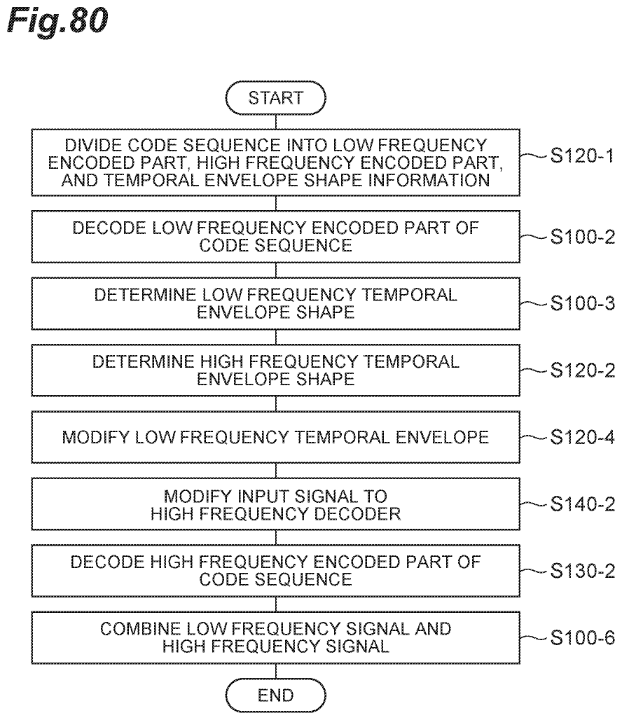

FIG. 80 is a flowchart showing the operation of the thirteenth modification 140M of the speech decoding device according to the sixth embodiment.

The present modification includes the low frequency temporal envelope shape determiner 120c, the high frequency temporal envelope modifier 140b, the high frequency temporal envelope shape determiner 120bA, and the low frequency temporal envelope modifier 120e.

### [Fourteenth Modification of Speech Decoding Device of Sixth Embodiment]

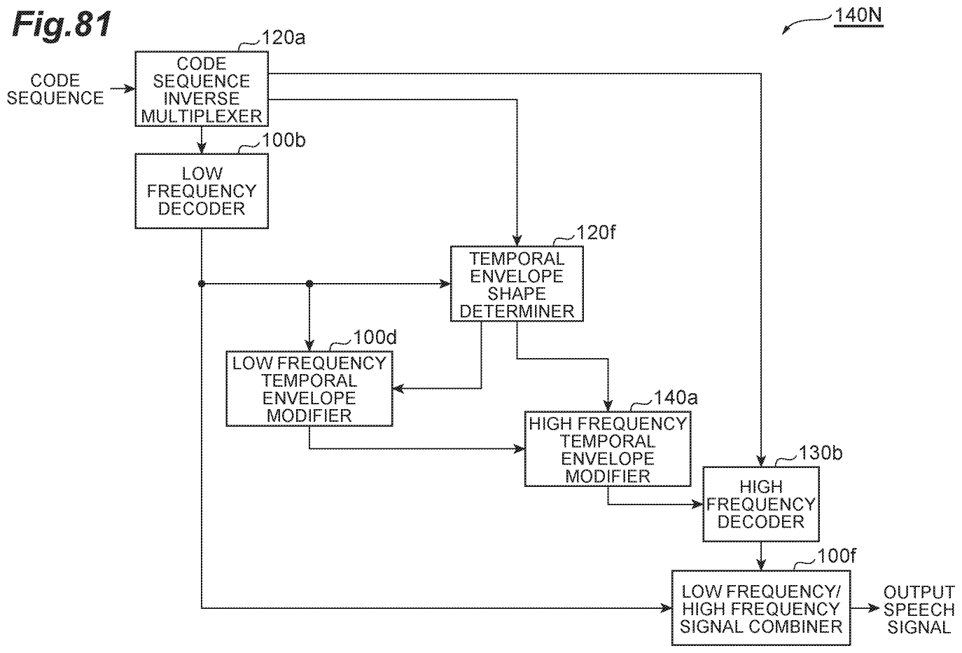

FIG. 81 is a diagram showing the configuration of a fourteenth modification 140N of the speech decoding device according to the sixth embodiment.

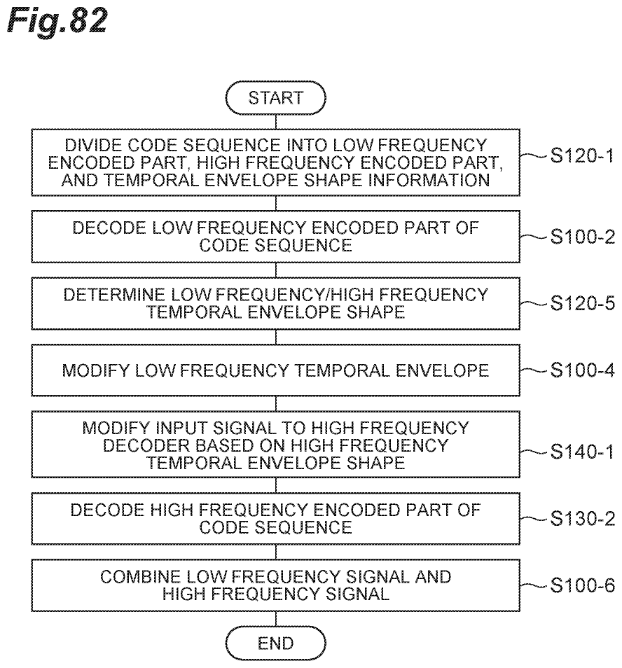

FIG. 82 is a flowchart showing the operation of the fourteenth modification 140N of the speech decoding device according to the sixth embodiment.

The present modification differs from the second modification 140B of the speech decoding device according to the sixth embodiment in that it includes a temporal envelope shape determiner 120f in place of the low frequency temporal envelope shape determiner 100c and the high frequency temporal envelope shape determiner 120b.

### Seventh Embodiment

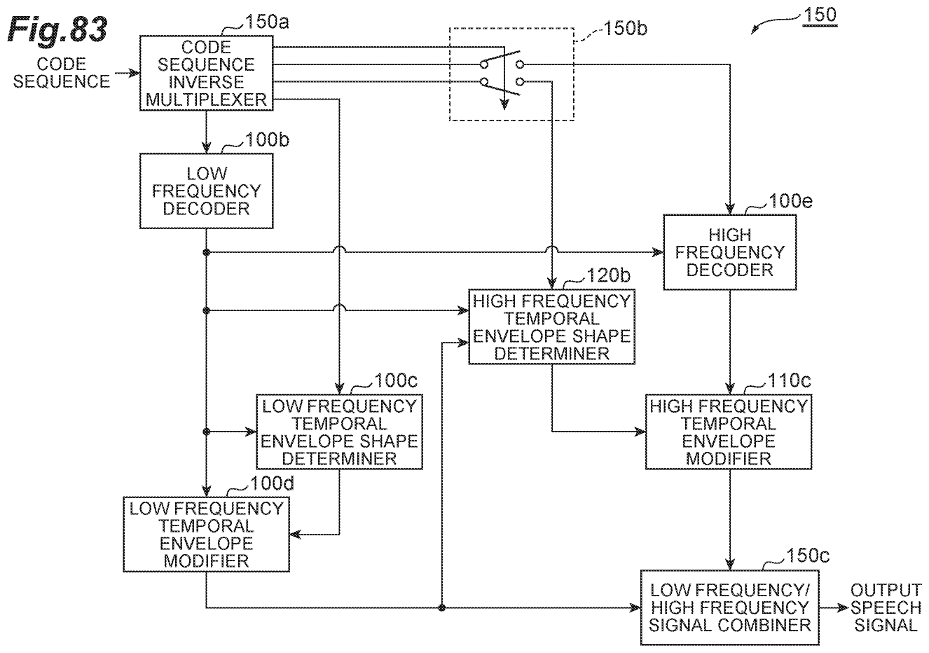

FIG. 83 is a diagram showing the configuration of a speech decoding device 150 according to a seventh embodiment. A communication device of the speech decoding device 150 receives a multiplexed code sequence output from a speech encoding device 250 described below and outputs a decoded speech signal to the outside. As shown in FIG. 83, the speech decoding device 150 functionally includes a code sequence demultiplexer 150a, switches 150b, a low frequency decoder 100b, a low frequency temporal envelope shape determiner 100c, a low frequency temporal envelope modifier 100d, a high frequency decoder 100e, a high frequency temporal envelope shape determiner 120b, a high frequency temporal envelope modifier 110c, and a low frequency/high frequency signal combiner 150c.

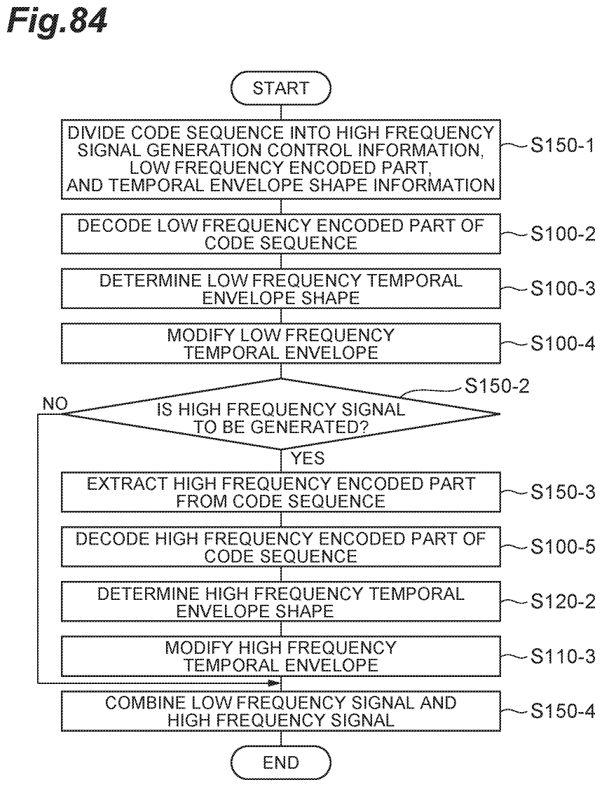

FIG. 84 is a flowchart showing the operation of the speech decoding device according to the seventh embodiment.

The code sequence demultiplexer 150a divides a code sequence into high frequency signal generation control information, a low frequency encoded part, and information about the temporal envelope shape (step S150-1).

It is determined whether to generate a high frequency signal, based on the high frequency signal generation control information obtained in the code sequence demultiplexer 150a (step S150-2).

If a high frequency signal is to be generated, the code sequence demultiplexer 150a extracts a high frequency encoded part from the code sequence (step S150-3). A high frequency signal is then generated using the high frequency encoded part of the code sequence, the temporal envelope shape of the high frequency signal is determined, and the temporal envelope shape of the high frequency signal is modified.

The order in which the processing in step S150-2 and S150-3 is performed is not limited to the order illustrated in the flowchart in FIG. 84 as long as it is before the determination of the high frequency temporal envelope shape and the decoding of the high frequency encoded part.

If it is determined to generate a high frequency signal based on the high frequency signal generation information, the low frequency/high frequency signal combiner 150c synthesizes an output speech signal from the low frequency signal whose temporal envelope shape is modified and the high frequency signal whose temporal envelope shape is modified. If it is determined not to generate a high frequency signal based on the high frequency signal generation information, the low frequency/high frequency signal combiner 150c synthesizes an output speech signal from the low frequency signal whose temporal envelope shape is modified (step S150-4). However, even when it is determined not to generate a high frequency signal, if the low frequency signal, whose temporal envelope shape is modified, is input in a state ready for output to low frequency/high frequency signal combiner 150c, the input low frequency signal can be optionally output as it is.

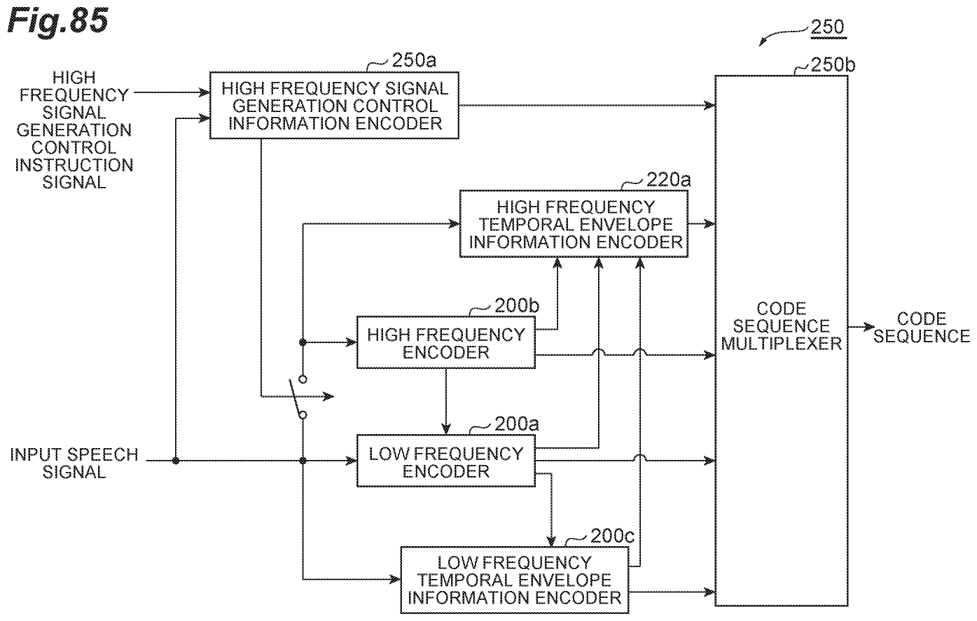

FIG. 85 is a diagram showing the configuration of the speech encoding device 250 according to the seventh embodiment. A communication device of the speech encoding device 250 receives a speech signal to be encoded from the outside and outputs the encoded code sequence to the outside. As shown in FIG. 85, the speech encoding device 250 functionally includes a high frequency signal generation control information encoder 250a, a low frequency encoder 200a, a high frequency encoder 200b, a low frequency temporal envelope information encoder 200c, a high frequency temporal envelope information encoder 220a, and a code sequence multiplexer 250b.

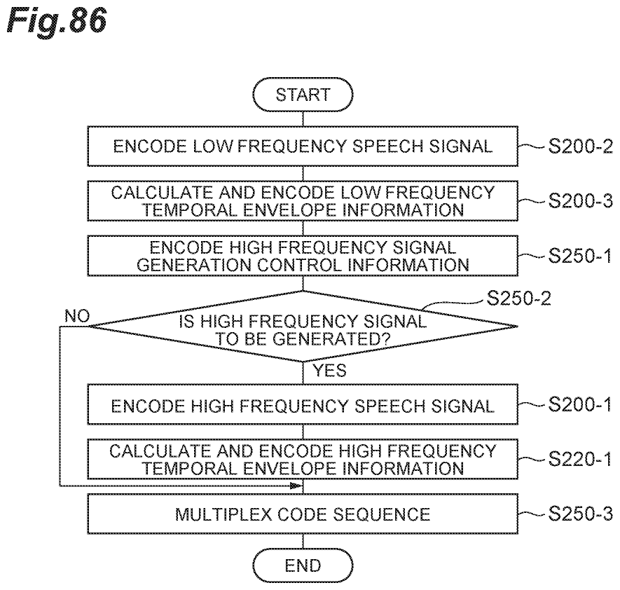

FIG. 86 is a flowchart showing the operation of the speech encoding device 250 according to the seventh embodiment.

The high frequency signal generation control information encoder 250a determines whether to generate a high frequency signal based on at least one of an input speech signal and a high frequency signal generation control instruction signal and encodes high frequency signal generation control information (step S250-1). For example, if the input speech signal includes a signal in a frequency band to be encoded by the high frequency encoder 200b, it can be determined to generate a high frequency signal. For example, if the high frequency signal generation control instruction signal instructs to generate a high frequency signal, it can be determined to generate a high frequency signal. For example, these two methods can be combined, and, for example, if at least one of these two methods decides to generate a high frequency signal, it can be determined to generate a high frequency signal.

The high frequency signal generation control information can be encoded, for example, by one bit representing whether to generate a high frequency signal.

The method of determining whether to generate a high frequency signal and the method of encoding the high frequency signal generation control information are not limited.

If the high frequency signal generation control information encoder 250a determines to generate a high frequency signal, the high frequency encoder 200b encodes a high frequency signal corresponding to the high frequency component of the input speech signal, and the high frequency temporal envelope information encoder 220a calculates and encodes high frequency temporal envelope shape information. By contrast, if the high frequency signal generation control information encoder 250a determines not to generate a high frequency signal, the encoding of the high frequency signal and the calculation and encoding of high frequency temporal envelope shape information are not carried out (step S250-2).

The code sequence multiplexer 250c receives the encoded high frequency signal generation control information from the high frequency signal generation control information encoder 250a, receives the code sequence of the low frequency speech signal from the low frequency encoder 200a, receives the encoded low frequency temporal envelope shape information from the low frequency temporal envelope information encoder 200c, additionally receives the code sequence of the high frequency speech signal from the high frequency encoder 200b and the encoded high frequency temporal envelope shape information from the high frequency temporal envelope information encoder 210a if the high frequency signal generation control information encoder 250a determines to generate a high frequency signal, and outputs a multiplexed code sequence (step S250-3).

If the high frequency signal generation control information encoder 250a determines to generate a high frequency signal, when encoding of the information about the low frequency temporal envelope shape and the information about the high frequency temporal envelope shape, for example, separately encoded information about the low frequency temporal envelope shape and information about the high frequency temporal envelope shape may be received, or unitedly encoded information about the low frequency temporal envelope shape and information about the high frequency temporal envelope shape may be received. For example, information about the low frequency temporal envelope shape and information about the high frequency temporal envelope shape, both being represented by a single piece of information and encoded, may be received.

### [First Modification of Speech Decoding Device of Seventh Embodiment]

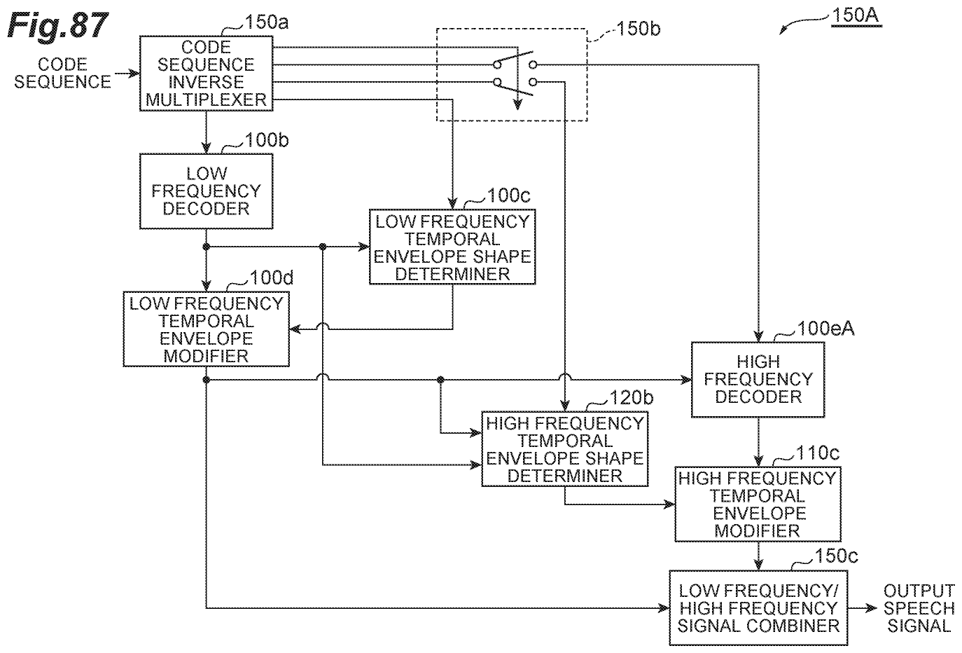

FIG. 87 is a diagram showing the configuration of a first modification 150A of the speech decoding device according to the seventh embodiment.

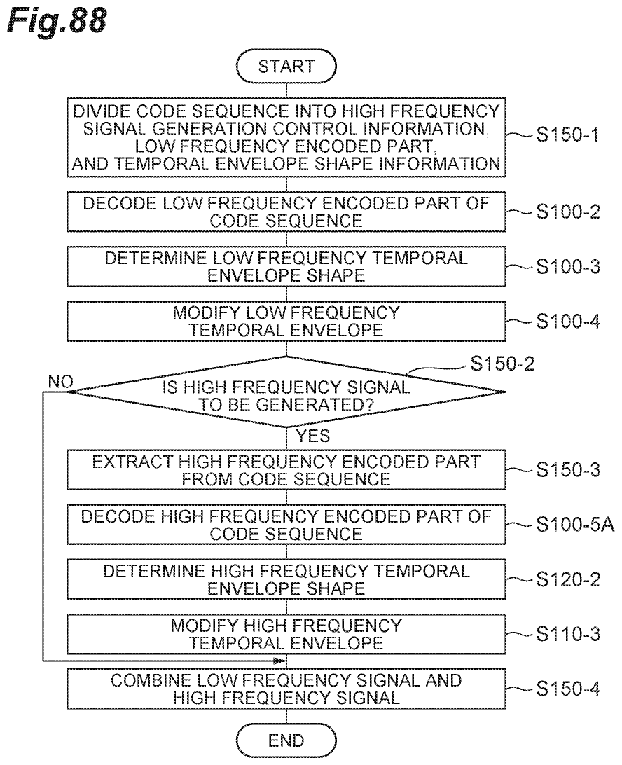

FIG. 88 is a flowchart showing the operation of the first modification 150A of the speech decoding device according to the seventh embodiment. The difference from the speech decoding device 150 in the seventh embodiment is that the low frequency signal having the temporal envelope shape modified by the low frequency temporal envelope modifier 100d is used in decoding a high frequency signal by the high frequency decoder 100eA. In step 100-5A in FIG. 88, when the low frequency decoded signal obtained by the low frequency decoder 100b is used in decoding a high frequency signal, the low frequency signal having the temporal envelope shape modified by the low frequency temporal envelope modifier 100d is used.

The order in which the processing in step S150-2 and S150-3 is performed is not limited to the order illustrated in the flowchart in FIG. 88 as long as it is before the determination of the high frequency temporal envelope shape and the decoding of the high frequency encoded part.

### [Second Modification of Speech Decoding Device of Seventh Embodiment]

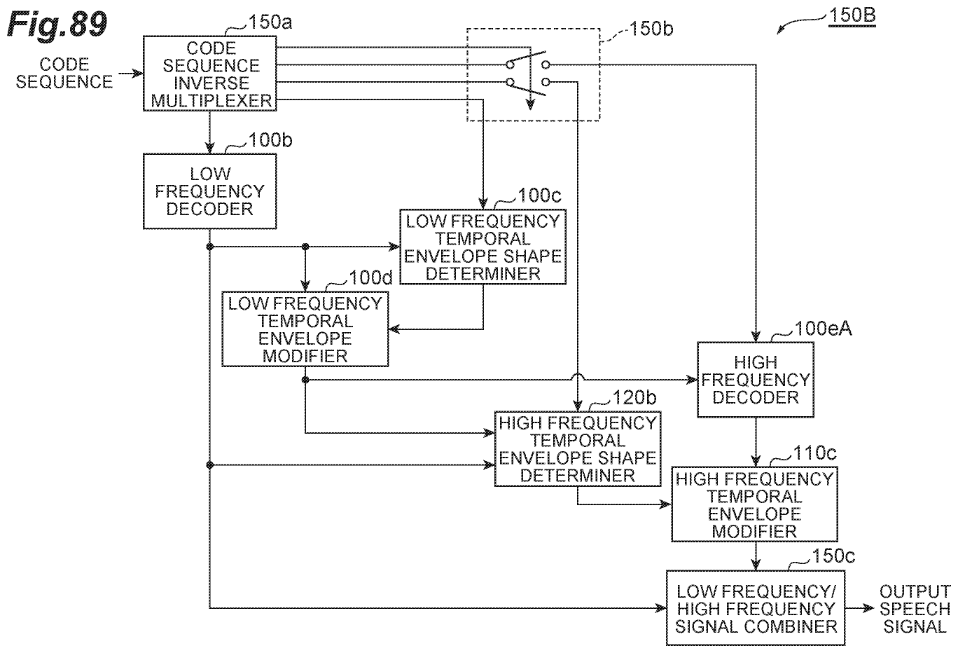

FIG. 89 is a diagram showing the configuration of a second modification 150B of the speech decoding device according to the seventh embodiment. The difference from the first modification of the speech decoding device in the seventh embodiment is that the low frequency signal input to the low frequency/high frequency signal combiner 150c is not output from the low frequency temporal envelope modifier 100d but output from the low frequency decoder 100b.

### [Third Modification of Speech Decoding Device of Seventh Embodiment]

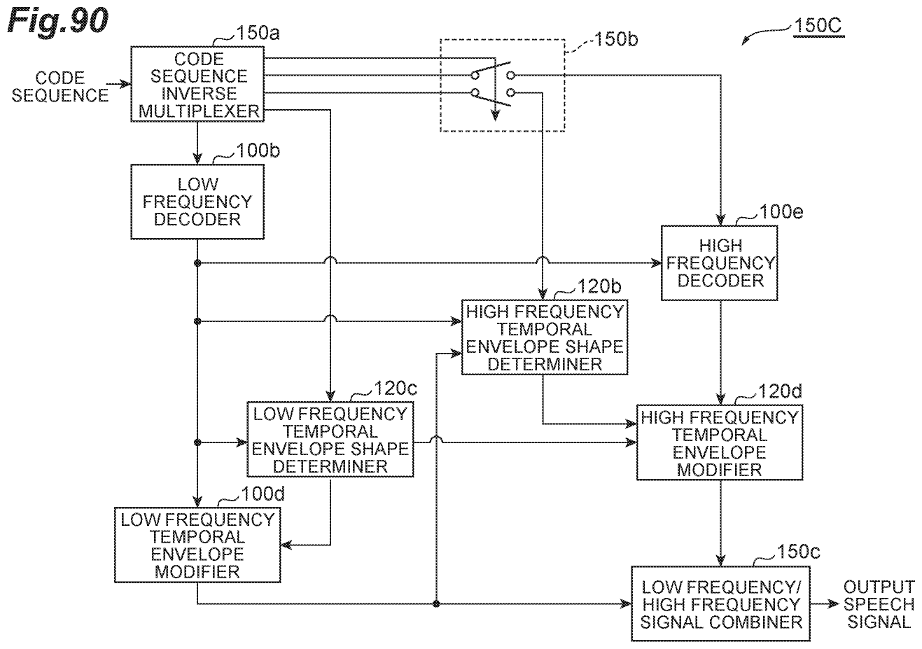

FIG. 90 is a diagram showing the configuration of a third modification 150C of the speech decoding device according to the seventh embodiment.

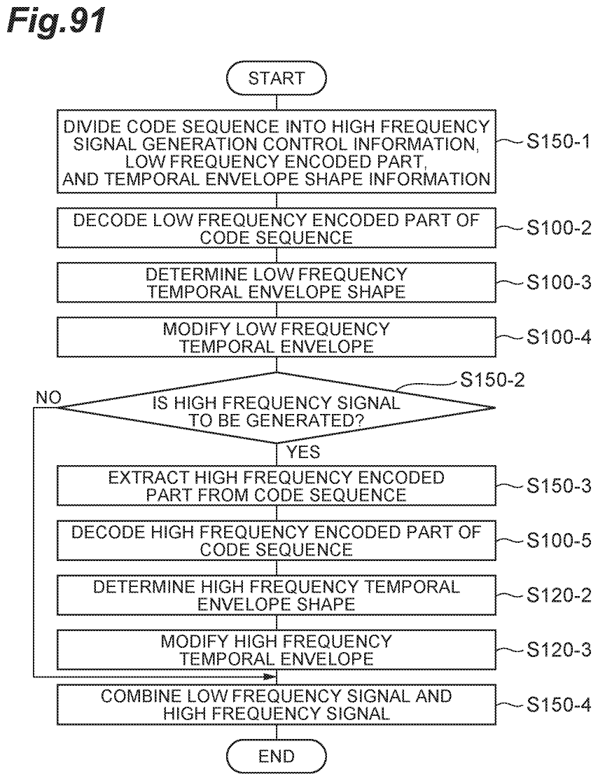

FIG. 91 is a flowchart showing the operation of the third modification 150C of the speech decoding device according to the seventh embodiment.

The present modification differs from the speech decoding device 150 according to the seventh embodiment in that it includes a low frequency temporal envelope shape determiner 120c and a high frequency temporal envelope modifier 120d in place of the low frequency temporal envelope shape determiner 100c and the high frequency temporal envelope modifier 110c.

### [Fourth Modification of Speech Decoding Device of Seventh Embodiment]

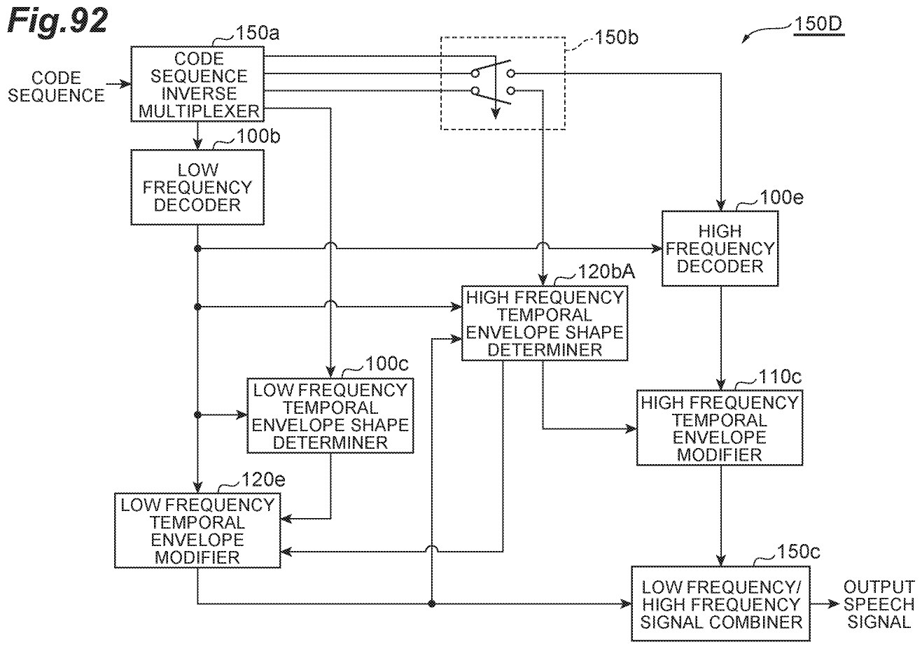

FIG. 92 is a diagram showing the configuration of a fourth modification 150D of the speech decoding device according to the seventh embodiment.

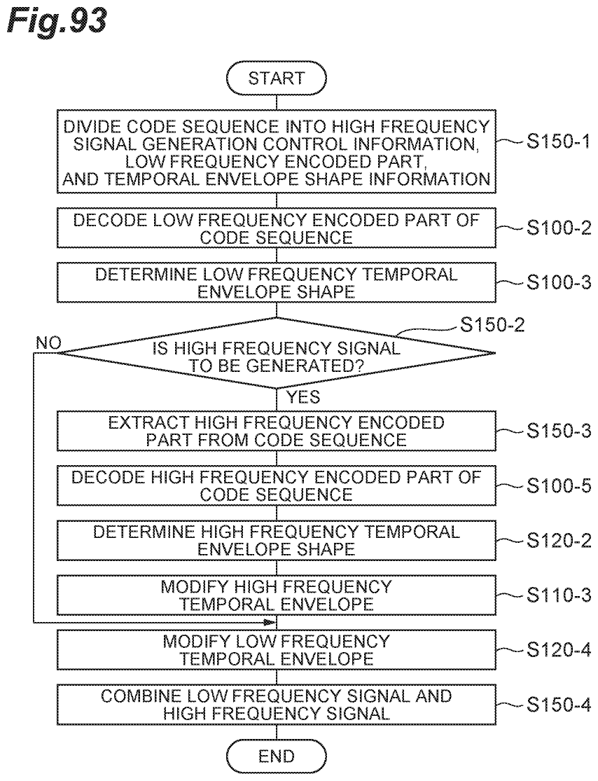

FIG. 93 is a flowchart showing the operation of the fourth modification 150D of the speech decoding device according to the seventh embodiment.

The present modification differs from the speech decoding device 150 according to the seventh embodiment in that it includes a high frequency temporal envelope shape determiner 120bA and a low frequency temporal envelope modifier 120e in place of the high frequency temporal envelope shape determiner 120b and the low frequency temporal envelope modifier 100d.

### [Fifth Modification of Speech Decoding Device of Seventh Embodiment]

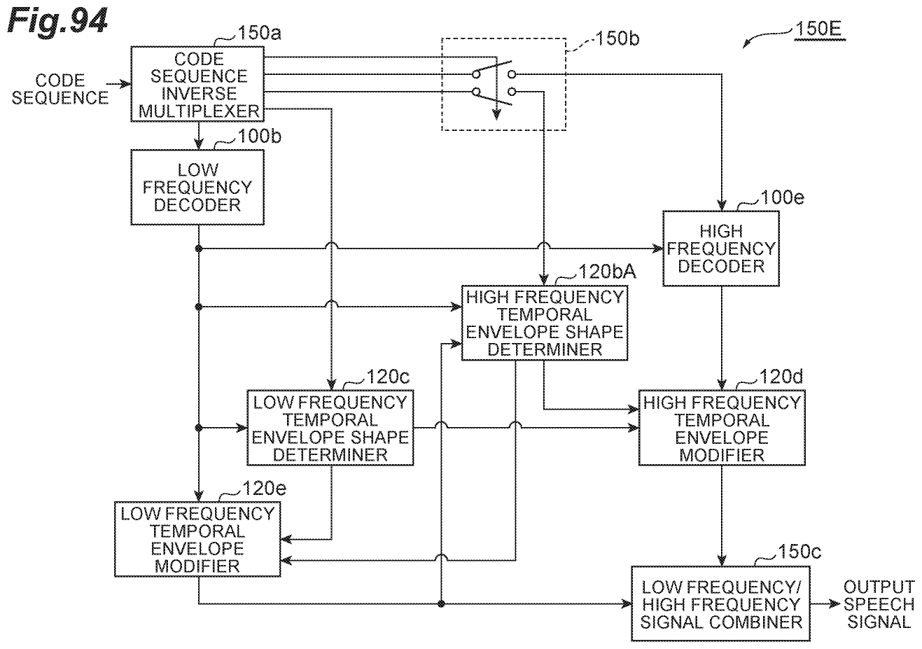

FIG. 94 is a diagram showing the configuration of a fifth modification 150E of the speech decoding device according to the seventh embodiment.

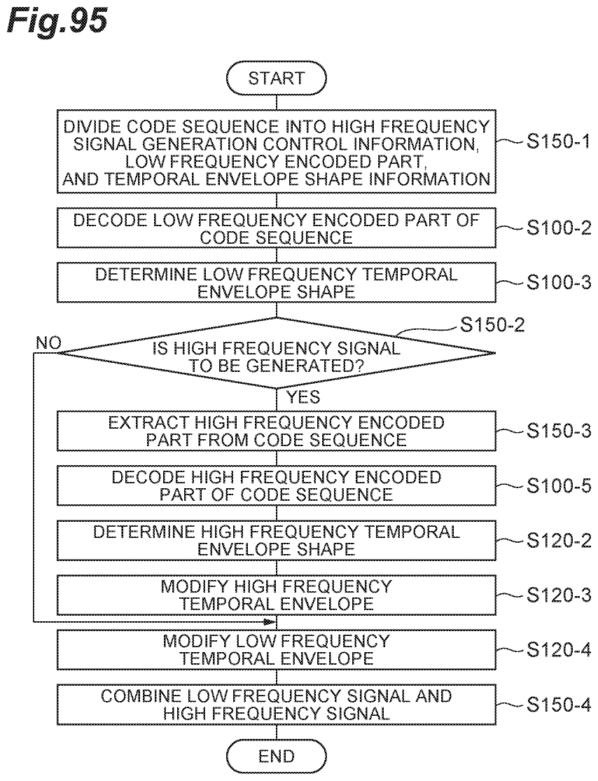

FIG. 95 is a flowchart showing the operation of the fifth modification 150E of the speech decoding device according to the seventh embodiment.

The present modification includes the low frequency temporal envelope shape determiner 120c, the high frequency temporal envelope modifier 120d, the high frequency temporal envelope shape determiner 120bA, and the low frequency temporal envelope modifier 120e.

### [Sixth Modification of Speech Decoding Device of Seventh Embodiment]

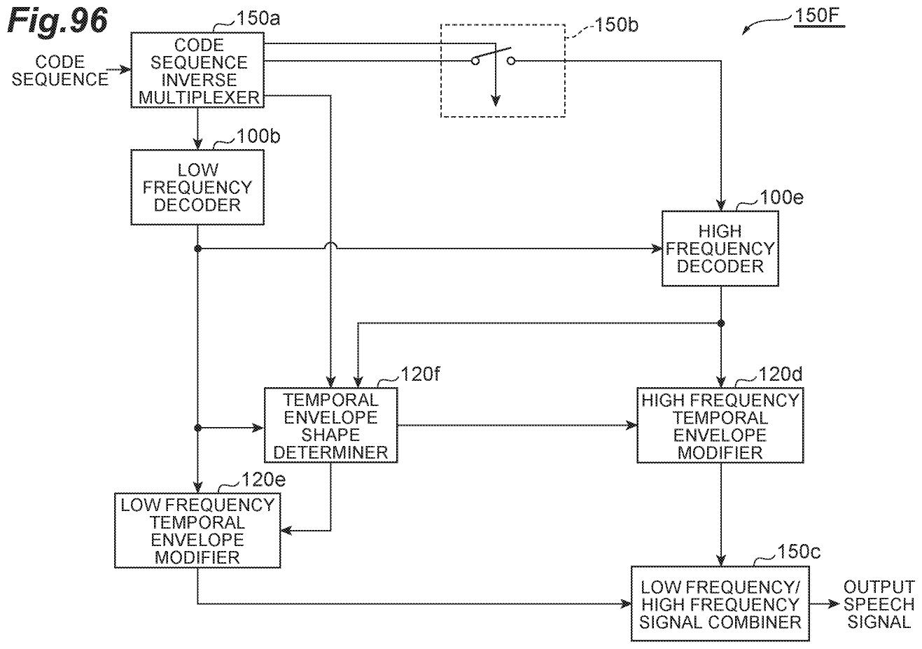

FIG. 96 is a diagram showing the configuration of a sixth modification 150F of the speech decoding device according to the seventh embodiment.

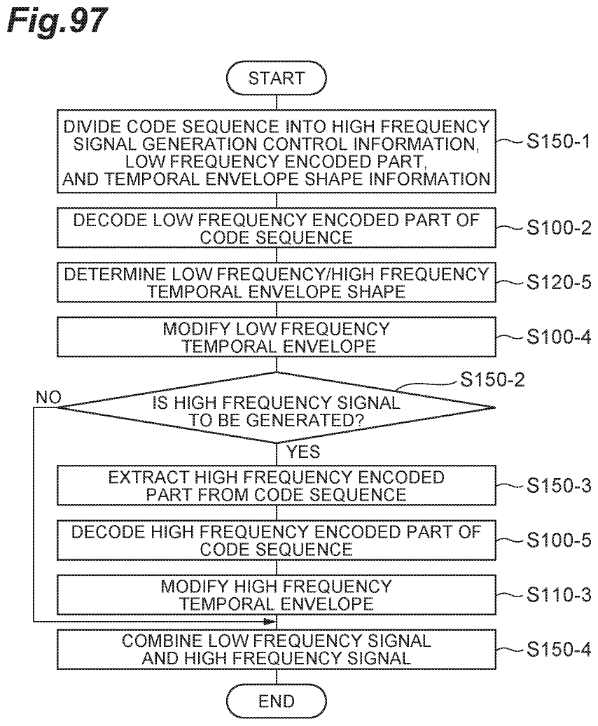

FIG. 97 is a flowchart showing the operation of the sixth modification 150F of the speech decoding device according to the seventh embodiment.

The present modification differs from the speech decoding device 150 according to the seventh embodiment in that it includes a temporal envelope shape determiner 120f in place of the low frequency temporal envelope shape determiner 100c and the high frequency temporal envelope shape determiner 120b.

### [Seventh Modification of Speech Decoding Device of Seventh Embodiment]

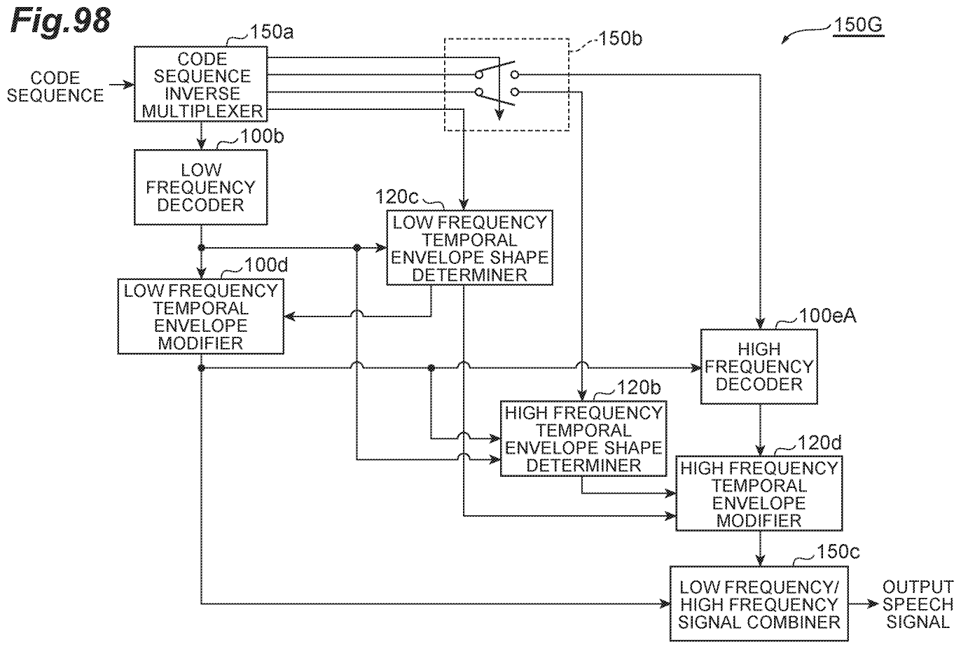

FIG. 98 is a diagram showing the configuration of a seventh modification 150G of the speech decoding device according to the seventh embodiment.

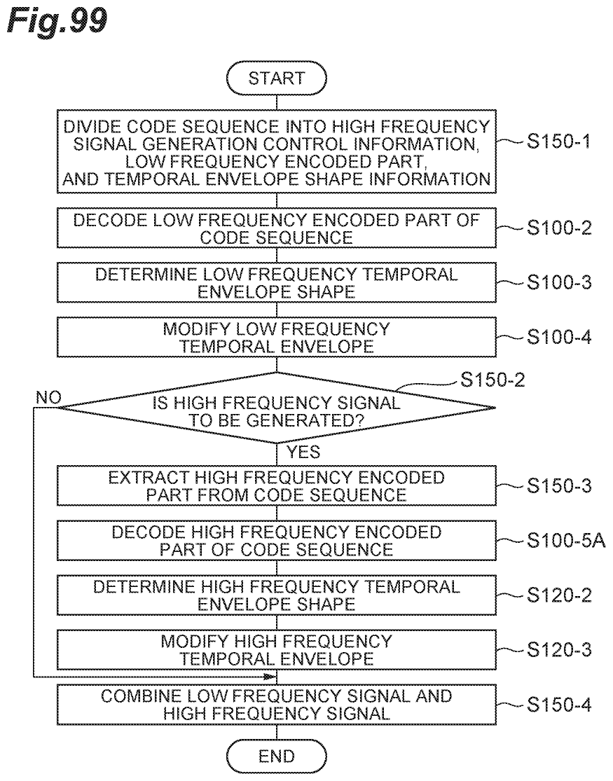

FIG. 99 is a flowchart showing the operation of the seventh modification 150G of the speech decoding device according to the seventh embodiment.

The present modification differs from the first modification 150A of the speech decoding device according to the seventh embodiment in that it includes a low frequency temporal envelope shape determiner 120c and a high frequency temporal envelope modifier 120d in place of the low frequency temporal envelope shape determiner 100c and the high frequency temporal envelope modifier 110c.

### [Eighth Modification of Speech Decoding Device of Seventh Embodiment]

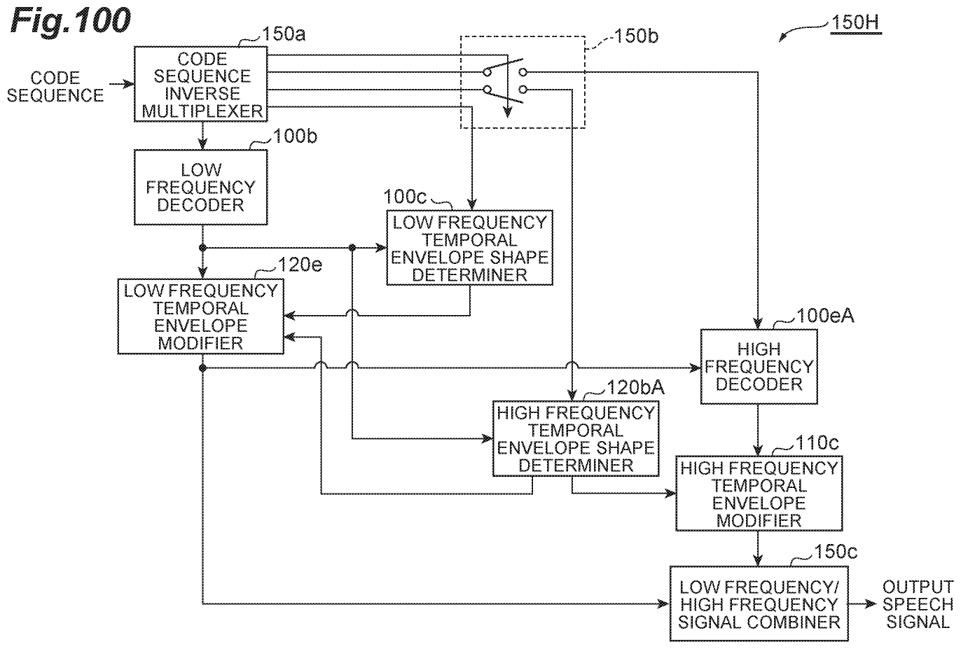

FIG. 100 is a diagram showing the configuration of an eighth modification 150H of the speech decoding device according to the seventh embodiment.

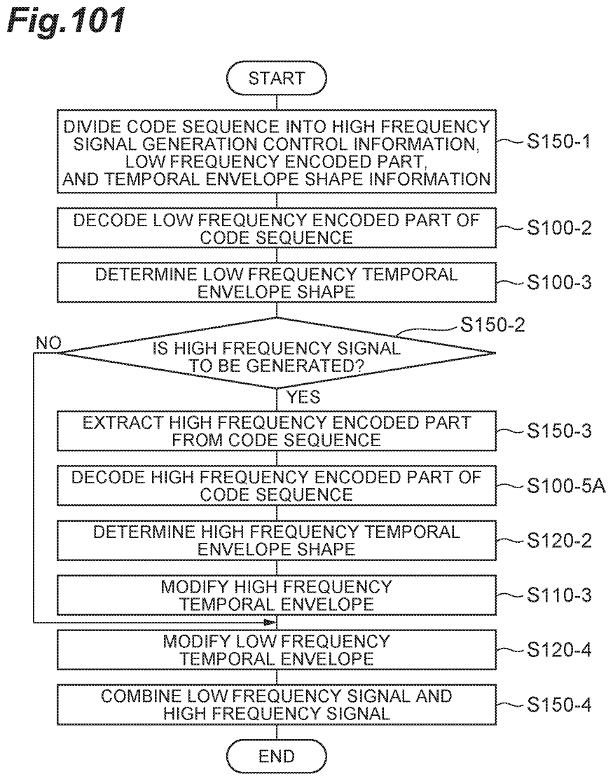

FIG. 101 is a flowchart showing the operation of the eighth modification 150H of the speech decoding device according to the seventh embodiment.

The present modification differs from the first modification 150A of the speech decoding device according to the seventh embodiment in that it includes a high frequency temporal envelope shape determiner 120bA and a low frequency temporal envelope modifier 120e in place of the high frequency temporal envelope shape determiner 120b and the low frequency temporal envelope modifier 100d.

### [Ninth Modification of Speech Decoding Device of Seventh Embodiment]

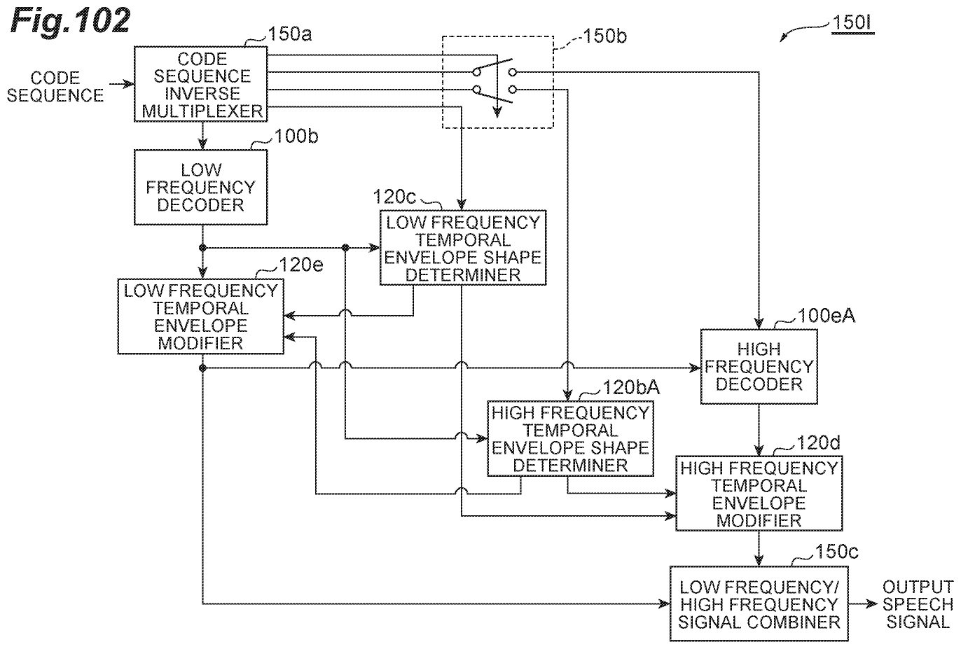

FIG. 102 is a diagram showing the configuration of a ninth modification 150I of the speech decoding device according to the seventh embodiment.

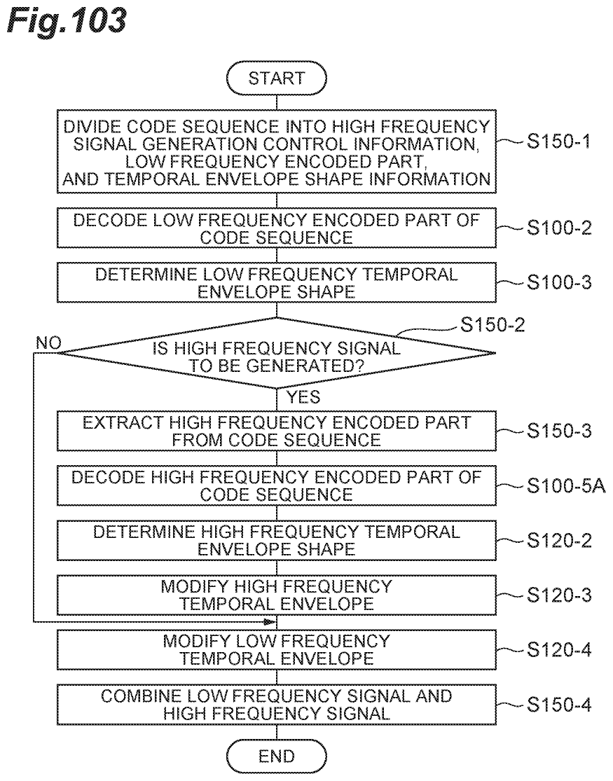

FIG. 103 is a flowchart showing the operation of the ninth modification 150I of the speech decoding device according to the seventh embodiment.

The present modification includes the low frequency temporal envelope shape determiner 120c, the high frequency temporal envelope modifier 120d, the high frequency temporal envelope shape determiner 120bA, and the low frequency temporal envelope modifier 120e.

### [Tenth Modification of Speech Decoding Device of Seventh Embodiment]

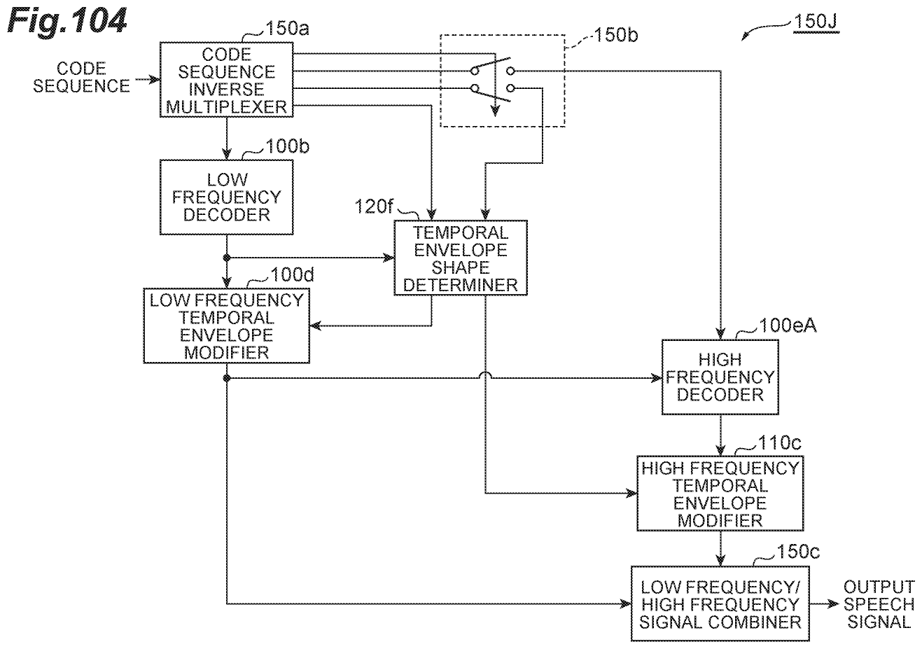

FIG. 104 is a diagram showing the configuration of a tenth modification 150J of the speech decoding device according to the seventh embodiment.

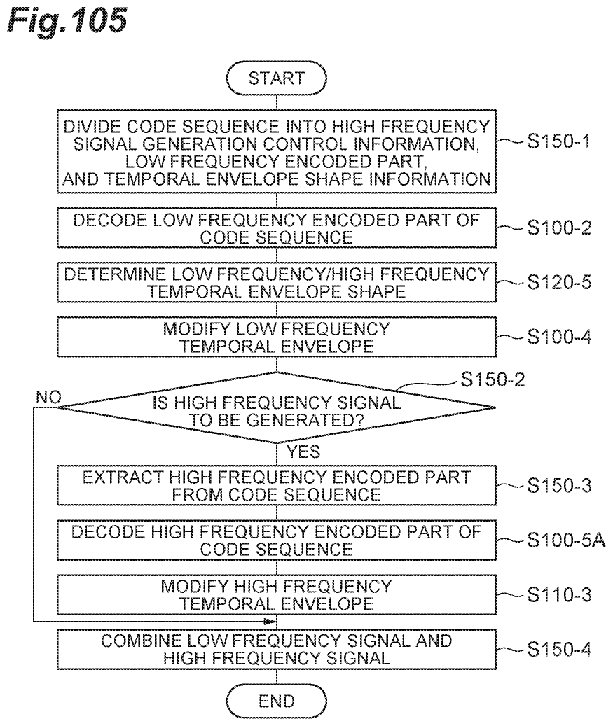

FIG. 105 is a flowchart showing the operation of the tenth modification 150J of the speech decoding device according to the seventh embodiment.

The present modification differs from the first modification 150A of the speech decoding device according to the seventh embodiment in that it includes a temporal envelope shape determiner 120f in place of the low frequency temporal envelope shape determiner 100c and the high frequency temporal envelope shape determiner 120b.

### [Eleventh Modification of Speech Decoding Device of Seventh Embodiment]

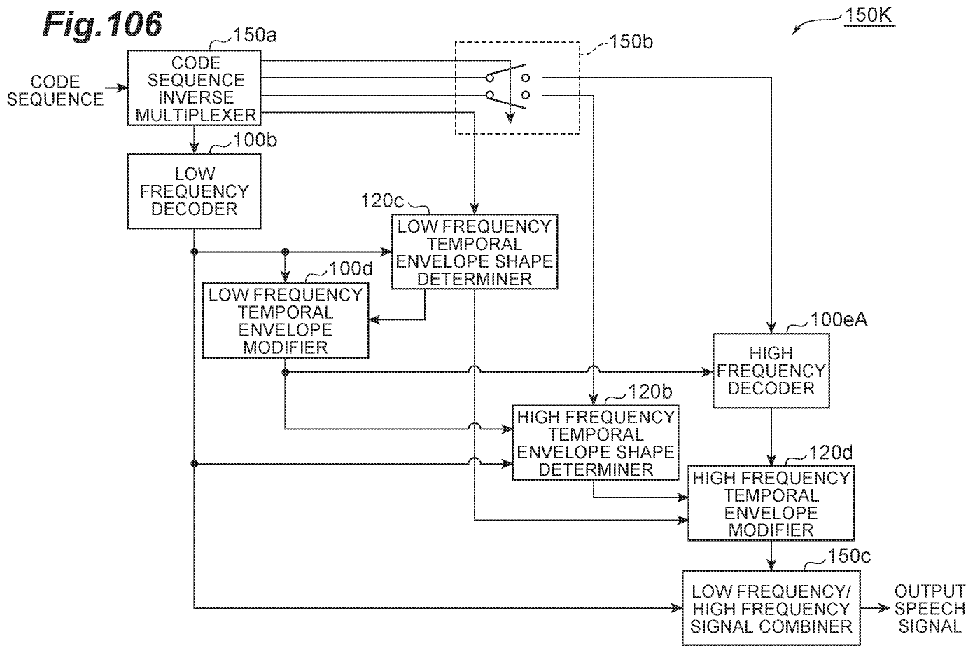

FIG. 106 is a diagram showing the configuration of an eleventh modification 150K of the speech decoding device according to the seventh embodiment.

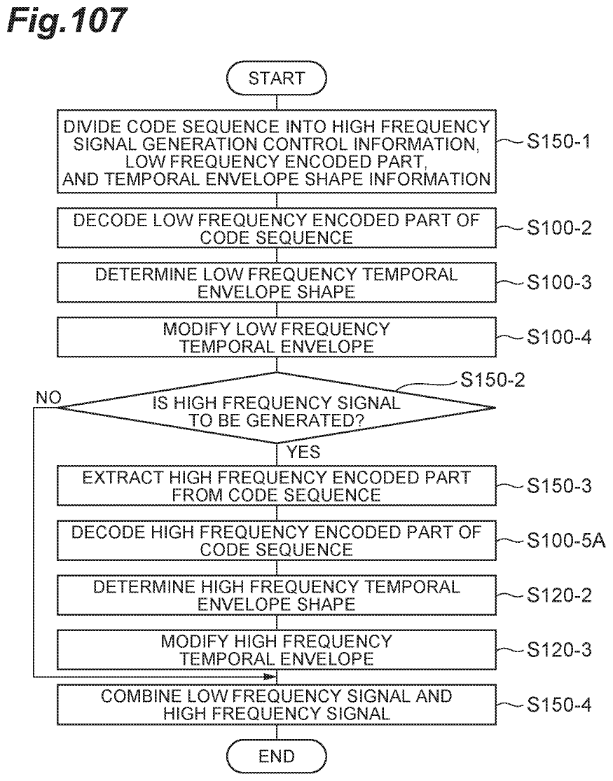

FIG. 107 is a flowchart showing the operation of the eleventh modification 150K of the speech decoding device according to the seventh embodiment.

The present modification differs from the second modification 150B of the speech decoding device according to the seventh embodiment in that it includes a low frequency temporal envelope shape determiner 120c and a high frequency temporal envelope modifier 120d in place of the low frequency temporal envelope shape determiner 100c and the high frequency temporal envelope modifier 110c.

### [Twelfth Modification of Speech Decoding Device of Seventh Embodiment]

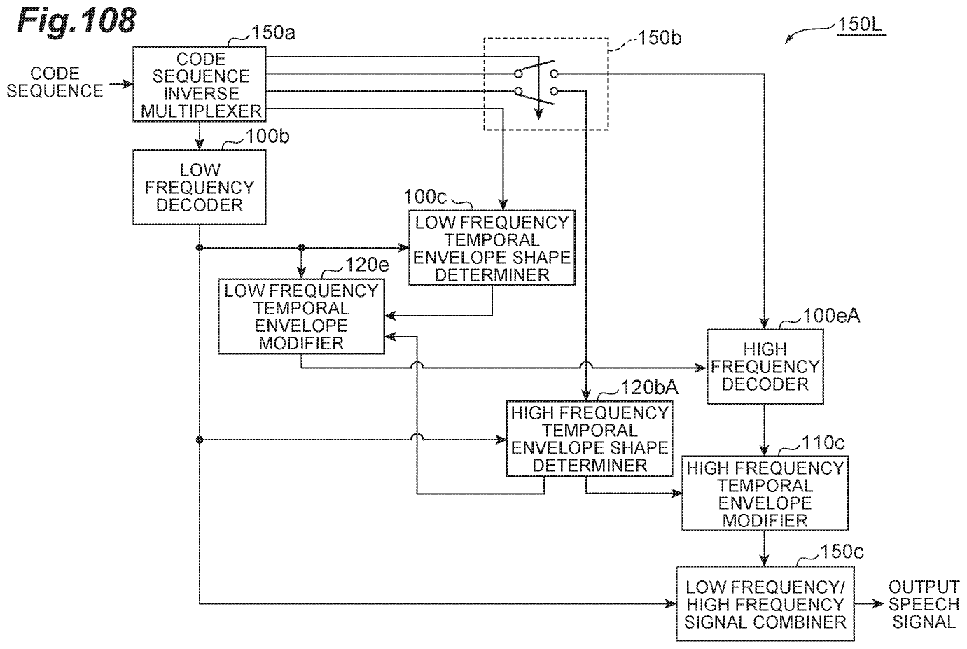

FIG. 108 is a diagram showing the configuration of a twelfth modification 150L of the speech decoding device according to the seventh embodiment.

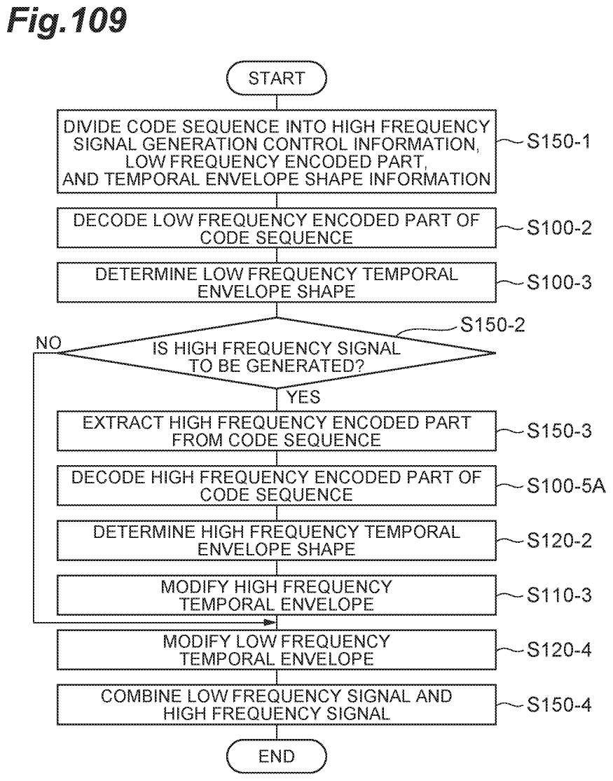

FIG. 109 is a flowchart showing the operation of the twelfth modification 150L of the speech decoding device according to the seventh embodiment.

The present modification differs from the second modification 150B of the speech decoding device according to the seventh embodiment in that it includes a high frequency temporal envelope shape determiner 120bA and a low frequency temporal envelope modifier 120e in place of the high frequency temporal envelope shape determiner 120b and the low frequency temporal envelope modifier 100d.

### [Thirteenth Modification of Speech Decoding Device of Seventh Embodiment]

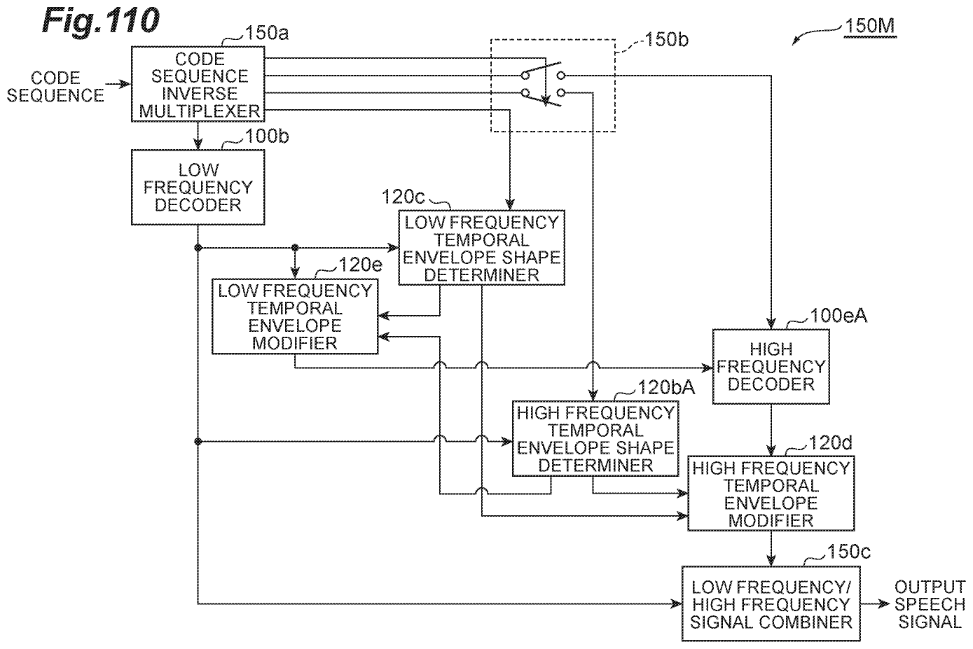

FIG. 110 is a diagram showing the configuration of a thirteenth modification 150M of the speech decoding device according to the seventh embodiment.

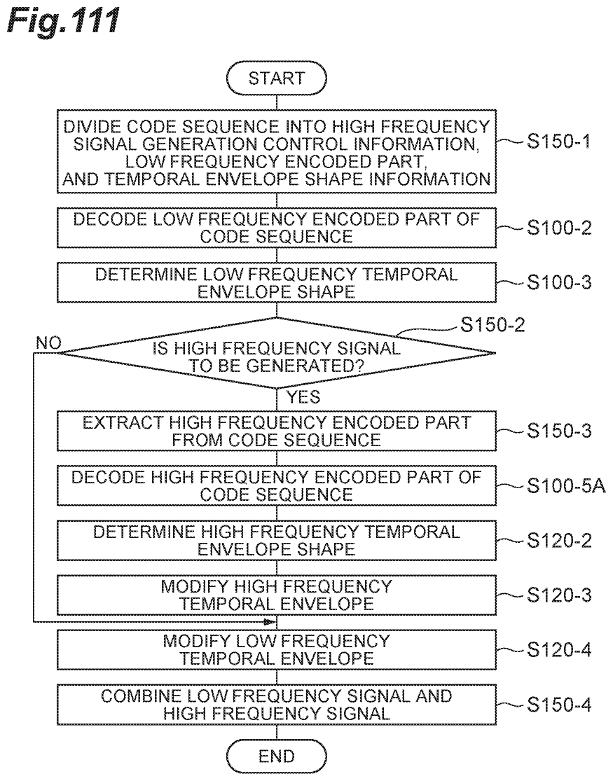

FIG. 111 is a flowchart showing the operation of the thirteenth modification 150M of the speech decoding device according to the seventh embodiment.

The present modification includes the low frequency temporal envelope shape determiner 120c, the high frequency temporal envelope modifier 120d, the high frequency temporal envelope shape determiner 120bA, and the low frequency temporal envelope modifier 120e.

### [Fourteenth Modification of Speech Decoding Device of Seventh Embodiment]

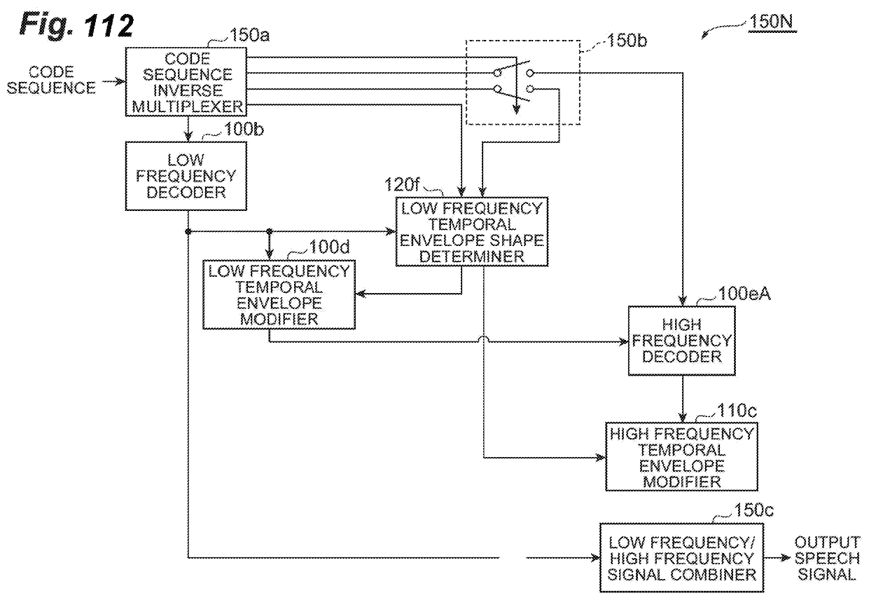

FIG. 112 is a diagram showing the configuration of a fourteenth modification 150N of the speech decoding device according to the seventh embodiment.

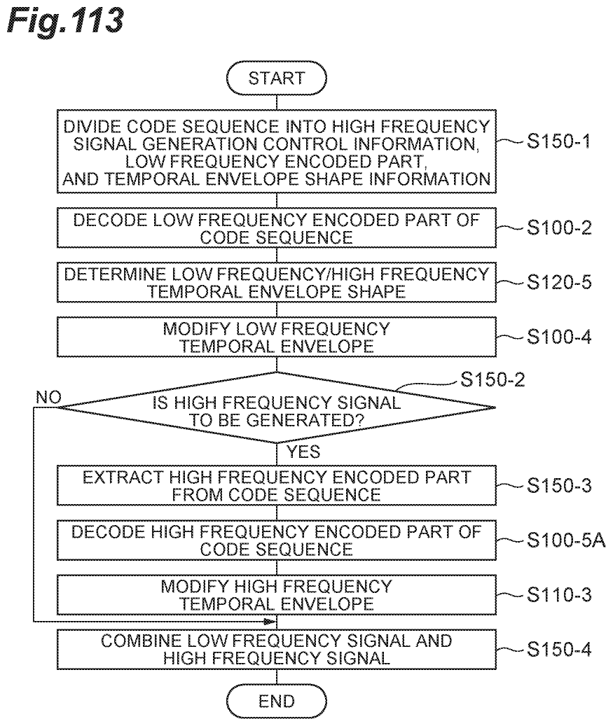

FIG. 113 is a flowchart showing the operation of the fourteenth modification 150N of the speech decoding device according to the seventh embodiment.

The present modification differs from the second modification 150B of the speech decoding device according to the seventh embodiment in that it includes a temporal envelope shape determiner 120f in place of the low frequency temporal envelope shape determiner 100c and the high frequency temporal envelope shape determiner 120b.

### Eighth Embodiment

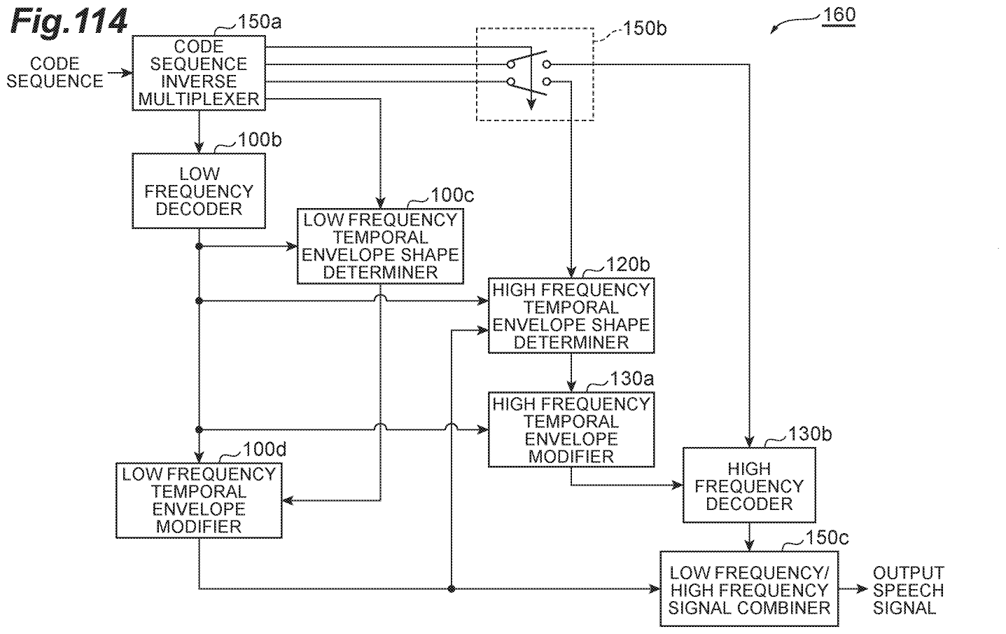

FIG. 114 is a diagram showing the configuration of a speech decoding device 160 according to an eighth embodiment. A communication device of the speech decoding device 160 receives a multiplexed code sequence output from a speech encoding device 260 described below and outputs a decoded speech signal to the outside. As shown in FIG. 114, the speech decoding device 160 functionally includes a code sequence demultiplexer 150a, switches 150b, a low frequency decoder 100b, a low frequency temporal envelope shape determiner 100c, a low frequency temporal envelope modifier 100d, a high frequency temporal envelope shape determiner 120b, a high frequency temporal envelope modifier 130a, a high frequency decoder 130b, and a low frequency/high frequency signal combiner 150c.

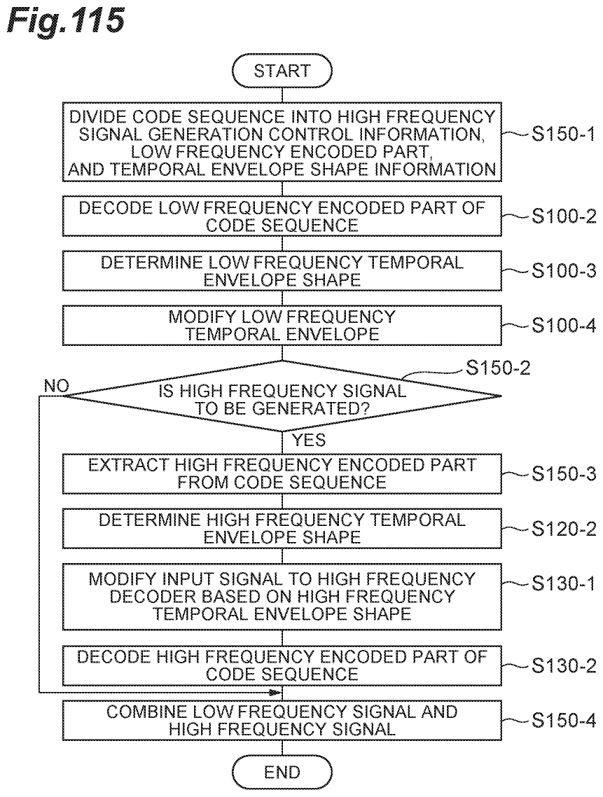

FIG. 115 is a flowchart showing the operation of the speech decoding device according to the eighth embodiment. The order in which the processing in step S150-2 and S150-3 is performed is not limited to the order illustrated in the flowchart in FIG. 115 as long as it is before the determination of the high frequency temporal envelope shape and the decoding of the high frequency encoded part.

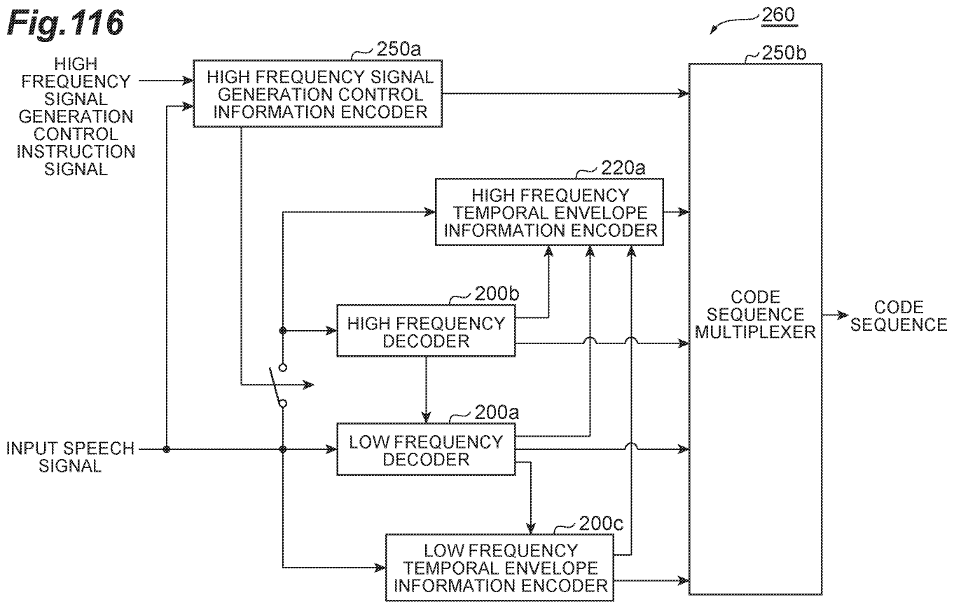

FIG. 116 is a diagram showing the configuration of the speech encoding device 260 according to the eighth embodiment. A communication device of the speech encoding device 260 receives a speech signal to be encoded from the outside and outputs the encoded code sequence to the outside. As shown in FIG. 116, the speech encoding device 260 functionally includes a high frequency signal generation control information encoder 250a, a low frequency encoder 200a, a high frequency encoder 200b, a low frequency temporal envelope information encoder 200c, a high frequency temporal envelope information encoder 220a, and a code sequence multiplexer 250b.

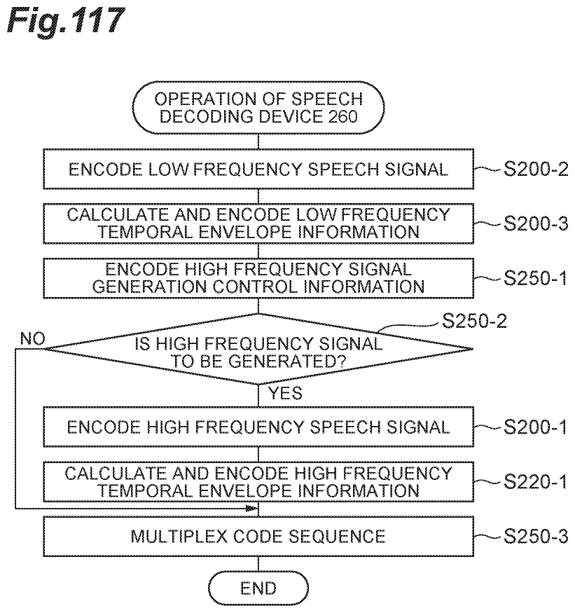

FIG. 117 is a flowchart showing the operation of the speech encoding device 260 according to the eighth embodiment.

### [First Modification of Speech Decoding Device of Eighth Embodiment]

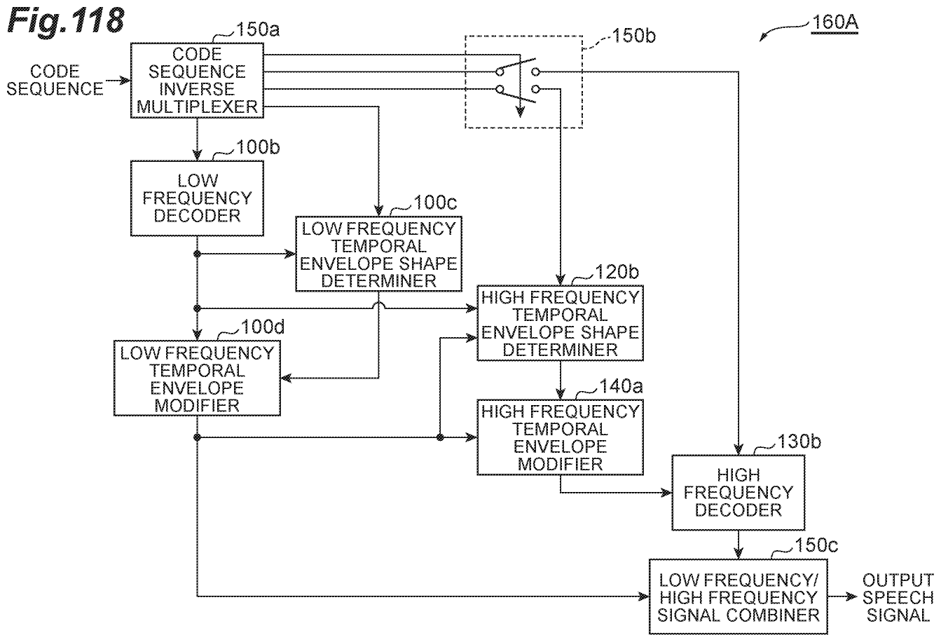

FIG. 118 is a diagram showing the configuration of a first modification 160A of the speech decoding device according to the eighth embodiment.

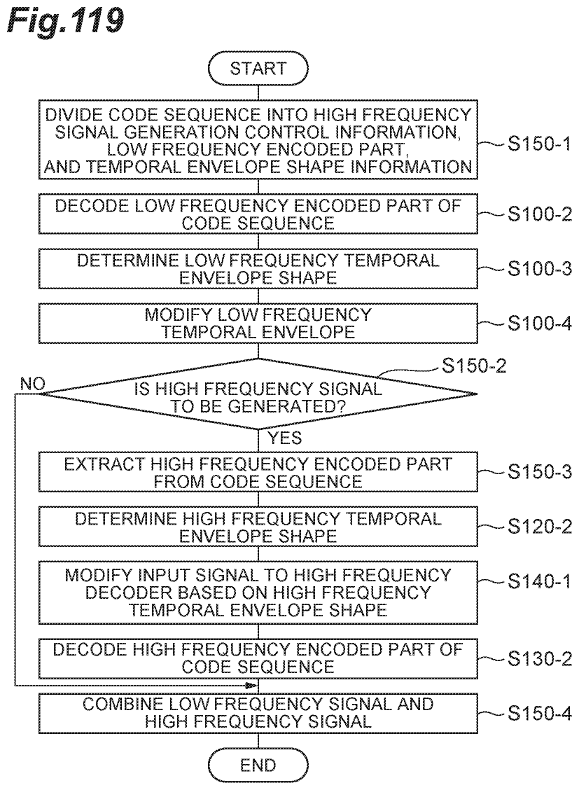

FIG. 119 is a flowchart showing the operation of the first modification 160A of the speech decoding device according to the eighth embodiment.

The difference from the speech decoding device 160 of the present embodiment is that the high frequency temporal envelope modifier 140a described in the first modification of the speech decoding device in the sixth embodiment is used in place of the high frequency temporal envelope modifier 130a.

The order in which the processing in step S150-2 and S150-3 is performed is not limited to the order illustrated in the flowchart in FIG. 119 as long as it is before the determination of the high frequency temporal envelope shape and the decoding of the high frequency encoded part.

### [Second Modification of Speech Decoding Device of Eighth Embodiment]

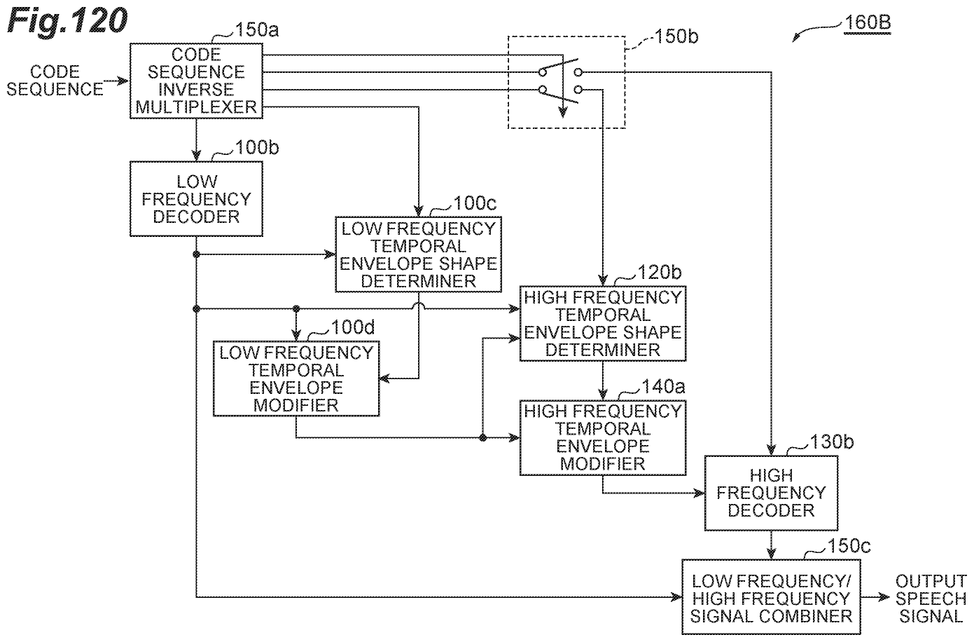

FIG. 120 is a diagram showing the configuration of a second modification 170B of the speech decoding device according to the eighth embodiment.

The difference from the first modification 160A of the speech decoding device of the present embodiment is that the low frequency signal to be used in the combining process by the low frequency/high frequency signal combiner 150c is the low frequency signal decoded by the low frequency decoder 100b, not the low frequency signal having the temporal envelope shape modified by the low frequency temporal envelope modifier 100d, as in the second modification of the speech decoding device of the sixth embodiment.

### [Third Modification of Speech Decoding Device of Eighth Embodiment]

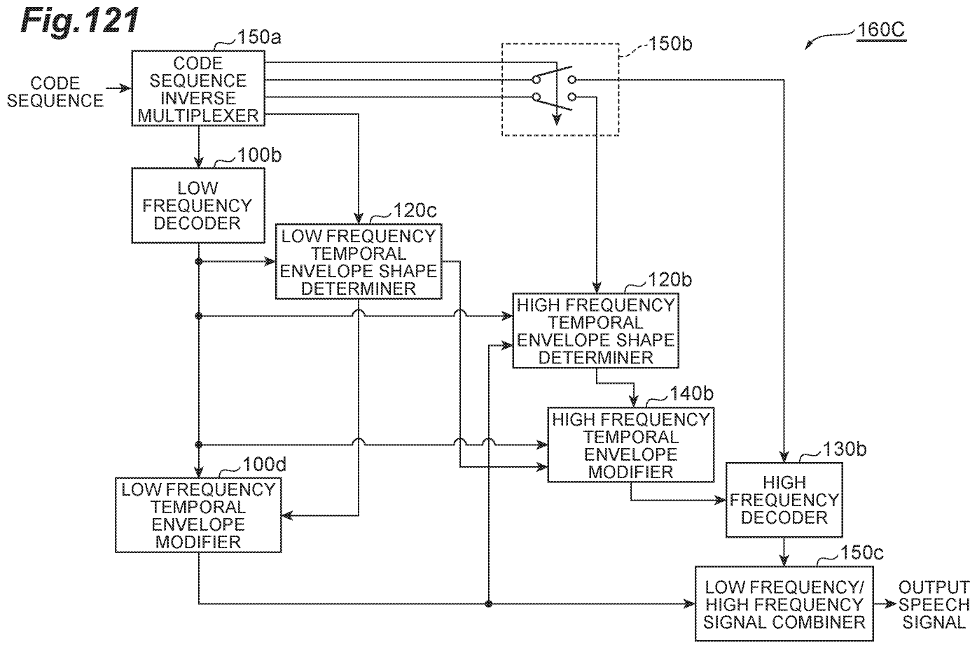

FIG. 121 is a diagram showing the configuration of a third modification 160C of the speech decoding device according to the eighth embodiment.

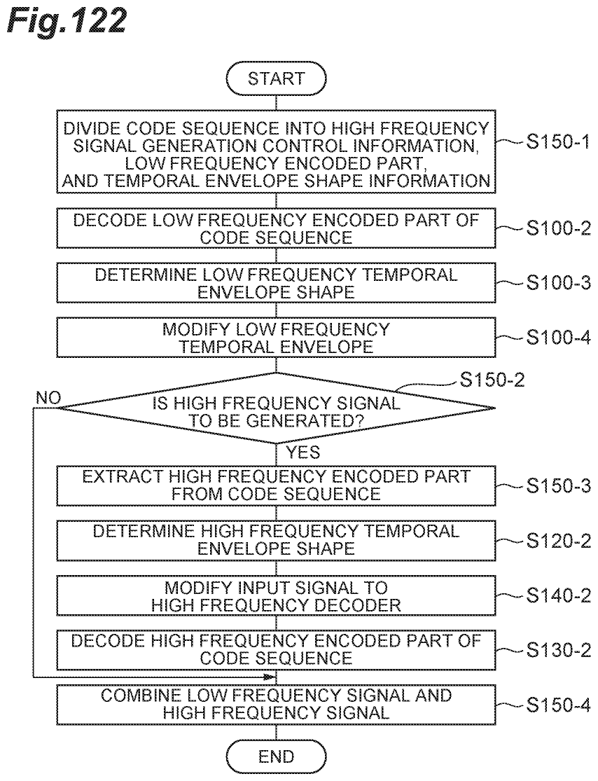

FIG. 122 is a flowchart showing the operation of the third modification 160C of the speech decoding device according to the eighth embodiment.

The present modification differs from the speech decoding device 160 according to the eighth embodiment in that it includes a low frequency temporal envelope shape determiner 120c and a high frequency temporal envelope modifier 140b in place of the low frequency temporal envelope shape determiner 100c and the high frequency temporal envelope modifier 130a.

### [Fourth Modification of Speech Decoding Device of Eighth Embodiment]

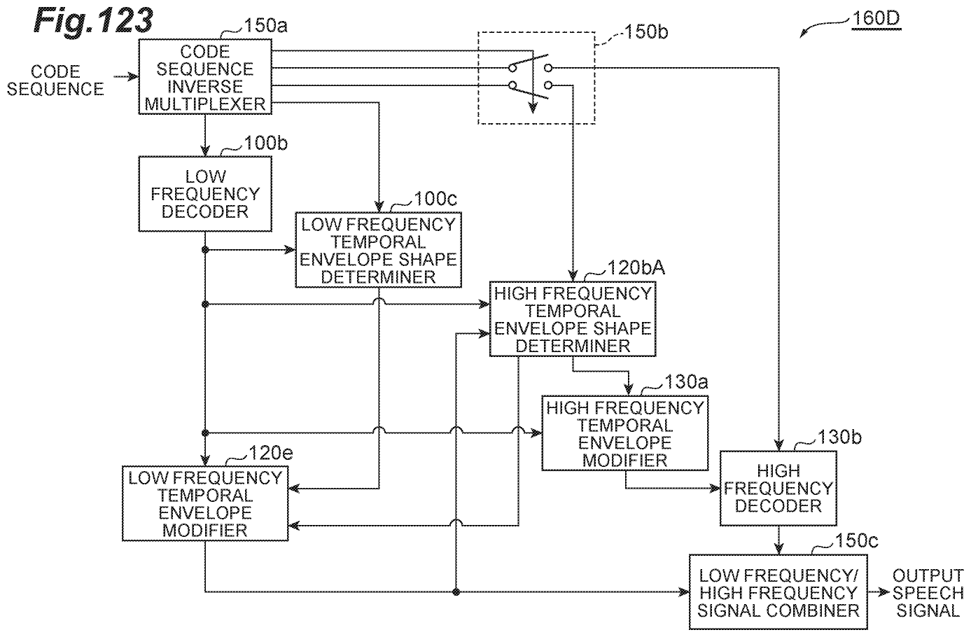

FIG. 123 is a diagram showing the configuration of a fourth modification 160D of the speech decoding device according to the eighth embodiment.

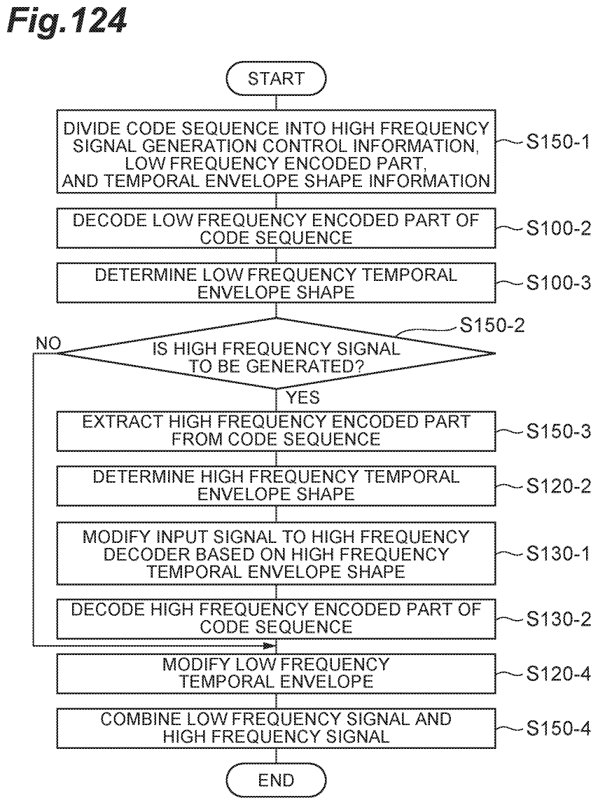

FIG. 124 is a flowchart showing the operation of the fourth modification 160D of the speech decoding device according to the eighth embodiment.

The present modification differs from the speech decoding device 160 according to the eighth embodiment in that it includes a high frequency temporal envelope shape determiner 120bA and a low frequency temporal envelope modifier 120e in place of the high frequency temporal envelope shape determiner 120b and the low frequency temporal envelope modifier 100d.

### [Fifth Modification of Speech Decoding Device of Eighth Embodiment]

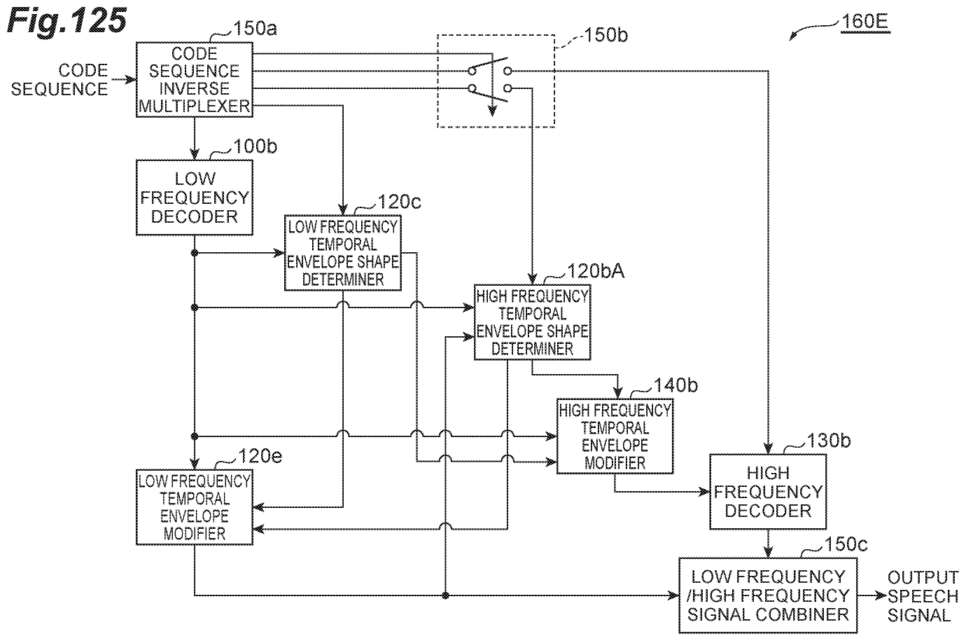

FIG. 125 is a diagram showing the configuration of a fifth modification 160E of the speech decoding device according to the eighth embodiment.

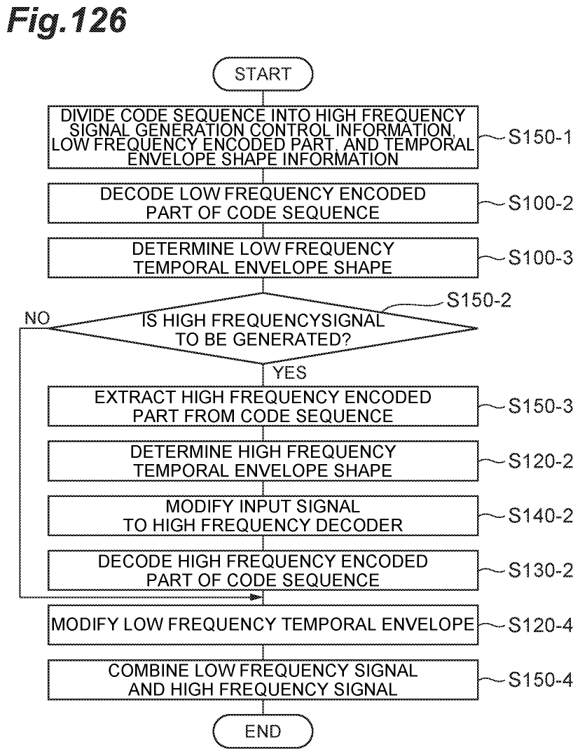

FIG. 126 is a flowchart showing the operation of the fifth modification 160E of the speech decoding device according to the eighth embodiment.

The present modification includes the low frequency temporal envelope shape determiner 120c, the high frequency temporal envelope modifier 140b, the high frequency temporal envelope shape determiner 120bA, and the low frequency temporal envelope modifier 120e.

### [Sixth Modification of Speech Decoding Device of Eighth Embodiment]

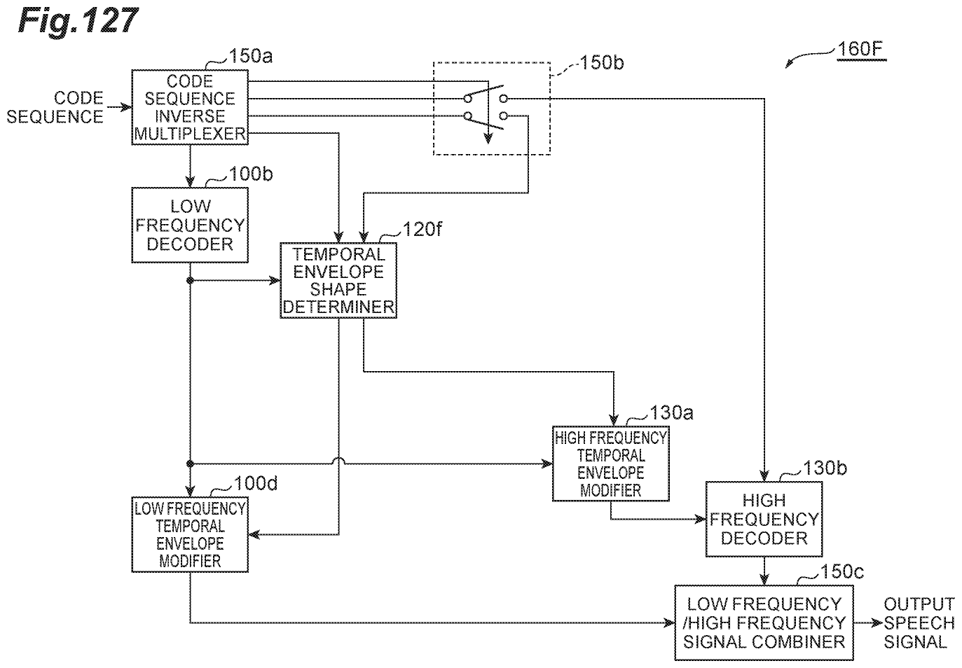

FIG. 127 is a diagram showing the configuration of a sixth modification 160F of the speech decoding device according to the eighth embodiment.

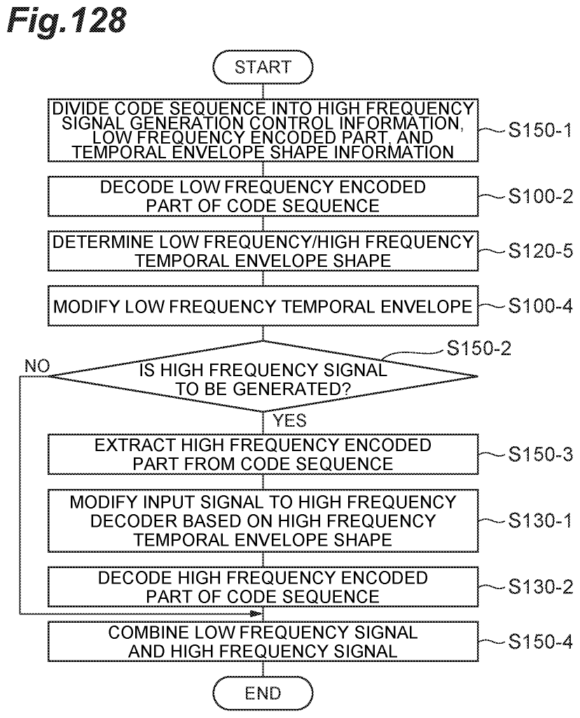

FIG. 128 is a flowchart showing the operation of the sixth modification 160F of the speech decoding device according to the eighth embodiment.

The present modification differs from the speech decoding device 160 according to the eighth embodiment in that it includes a temporal envelope shape determiner 120f in place of the low frequency temporal envelope shape determiner 100c and the high frequency temporal envelope shape determiner 120b.

### [Seventh Modification of Speech Decoding Device of Eighth Embodiment]

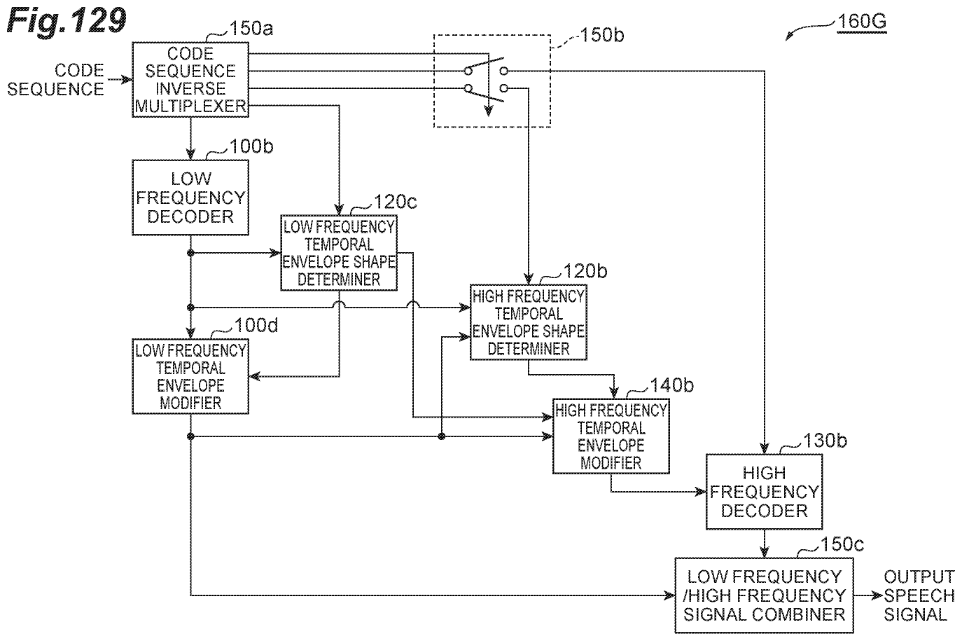

FIG. 129 is a diagram showing the configuration of a seventh modification 160G of the speech decoding device according to the eighth embodiment.

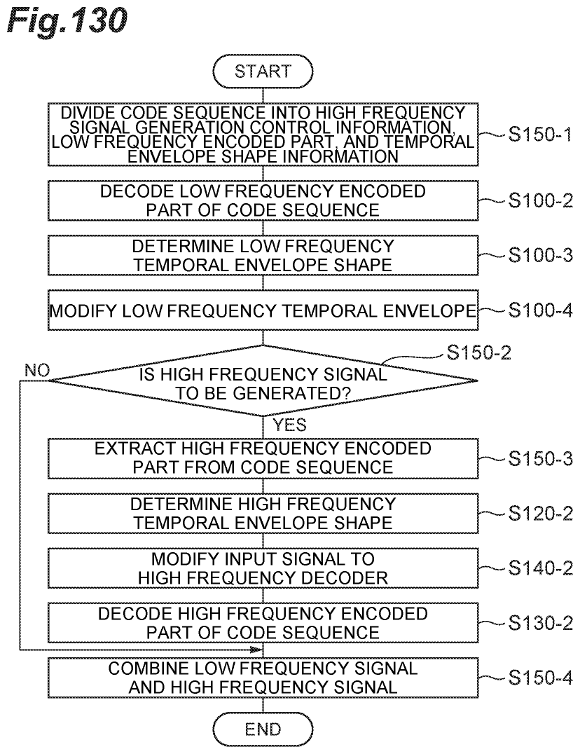

FIG. 130 is a flowchart showing the operation of the seventh modification 160G of the speech decoding device according to the eighth embodiment.

The present modification differs from the first modification 160A of the speech decoding device according to the eighth embodiment in that it includes a low frequency temporal envelope shape determiner 120c and a high frequency temporal envelope modifier 140b in place of the low frequency temporal envelope shape determiner 100c and the high frequency temporal envelope modifier 140a.

In the present modification, the high frequency temporal envelope modifier 140b modifies the shape of the temporal envelope of the low frequency signal having the temporal envelope shape modified to be input to the high frequency decoder 130b, based on at least one of the temporal envelope shape determined by the high frequency temporal envelope shape determiner 120b and the temporal envelope shape determined by the low frequency temporal envelope shape determiner 120c (S140-2).

### [Eighth Modification of Speech Decoding Device of Eighth Embodiment]

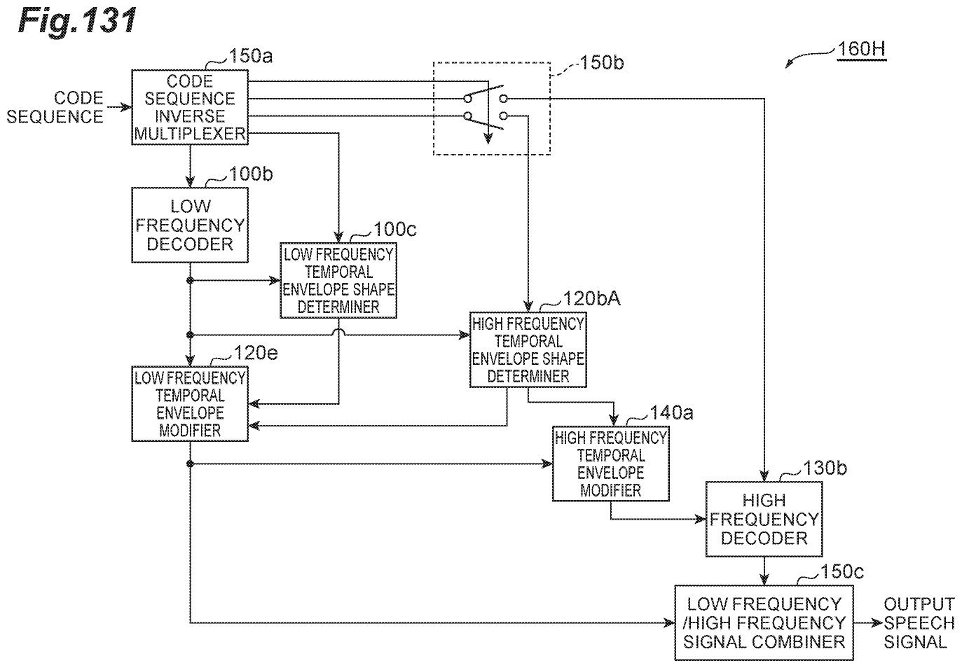

FIG. 131 is a diagram showing the configuration of an eighth modification 160H of the speech decoding device according to the eighth embodiment.

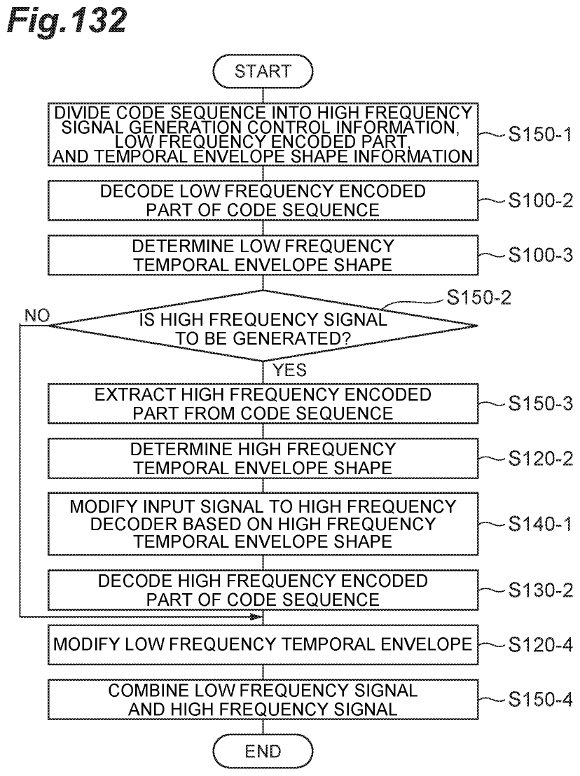

FIG. 132 is a flowchart showing the operation of the eighth modification 160H of the speech decoding device according to the eighth embodiment.

The present modification differs from the first modification 160A of the speech decoding device according to the eighth embodiment in that it includes a high frequency temporal envelope shape determiner 120bA and a low frequency temporal envelope modifier 120e in place of the high frequency temporal envelope shape determiner 120b and the low frequency temporal envelope modifier 100d.

### [Ninth Modification of Speech Decoding Device of Eighth Embodiment]

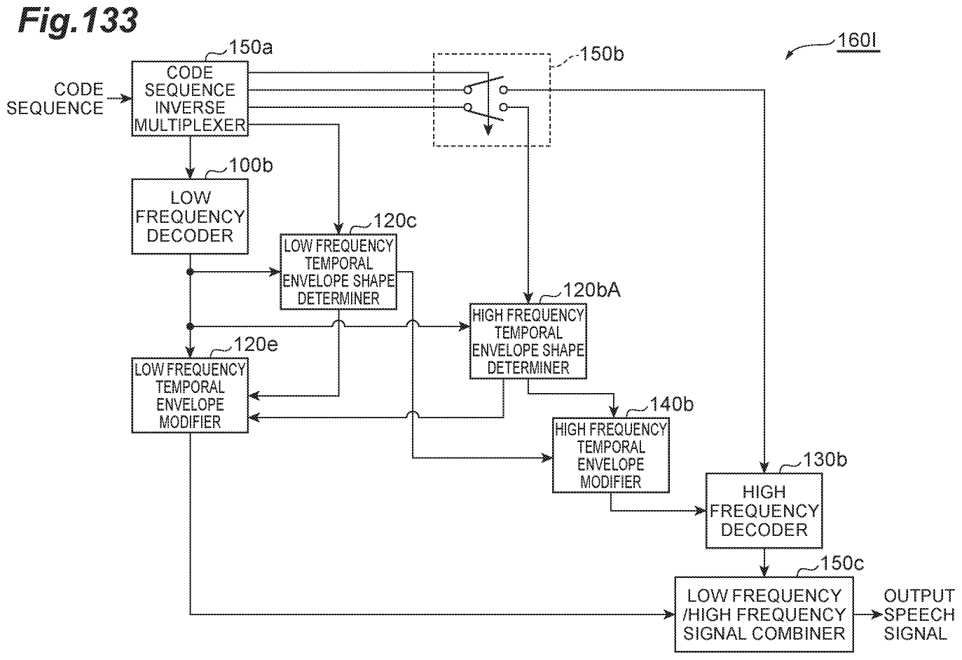

FIG. 133 is a diagram showing the configuration of a ninth modification 160I of the speech decoding device according to the eighth embodiment.

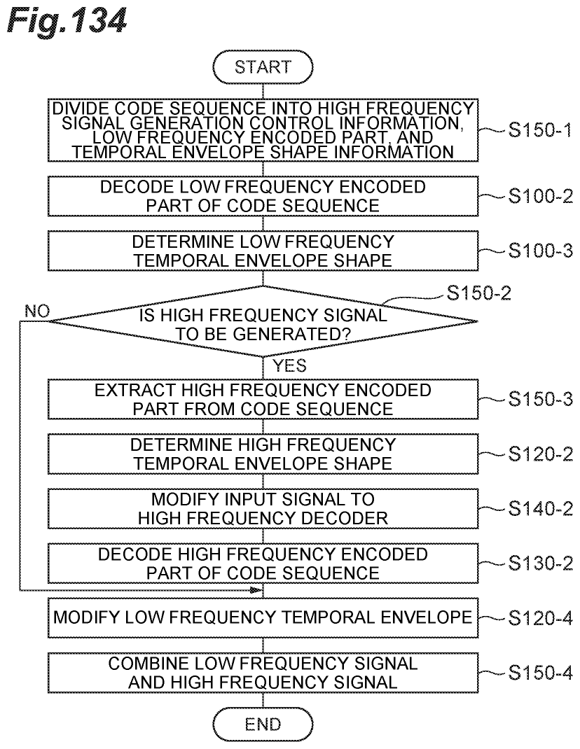

FIG. 134 is a flowchart showing the operation of the ninth modification 160I of the speech decoding device according to the eighth embodiment.

The present modification includes the low frequency temporal envelope shape determiner 120c, the high frequency temporal envelope modifier 140b, the high frequency temporal envelope shape determiner 120bA, and the low frequency temporal envelope modifier 120e.

### [Tenth Modification of Speech Decoding Device of Eighth Embodiment]

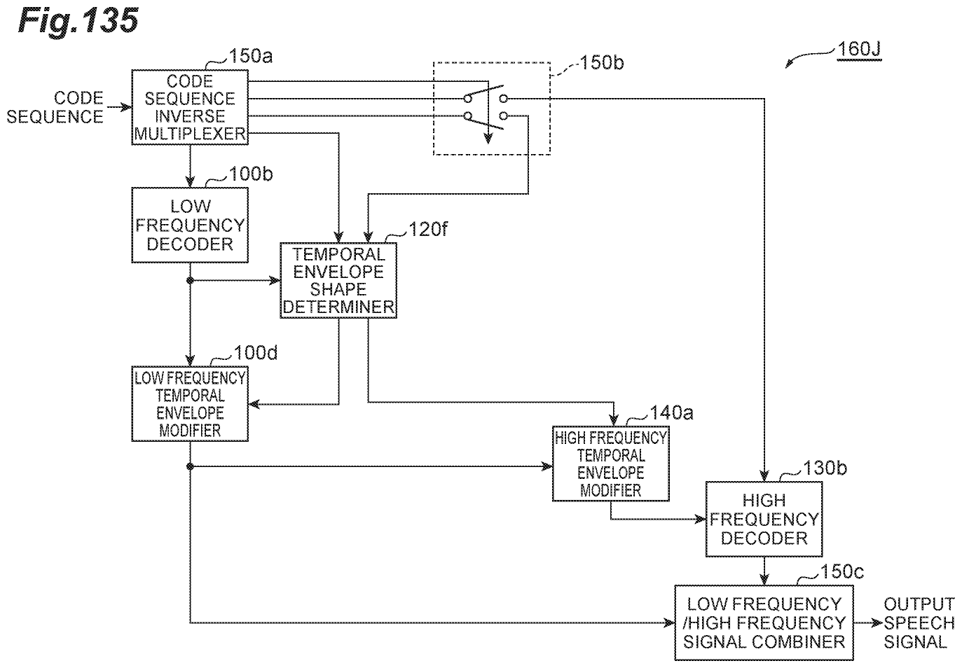

FIG. 135 is a diagram showing the configuration of a tenth modification 160J of the speech decoding device according to the eighth embodiment.

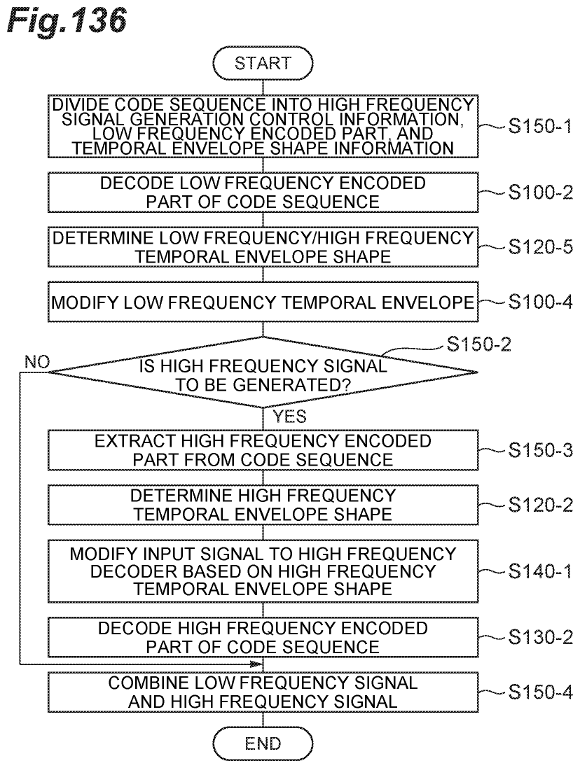

FIG. 136 is a flowchart showing the operation of the tenth modification 160J of the speech decoding device according to the eighth embodiment.

The present modification differs from the first modification 160A of the speech decoding device according to the eighth embodiment in that it includes a temporal envelope shape determiner 120f in place of the low frequency temporal envelope shape determiner 100c and the high frequency temporal envelope shape determiner 120b.

### [Eleventh Modification of Speech Decoding Device of Eighth Embodiment]

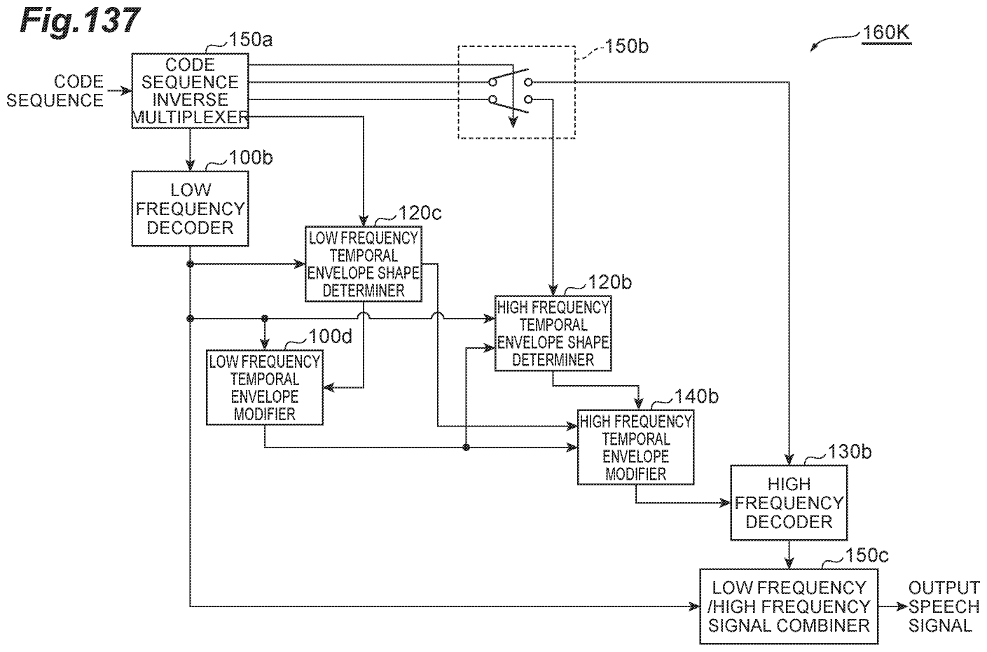

FIG. 137 is a diagram showing the configuration of an eleventh modification 160K of the speech decoding device according to the eighth embodiment.

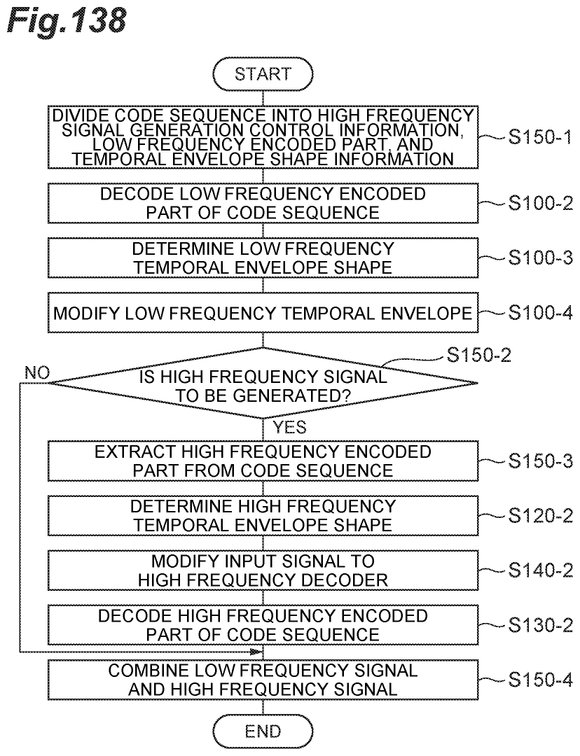

FIG. 138 is a flowchart showing the operation of the eleventh modification 160K of the speech decoding device according to the eighth embodiment.

The present modification differs from the second modification 160B of the speech decoding device according to the eighth embodiment in that it includes a low frequency temporal envelope shape determiner 120c and a high frequency temporal envelope modifier 140b in place of the low frequency temporal envelope shape determiner 100c and the high frequency temporal envelope modifier 140a.

### [Twelfth Modification of Speech Decoding Device of Eighth Embodiment]

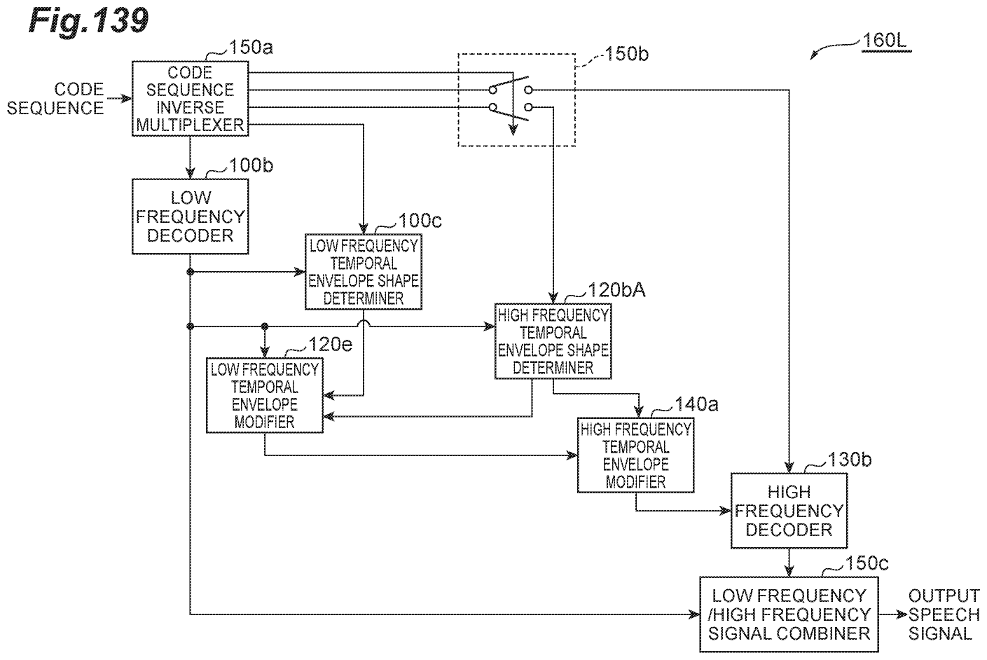

FIG. 139 is a diagram showing the configuration of a twelfth modification 160L of the speech decoding device according to the eighth embodiment.

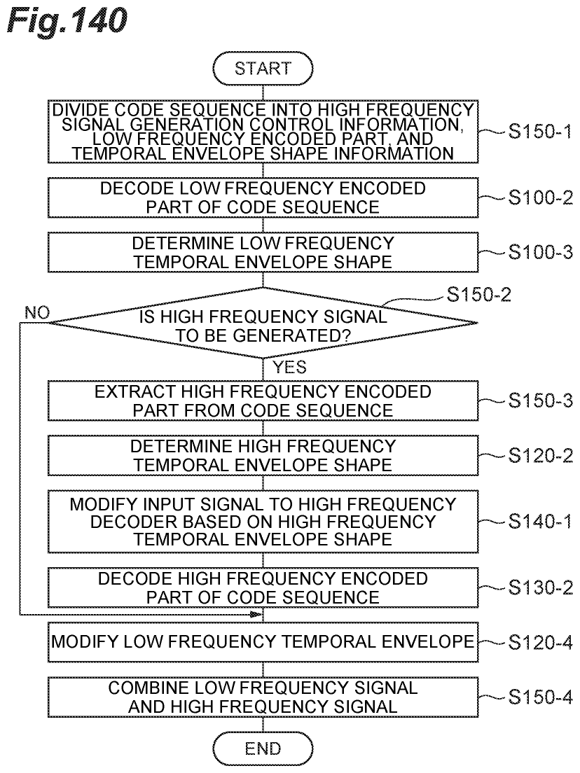

FIG. 140 is a flowchart showing the operation of the twelfth modification 160L of the speech decoding device according to the eighth embodiment.

The present modification differs from the second modification 160B of the speech decoding device according to the eighth embodiment in that it includes a high frequency temporal envelope shape determiner 120bA and a low frequency temporal envelope modifier 120e in place of the high frequency temporal envelope shape determiner 120b and the low frequency temporal envelope modifier 100d.

### [Thirteenth Modification of Speech Decoding Device of Eighth Embodiment]

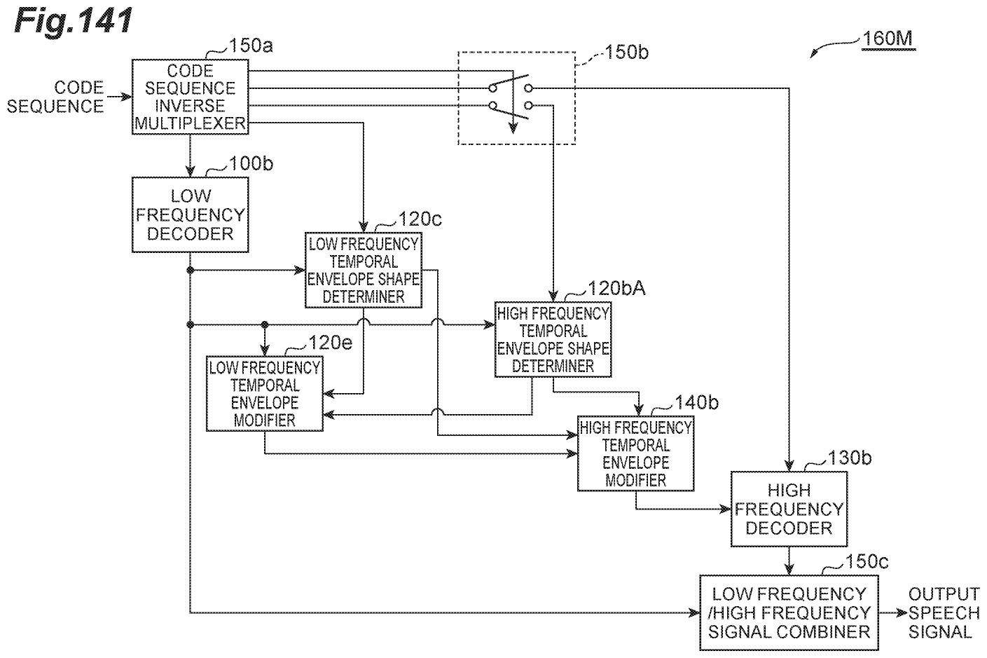

FIG. 141 is a diagram showing the configuration of a thirteenth modification 160M of the speech decoding device according to the eighth embodiment.

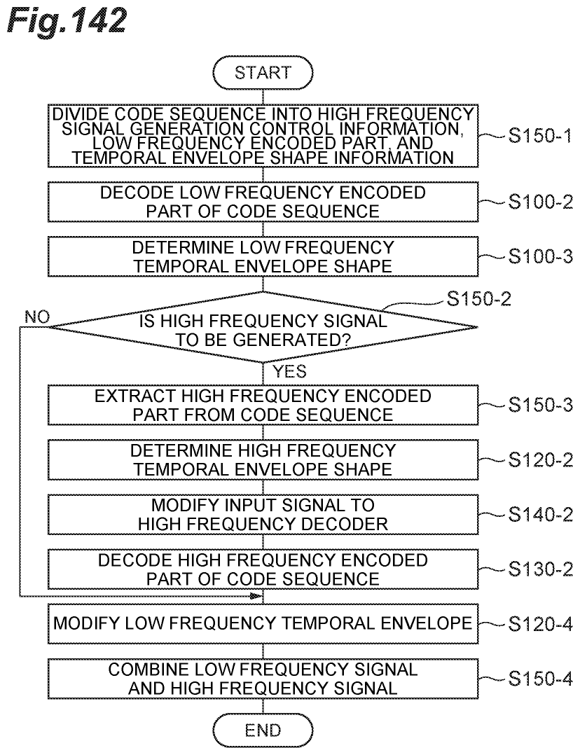

FIG. 142 is a flowchart showing the operation of the thirteenth modification 160M of the speech decoding device according to the eighth embodiment.

The present modification includes the low frequency temporal envelope shape determiner 120c, the high frequency temporal envelope modifier 140b, the high frequency temporal envelope shape determiner 120bA, and the low frequency temporal envelope modifier 120e.

### [Fourteenth Modification of Speech Decoding Device of Eighth Embodiment]

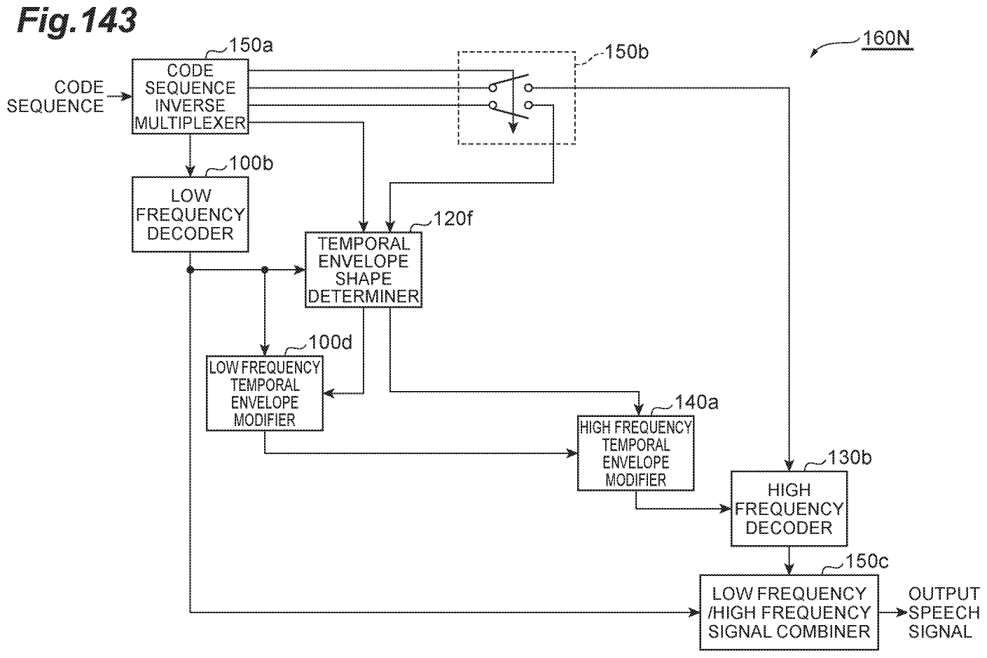

FIG. 143 is a diagram showing the configuration of a fourteenth modification 160N of the speech decoding device according to the eighth embodiment.

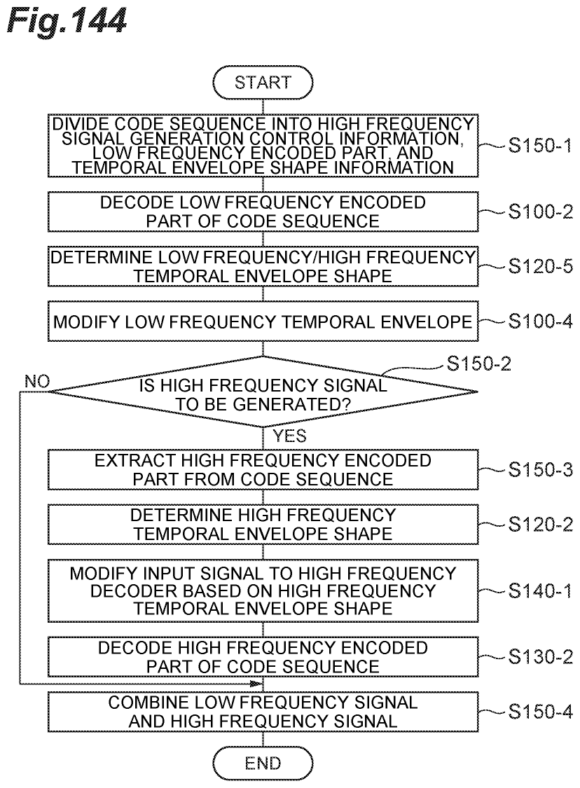

FIG. 144 is a flowchart showing the operation of the fourteenth modification 160N of the speech decoding device according to the eighth embodiment.

The present modification differs from the second modification 160B of the speech decoding device according to the eighth embodiment in that it includes a temporal envelope shape determiner 120f in place of the low frequency temporal envelope shape determiner 100c and the high frequency temporal envelope shape determiner 120b.

### [Speech Decoding Device of Ninth Embodiment]

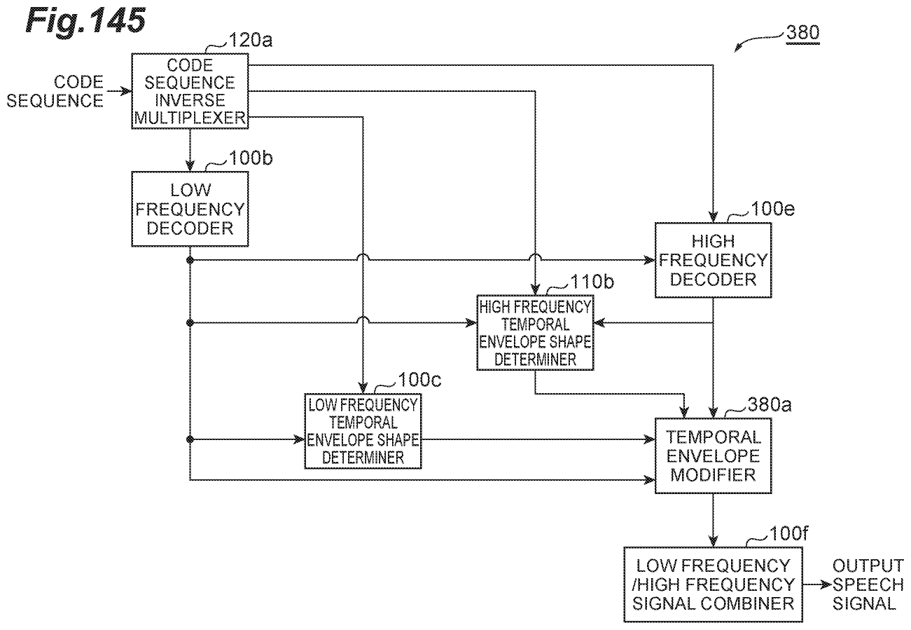

FIG. 145 is a diagram showing the configuration of a speech decoding device 380 according to a ninth embodiment.

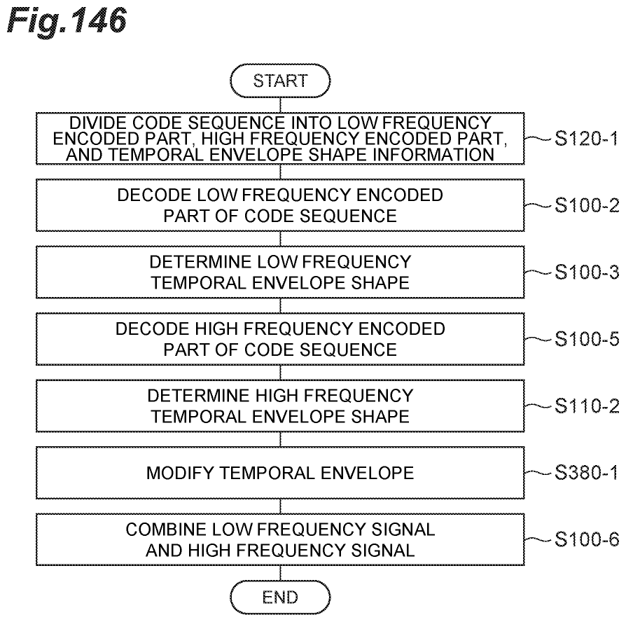

FIG. 146 is a flowchart showing the operation of the speech decoding device 380 according to the ninth embodiment.

The temporal envelope modifier 380a modifies the shape of the temporal envelope of the low frequency signal output from the low frequency decoder 100b and the high frequency signal output from the high frequency decoder 100e, based on at least one of the temporal envelope shape determined by the low frequency temporal envelope shape determiner 100c and the temporal envelope shape determined by the high frequency temporal envelope shape determiner 110b (S380-1).

The temporal envelope shape determined by the low frequency temporal envelope shape determiner 100c and the temporal envelope shape determined by the high frequency temporal envelope shape determiner 110b may be the same or different.

### [First Modification of Speech Decoding Device of Ninth Embodiment]

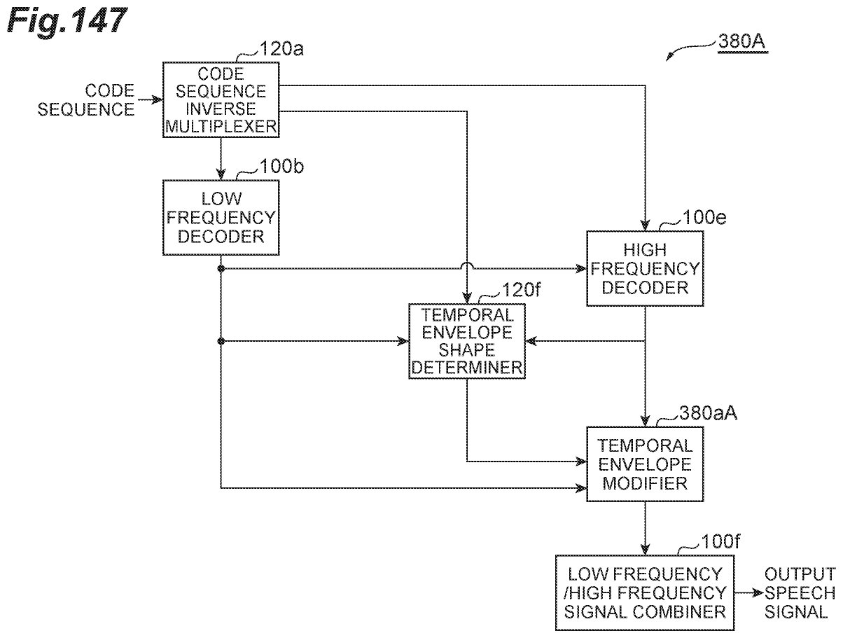

FIG. 147 is a diagram showing the configuration of a first modification 380A of the speech decoding device according to the ninth embodiment.

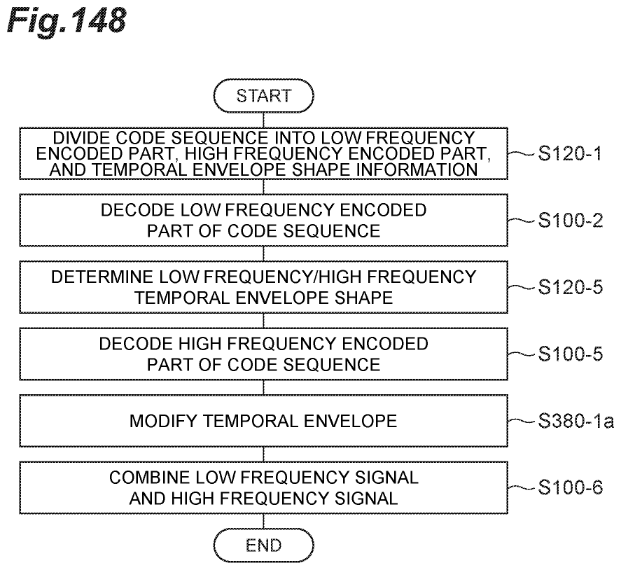

FIG. 148 is a flowchart showing the operation of the first modification 380A of the speech decoding device according to the ninth embodiment.

The present modification differs from the speech decoding device 380 according to the ninth embodiment in that it includes a temporal envelope shape determiner 120f in place of the low frequency temporal envelope shape determiner 100c and the high frequency temporal envelope shape determiner 110b, and a temporal envelope modifier 380aA in place of the temporal envelope modifier 380a.

The temporal envelope modifier 380aA modifies the shape of the temporal envelope of the low frequency signal output from the low frequency decoder 100b and the high frequency signal output from the high frequency decoder 100e, based on the temporal envelope shape determined by the temporal envelope shape determiner 120f (S380-1a).

### [Speech Decoding Device of Tenth Embodiment]

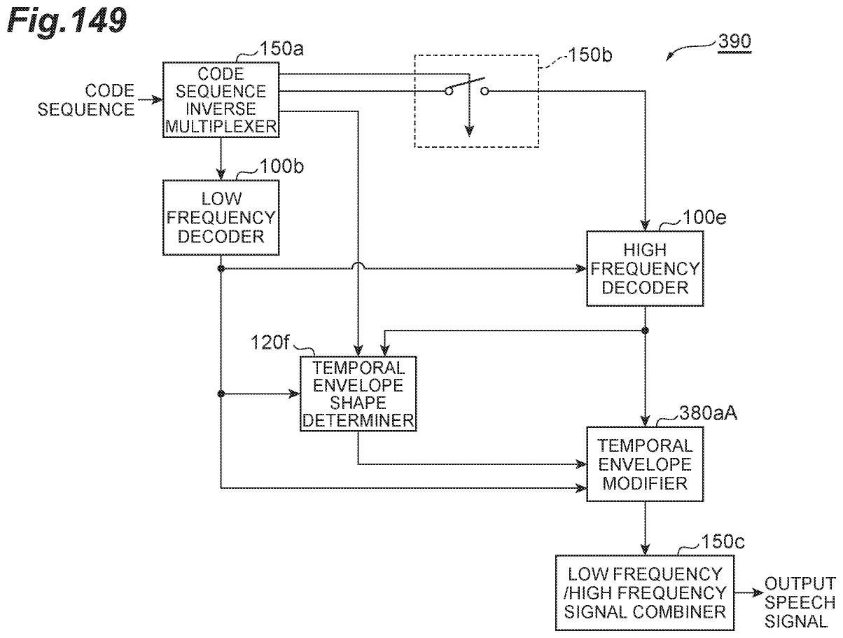

FIG. 149 is a diagram showing the configuration of a speech decoding device 390 according to a tenth embodiment.

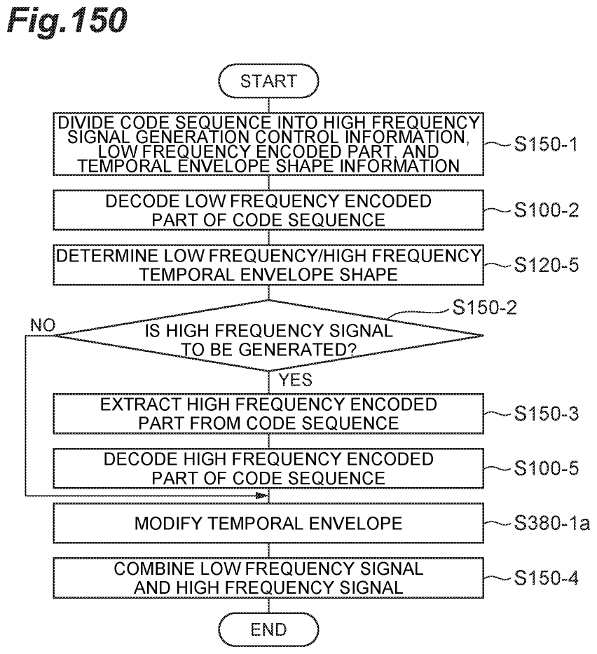

FIG. 150 is a flowchart showing the operation of the speech decoding device 390 according to the tenth embodiment.

In the present modification, the temporal envelope modifier 380aA modifies the shape of the temporal envelope of the low frequency signal output from the low frequency decoder 100b, based on the temporal envelope shape determined by the temporal envelope shape determiner 120f, and, if it is determined to generate a high frequency signal based on the high frequency signal generation information, additionally modifies the shape of the temporal envelope of the high frequency signal output from the high frequency decoder 100e (S380-1a).

1.-4. (canceled)

5. A speech encoding device that encodes an input speech signal to output a code sequence, the speech encoding device comprising:
a speech encoder that encodes the speech signal;
a temporal envelope information encoder that calculates and encodes temporal envelope information of the speech signal; and
a code sequence multiplexer that multiplexes a code sequence including the speech signal obtained by the speech encoder and a code sequence of the temporal envelope information obtained by the temporal envelope information encoder,
wherein the temporal envelope information is generated based on a ratio between an arithmetic mean and geometric mean of a temporal envelope of a high frequency signal of the speech signal, and
the temporal envelope information indicate whether a temporal envelope shape is flat or not.

6. The speech encoding device according to claim 5 wherein the temporal envelope information is represented by one bit.

7. A speech encoding method executed by a speech encoding device that encodes an input speech signal to output a code sequence, the speech encoding method comprising:
a speech encoding step of encoding the speech signal;
a temporal envelope information encoding step of calculating and encoding temporal envelope information of the speech signal; and
a code sequence multiplexing step of multiplexing a code sequence including the speech signal obtained in the speech encoding step and a code sequence of the temporal envelope information obtained in the temporal envelope information encoding step,
wherein the temporal envelope information is generated based on a ratio between an arithmetic mean and geometric mean of a temporal envelope of a high frequency signal of the speech signal, and
the temporal envelope information indicate whether a temporal envelope shape is flat or not.

8. The speech encoding method according to claim 7 wherein the temporal envelope information is represented by one bit.
